(19) United States
(12) Patent Application Publication
(10) Pub. No.: US 2005/0215435 A1
(43) Pub. Date: Sep. 29, 2005

(54) Phenylalanine derivatives as herbicides

(76) Inventors: Markus Menges, Harthausen (DE); Michael Puhl, Lampertheim (DE); Costin Rentzea, Heidelberg (DE); Albrecht Harreus, Ludwigshafen (DE); Christoph v.d. Bussche-Hunnefeld, Kassel (DE); Andreas Gypser, Mannheim (DE); Anja Schwogler, Mannheim (DE); Matthias Witschel, Bad Durkheim (DE); Cyrill Zagar, Mannheim (DE); Klaus Grossmann, Neuhofen (DE); Helmut Schiffer, Grossfischlingen (DE); Franz Rohl, Schifferstadt (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/503,762

(22) PCT Filed: Jan. 30, 2003
(86) PCT No.: PCT/EP03/00926

§ 371 Date: Aug. 6, 2004

(30) Foreign Application Priority Data
Feb. 6, 2002 (DE) 102049513

(51) Int. Cl. A01N 37/18

(52) U.S. Cl. 504/335; 564/154; 564/155

(57) ABSTRACT

Phenylalanine derivatives of the formula I 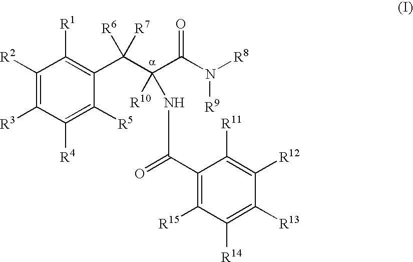 where the radicals are as defined in the description, and the use of these compounds as herbicides and/or for regulating plant growth is described.

The present invention relates to phenylalanine derivatives of the formula 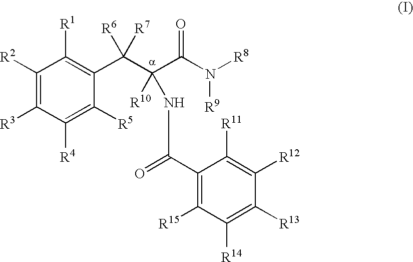
in which
R¹, R², R⁴, R⁵, R¹³ and R¹⁵ independently of one another are hydrogen, halogen, hydroxyl, mercapto, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₂-C₆-haloalkenyl, C₂-C₆-haloalkynyl, C₁-C₆-haloalkoxy, C₃-C₆-haloalkenyloxy, C₃-C₆-haloalkynyloxy, C₁-C₆-haloalkylthio, C₃-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, formyl, C₁-C₆-alkylcarbonyloxy, C₁-C₆-alkoxy-C₁-C₄-alkyl, C₃-C₆-alkenyloxy-C₁-C₄-alkyl, C₃-C₄-alkynyloxy-C₁-C₄-alkyl, C₁-C₆-alkylthio-C₁-C₄-alkyl, C₃-C₆-alkenylthio-C₁-C₄-alkyl, C₃-C₄-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkoxycarbonyl-C₁-C₄-alkyl, C₁-C₆-alkoxy-C₁-C₄-alkoxy, C₃-C₆-alkenyloxy-C₁-C₄-alkoxy, C₃-C₄-alkynyloxy-C₁-C₄-alkoxy, C₁-C₆-alkylthio-C₁-C₄-alkoxy, C₃-C₆-alkenylthio-C₁-C₄-alkoxy, C₃-C₆-alkynylthio-C₁-C₄-alkoxy, C₁-C₆-alkylcarbonyl-C₁-C₄-alkoxy, C₁-C₆-alkylcarbonyloxy-C₁-C₄-alkoxy, C₁-C₆-alkoxycarbonyl-C₁-C₄-alkoxy or CO—R¹⁶;
R³ is hydrogen, halogen, mercapto, C₁-C₆-alkyl, C₂-C₆-alkenyl, C₂-C₆-alkynyl, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₂-C₆-haloalkenyl, C₂-C₆-haloalkynyl, C₁-C₆-haloalkylthio, C₃-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, C₁-C₆-alkoxy-C₁-C₄-alkyl, C₃-C₆-alkenyloxy-C₁-C₄-alkyl, C₃-C₄-alkynyloxy-C₁-C₄-alkyl, C₁-C₆-alkylthio-C₁-C₄-alkyl, C₃-C₆-alkenylthio-C₁-C₄-alkyl, C₃-C₆-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkyloxycarbonyl-C₁-C₄-alkyl or CO—R¹⁶;
R⁶ is hydrogen, C₂-C₆-alkenyl, C₂-C₆-alkynyl or C₁-C₆-alkyl;
R⁷ is hydrogen, halogen, C₁-C₆-alkyl, C₂-C₆-alkenyl, C₂-C₆-alkynyl, C₁-C₆-haloalkyl, C₂-C₆-haloalkenyl or C₂-C₆-haloalkynyl;
R⁸ is methyl, ethyl, C₁-C₆-alkoxy or hydroxyl;
R⁹ is hydrogen or C₁-C₆-alkyl;
R¹⁰ is hydrogen, C₁-C₆-alkyl, C₁-C₆-alkoxycarbonyl or C₁-C₆-haloalkoxylcarbonyl;
R¹¹ is halogen, mercapto, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₂-C₆-haloalkenyl, C₂-C₆-haloalkynyl, C₁-C₆-haloalkoxy, C₃-C₆-haloalkenyloxy, C₃-C₆-haloalkynyloxy, C₁-C₆-haloalkylthio, C₃-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, formyl, C₁-C₆-alkylcarbonyloxy, C₁-C₆-alkoxy-C₁-C₄-alkyl, C₂-C₆-alkenyloxy-C₁-C₄-alkyl, C₃-C₄-alkynyloxy-C₁-C₄-alkyl, C₁-C₆-alkylthio-C₁-C₄-alkyl, C₂-C₆-alkenylthio-C₁-C₄-alkyl, C₃-C₄-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkyloxycarbonyl-C₁-C₄-alkyl, C₁-C₆-alkoxy-C₁-C₄-alkoxy, C₃-C₆-alkenyloxy-C₁-C₄-alkoxy, C₃-C₄-alkynyloxy-C₁-C₄-alkoxy, C₁-C₆-alkylthio-C₁-C₄-alkoxy, C₃-C₆-alkenylthio-C₁-C₄-alkoxy, C₃-C₆-alkynylthio-C₁-C₄-alkoxy, C₁-C₆-alkylcarbonyl-C₁-C₄-alkoxy, C₁-C₆-alkylcarbonyloxy-C₁-C₄-alkoxy, C₁-C₆-alkyloxycarbonyl-C₁-C₄-alkoxy or CO—R¹⁶;
R¹² and R¹⁴ independently of one another are hydrogen, halogen, hydroxyl, mercapto, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₃-C₆-haloalkenyl, C₂-C₆-haloalkynyl, C₁-C₆-haloalkoxy, C₃-C₆-haloalkenyloxy, C₃-C₆-haloalkynyloxy, C₁-C₆-haloalkylthio, C₂-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, formyl, C₁-C₆-alkylcarbonyloxy, C₁-C₆-alkoxy-C₁-C₄-alkyl, C₃-C₆-alkenyloxy-C₁-C₄-alkyl, C₃-C₄-alkynyloxy-C₁-C₄-alkyl, C₁-C₆-alkylthio-C₁-C₄-alkyl, C₃-C₆-alkenylthio-C₁-C₄-alkyl, C₃-C₄-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkyloxycarbonyl-C₁-C₄-alkyl, C₁-C₆-alkoxy-C₁-C₄-alkoxy, C₃-C₆-alkenyloxy-C₁-C₄-alkoxy, C₃-C₄-alkynyloxy-C₁-C₄-alkoxy, C₁-C₆-alkylthio-C₁-C₄-alkoxy, C₃-C₆-alkenylthio-C₁-C₄-alkoxy, C₃-C₆-alkynylthio-C₁-C₄-alkoxy, C₁-C₆-alkylcarbonyl-C₁-C₄-alkoxy, C₁-C₆-alkylcarbonyloxy-C₁-C₄-alkoxy, C₁-C₆-alkyloxycarbonyl-C₁-C₄-alkoxy or CO—R¹⁶; and
R¹⁶ is hydrogen, hydroxyl, C₁-C₆-alkyl, C₂-C₆-alkenyl, C₂-C₆-alkynyl, C₁-C₆-haloalkyl, C₂-C₆-haloalkenyl, C₂-C₆-haloalkynyl, C₁-C₆-alkoxy, C₃-C₆-alkenyloxy, C₃-C₆-alkynyloxy, C₁-C₆-haloalkoxy, C₁-C₆-alkylamino or di(C₁-C₆-alkyl)amino; or
R⁷ together with R¹⁰ forms a C₃-C₄-alkylene or -alkenylene chain, where the C₃-C₄-alkylene or -alkenylene chain may carry 1-3 substituents from the group consisting of halogen, nitro or cyano and/or one carbon atom of the C₃-C₄-alkylene chain may be replaced by a heteroatom selected from the group consisting of oxygen, sulfur and nitrogen and/or by a carbonyl group,
and the agriculturally useful salts of the compounds I.

Moreover, the invention relates to
the use of the compounds I as herbicides,
herbicidal compositions which comprise the compounds I as active substances,
processes for preparing the compounds I and for preparing herbicidal compositions using the compounds I, and also
methods for controlling undesirable vegetation using the compounds I and/or
for controlling the growth of plants,
compositions for regulating the growth of plants, which compositions comprise the compounds I as active substances,
processes for preparing compositions for regulating the growth of plants using the compounds I, and also
methods for regulating the growth of plants using the compounds I.

Numerous amino acid derivatives are disclosed in the literature; WO 01/21584, for example, describes tyrosine derivatives which can be used for treating chronic inflammatory conditions.

EP-A 805 147 discloses amino acid derivatives which can be used as calcium channel modulators.

WO 97/19908 describes phenylalanine derivatives whose phenyl ring is preferably substituted by fluorine and which can be used as fungicides.

JP-A 02088549 teaches derivatives of amino acids which are preferably derived from proline, serine or threonine. The compounds described have antithrombotic action.

WO 97/05865 discloses amino acid derivatives which are preferably SO₂-substituted at the amino group group and are used as C-proteinase inhibitors.

DE-A 33 326 333 discloses carboxylic acid derivatives suitable for preparing medicaments.

JP 3294-253-A teaches amino acid derivatives as inhibitors of cholecystokinin and gastrin receptors.

It is an object of the present invention to provide herbicidally active compounds.

The object also extends to the provision of compounds suitable for regulating the growth of plants.

We have found that this object is achieved by providing the phenylalanine derivatives of the formula I defined at the outset.

Furthermore, it has been found that the compounds I are also suitable for regulating the growth of plants. In this respect, we have found compositions for regulating the growth of plants, processes for preparing these compositions and methods for regulating the growth of plants using the compounds I.

Owing to the asymmetrically substituted α-carbon, these compounds are present either as racemates, enantiomer mixtures or as pure enantiomers and may, if they carry chiral substituents on the α-carbon or have further centers of chirality, also be present as diastereomer mixtures. Furthermore, depending on the substitution pattern, the compounds I can also be present as diastereomer mixtures. Preference is given to compounds of the formula I in which the α-carbon has the S configuration. Hereinbelow, these compounds are also referred to as S enantiomers.

Suitable agriculturally useful salts are especially the salts of those cations or the acid addition salts of those acids whose cations and anions, respectively, have no adverse effect on the herbicidal action of the compounds I. Thus, suitable cations are in particular the ions of the alkali metals, preferably sodium and potassium, of the alkaline earth metals, preferably calcium, magnesium and barium, and of the transition metals, preferably manganese, copper, zinc and iron, and also the ammonium ion which, if desired, may carry one to four C₁-C₄-alkyl substituents and/or one phenyl or benzyl substituent, preferably diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, bicarbonate, carbonate, hexafluorosilicate, hexafluorophosphate, benzoate, and also the anions of C₁-C₄-alkanoic acids, preferably formate, acetate, propionat and butyrate. They can be formed by reacting I with an acid of the corresponding anion, preferably of hydrochloric acid, hydrobromic acid, sulfuric acid, phosphoric acid or nitric acid.

The organic moieties mentioned in the definition of the substituents R¹ to R¹⁵ are—like the term halogen—collective terms for individual enumerations of the individual group members. All hydrocarbon chains, i.e. all alkyl, alkenyl, alkynyl, haloalkyl, haloalkenyl, haloalkynyl moieties, can be straight-chain or branched. Halogenated substituents preferably carry one to five identical or different halogen atoms. The term halogen denotes in each case fluorine, chlorine, bromine or iodine.

Examples of meanings are:
halogen is fluorine, chlorine or bromine;
C₁-C₄-alkyl is methyl, ethyl, n-propyl, 1-methylethyl, n-butyl, 1-methylpropyl, 2-methylpropyl or 1,1-dimethylethyl;
C₁-C₆-alkyl is a C₁-C₄-alkyl radical as mentioned above or, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl;
C₃-C₄-alkenyl is a mono- or diethylenically unsaturated radical having 3 or 4 carbon atoms, such as prop-1-en-1-yl, allyl, 1-methylethenyl, but-1-en-1-yl, but-1-en-2-yl, but-1-en-3-yl, but-2-en-1-yl, 1-methylprop-1-en-1-yl, 2-methylprop-1-en-1-yl, 1-methylprop-2-en-1-yl or 2-methylprop-2-en-1-yl;
C₅-C₆-alkenyl is a C₃-C₄-alkenyl radical as mentioned above or is a mono- or polyethylenically unsaturated radical having 5 or 6 carbon atoms, such as, for example, n-penten-1-yl, n-penten-2-yl, n-penten-3-yl, n-penten-4-yl, 1-methylbut-1-en-1-yl, 2-methylbut-1-en-1-yl, 3-methylbut-1-en-1-yl, 1-methylbut-2-en-1-yl, 2-methylbut-2-en-1-yl, 3-methylbut-2-en-1-yl, 1-methylbut-3-en-1-yl, 2-methylbut-3-en-1-yl, 3-methylbut-3-en-1-yl, 1,1-dimethylprop-2-en-1-yl, 1,2-dimethyl-prop-1-en-1-yl, 1,2-dimethylprop-2-en-1-yl, 1-ethylprop-1-en-2-yl, 1-ethylprop-2-en-1-yl, n-hex-1-en-1-yl, n-hex-2-en-1-yl, n-hex-3-en-1-yl, n-hex-4-en-1-yl, n-hex-5-en-1-yl, 1-methylpent-1-en-1-yl, 2-methylpent-1-en-1-yl, 3-methylpent-1-en-1-yl, 4-methylpent-1-en-1-yl, 1-methylpent-2-en-1-yl, 2-methylpent-2-en-1-yl, 3-methylpent-2-en-1-yl, 4-methylpent-2-en-1-yl, 1-methylpent-3-en-1-yl, 2-methylpent-3-en-1-yl, 3-methylpent-3-en-1-yl, 4-methylpent-3-en-1-yl, 1-methylpent-4-en-1-yl, 2-methylpent-4-en-1-yl, 3-methylpent-4-en-1-yl, 4-methylpent-4-en-1-yl, 1,1-dimethylbut-2-en-1-yl, 1,1-dimethylbut-3-en-1-yl, 1,2-dimethylbut-1-en-1-yl, 1,2-dimethylbut-2-en-1-yl, 1,2-dimethylbut-3-en-1-yl, 1,3-dimethylbut-1-en-1-yl, 1,3-dimethyl-but-2-en-1-yl, 1,3-dimethylbut-3-en-1-yl, 2,2-dimethylbut-3-en-1-yl, 2,3-dimethylbut-1-en-1-yl, 2,3-dimethylbut-2-en-1-yl, 2,3-dimethylbut-3-en-1-yl, 3,3-dimethylbut-1-en-1-yl, 3,3-dimethylbut-2-en-1-yl, 1-ethylbut-1-en-1-yl, 1-ethylbut-2-en-1-yl, 1-ethylbut-3-en-1-yl, 2-ethylbut-1-en-1-yl, 2-ethylbut-2-en-1-yl, 2-ethylbut-3-en-1-yl, 1,1,2-trimethylprop-2-en-1-yl, 1-ethyl-1-methylprop-2-en-1-yl, 1-ethyl-2-methylprop-1-en-1-yl or 1-ethyl-2-methylprop-2-en-1-yl;
C₂-C₆-alkenyl is a C₃-C₆-alenylkyl radical as mentioned above or ethenyl;
C₂-C₄-alkenyl is a C₃-C₄-alenylkyl radical as mentioned above or ethenyl;
C₂-C₄-alkynyl is: ethynyl, prop-1-yn-1-yl, prop-2-yn-1-yl, n-but-1-yn-1-yl, n-but-1-yn-3-yl, n-but-1-yn-4-yl or n-but-2-yn-1-yl;
C₃-C₆-alkynyl is a C₂-C₄-alkynyl radical as mentioned above or n-pent-1-yn-1-yl, n-pent-1-yn-3-yl, n-pent-1-yn-4-yl, n-pent-1-yn-5-yl, n-pent-2-yn-1-yl, n-pent-2-yn-4-yl, n-pent-2-yn-5-yl, 3-methylbut-1-yn-3-yl, 3-methylbut-1-yn-4-yl, n-hex-1-yn-1-yl, n-hex-1-yn-3-yl, n-hex-1-yn-4-yl, n-hex-1-yn-5-yl, n-hex-1-yn-6-yl, n-hex-2-yn-1-yl, n-hex-2-yn-4-yl, n-hex-2-yn-5-yl, n-hex-2-yn-6-yl, n-hex-3-yn-1-yl, n-hex-3-yn-2-yl, 3-methylpent-1-yn-1-yl, 3-methylpent-1-yn-3-yl, 3-methyl-pent-1-yn-4-yl, 3-methylpent-1-yn-5-yl, 4-methylpent-1-yn-1-yl, 4-methylpent-2-yn-4-yl and 4-methylpent-2-yn-5-yl;
C₂-C₆-alkynyl is a C₃-C₆-alkynylkyl radical as mentioned above or ethynyl;
C₃-C₆-alkenyloxy is a C₃-C₆-alkenyl radical as mentioned above which is attached to the skeleton via an oxygen atom (—O—);
C₁-C₄-alkoxy is a C₁-C₄-alkyl radical as mentioned above which is attached to the skeleton via an oxygen atom (—O—);
C₁-C₆-alkoxy is a C₁-C₆-alkyl radical as mentioned above which is attached to the skeleton via an oxygen atom (—O—);
C₃-C₆-alkenyloxy is a C₃-C₆-alkenyl radical as mentioned above which is attached to the skeleton via an oxygen atom (—O—);
C₃-C₆-alkynyloxy is a C₃-C₆-alkynyl radical as mentioned above which is attached to the skeleton via an oxygen atom (—O—);
C₁-C₆-alkylthio is a C₁-C₆-alkyl radical as mentioned above which is attached to the skeleton via a sulfur atom (—S—);
C₃-C₆-alkenylthio is a C₃-C₆-alkenyl radical as mentioned above which is attached to the skeleton via a sulfur atom (—S—);
C₃-C₆-alkynylthio is a C₃-C₆-alkynyl radical as mentioned above which is attached to the skeleton via a sulfur atom (—S—);
C₁-C₆-alkylsulfinyl is a C₁-C₆-alkyl radical as mentioned above which is attached to the skeleton via a sulfinyl group (—SO—);
C₃-C₆-alkenylsulfinyl is a C₃-C₆-alkenyl radical as mentioned above which is attached to the skeleton via a sulfinyl group (—SO—);
C₃-C₆-alkynylsulfinyl is a C₃-C₆-alkynyl radical as mentioned above which is attached to the skeleton via a sulfinyl group (—SO—);
C₁-C₆-alkylsulfonyl is a C₁-C₆-alkyl radical as mentioned above which is attached to the skeleton via a sulfonyl group (—SO₂—);
C₃-C₆-alkenylsulfonyl is a C₃-C₆-alkenyl radical as mentioned above which is attached to the skeleton via a sulfonyl group (—SO₂—);
C₃-C₆-alkynylsulfonyl is a C₃-C₆-alkynyl radical as mentioned above which is attached to the skeleton via a sulfonyl group (—SO₂—);
C₁-C₄-haloalkyl is a C₁-C₄-alkyl radical as mentioned above which is partially or fully substituted by fluorine, chlorine, bromine and/or iodine, i.e., for example, chloromethyl, dichloromethyl, trichloromethyl, fluoromethyl, difluoromethyl, trifluoromethyl, chlorfluoromethyl, dichlorofluoromethyl, chlorodifluoromethyl, 2-fluoroethyl, 2-chloroethyl, 2-bromoethyl, 2-iodoethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromomethyl)-2-bromoethyl, 4-fluorobutyl, 4-chlorobutyl, 4-bromobutyl or nonafluorobutyl, in particular chloromethyl, fluoromethyl, difluoromethyl, trifluoromethyl, 2-fluoroethyl, 2-chloroethyl or 2,2,2-trifluoroethyl;
C₁-C₆-haloalkyl is a C₁-C₆-alkyl radical as mentioned above which is partially or fully substituted by fluorine, chlorine, bromine and/or iodine, i.e. for example, one of the radicals mentioned under C₁-C₄-haloalkyl or 5-fluoro-1-pentyl, 5-chloro-1-pentyl, 5-bromo-1-pentyl, 5-iodo-1-pentyl, 5,5,5-trichloro-1-pentyl, undecafluoropentyl, 6-fluoro-1-hexyl, 6-chloro-1-hexyl, 6-bromo-1-hexyl, 6-iodo-1-hexyl, 6,6,6-trichloro-1-hexyl or dodecafluorohexyl;
C₂-C₆-haloalkenyl is a C₂-C₆-alkenyl radical as mentioned above in which some or all of the hydrogen atoms may be replaced by halogen atoms as mentioned above, in particular by fluorine, chlorine and bromine;
C₂-C₆-haloalkynyl is a C₂-C₆-alkynyl radical as mentioned above in which some or all of the hydrogen atoms may be replaced by halogen atoms as mentioned above, in particular by fluorine, chlorine and bromine;
C₁-C₆-haloalkoxy is a C₁-C₆-haloalkyl radical as mentioned above which is attached to the skeleton via an oxygen atom (—O—);
C₃-C₆-haloalkenyloxy is a C₃-C₆-alkenyloxy radical as mentioned above which is partially or fully substituted by fluorine, chlorine, bromine and/or iodine;
C₃-C₆-haloalkynyloxy is a C₃-C₆-alkynyloxy radical as mentioned above which is partially or fully substituted by fluorine, chlorine, bromine and/or iodine;
C₁-C₆-haloalkylthio is a C₁-C₆-haloalkyl radical as mentioned above which is attached to the skeleton via a sulfur atom (—S—);
C₃-C₆-haloalkenylthio is a C₃-C₆-haloalkenyl radical as mentioned above which is attached to the skeleton via a sulfur atom (—S—);
C₃-C₆-haloalkynylthio is a C₃-C₆-haloalkynyl radical as mentioned above is attached to the skeleton via a sulfur atom (—S—);
C₁-C₆-haloalkylsulfinyl is a C₁-C₆-haloalkyl radical as mentioned above which is attached to the skeleton via a sulfinyl group (—SO—);
C₃-C₆-haloalkenylsulfinyl is a C₃-C₆-haloalkenyl radical as mentioned above which is attached to the skeleton via a sulfinyl group (—SO—);
C₃-C₆-haloalkynylsulfinyl is a C₃-C₆-haloalkynyl radical as mentioned above which is attached to the skeleton via a sulfinyl group (—SO—);
C₁-C₆-haloalkylsulfonyl is a C₁-C₆-haloalkyl radical as mentioned above which is attached to the skeleton via a sulfonyl group (—SO₂—);
C₃-C₆-haloalkenylsulfonyl is a C₃-C₆-haloalkenyl radical as mentioned above which is attached to the skeleton via a sulfonyl group (—SO₂—);
C₃-C₆-haloalkynylsulfonyl is a C₃-C₆-haloalkynyl radical as mentioned above which is attached to the skeleton via a sulfonyl group (—SO₂—);
C₁-C₆-alkylcarbonyloxy is a C₁-C₆-alkyl radical which is attached to the skeleton via a carbonyloxy group (—C(O)—O—) via is the oxygen;
C₁-C₆-alkoxy-C₁-C₄-alkyl is a C₁-C₄-alkyl radical as mentioned above which is substituted by a C₁-C₆-alkoxy radical as mentioned above, for example methoxymethyl, ethoxymethyl, n-propoxymethyl, i-propoxymethyl, n-butoxymethyl, (1-methylpropoxy)methyl, (2-methylpropoxy)methyl, t-butoxymethyl, 2-(methoxy)ethyl, 2-(ethoxy)ethyl, 2-(n-propoxy)ethyl, 2-(1-methylethoxy)ethyl, 2-(n-butoxy)ethyl, 2-(1-methylpropoxy)ethyl, 2-(2-methylpropoxy)ethyl, 2-(1,1-dimethylethoxy)ethyl, 2-(methoxy)propyl, 2-(ethoxy)propyl, 2-(n-propoxy)propyl, 2-(1-methylethoxy)propyl, 2-(n-butoxy)propyl, 2-(1-methylpropoxy)propyl, 2-(2-methylpropoxy)propyl, 2-(1,1-dimethylethoxy)propyl, 3-(methoxy)propyl, 3-(ethoxy)propyl, 3-(n-propoxy)propyl, 3-(1-methylethoxy)propyl, 3-(n-butoxy)propyl, 3-(1-methylpropoxy)propyl, 3-(2-methylpropoxy)propyl, 3-(1,1-dimethylethoxy)propyl, 2-(methoxy)butyl, 2-(ethoxy)butyl, 2-(n-propoxy)butyl, 2-(1-methylethoxy)butyl, 2-(n-butoxy)butyl, 2-(1-methylpropoxy)butyl, 2-(2-methylpropoxy)butyl, 2-(1,1-dimethylethoxy)butyl, 3-(methoxy)butyl, 3-(ethoxy)butyl, 3-(n-propoxy)butyl, 3-(1-methylethoxy)butyl, 3-(n-butoxy)butyl, 3-(1-methylpropoxy)butyl, 3-(2-methylpropoxy)butyl, 3-(1,1-dimethylethoxy)butyl, 4-(methoxy)butyl, 4-(ethoxy)butyl, 4-(n-propoxy)butyl, 4-(1-methylethoxy)butyl, 4-(n-butoxy)butyl, 4-(1-methylpropoxy)butyl, 4-(2-methylpropoxy)butyl or 4-(1,1-dimethylethoxy)butyl;
C₃-C₆-alkenyloxy-C₁-C₄-alkyl is a C₁-C₄-alkyl radical as mentioned above which is substituted by a C₃-C₆-alkenyloxy radical as mentioned above;
C₃-C₄-alkynyloxy-C₁-C₄-alkyl is a C₁-C₄-alkyl radical as mentioned above which is substituted by a C₃-C₄-alkynyloxy radical as mentioned above;
C₁-C₆-alkylthio-C₁-C₄-alkyl is a C₁-C₄-alkyl radical as mentioned above which is substituted by a C₁-C₆-alkylthio radical as mentioned above;
C₃-C₆-alkenylthio-C₁-C₄-alkyl is a C₁-C₄-alkyl radical as mentioned above which is substituted by a C₃-C₆-alkenylthio radical as mentioned above;
C₃-C₄-alkynylthio-C₁-C₄-alkyl is a C₁-C₄-alkyl radical as mentioned above which is substituted by a C₃-C₆-alkynylthio radical as mentioned above;
C₁-C₆-alkylcarbonyl is a C₁-C₆-alkyl radical as mentioned above which is attached to the skeleton via a carbonyl group (—CO—);
C₁-C₆-alkoxycarbonyl is a C₁-C₆-alkoxy radical as mentioned above which is attached to the skeleton via a carbonyl group (—CO—);
C₁-C₆-alkylcarbonyl-C₁-C₄-alkyl is a C₁-C₄-alkyl radical as mentioned above which is substituted by a C₁-C₆-alkylcarbonyl radical as mentioned above;
C₁-C₆-alkoxycarbonyl-C₁-C₄-alkyl is a C₁-C₄-alkyl radical as mentioned above which is substituted by a C₁-C₆-alkoxycarbonyl radical as mentioned above;
C₁-C₆-alkoxy-C₁-C₄-alkyl is a C₁-C₄-alkyl radical which is substituted by C₁-C₆-alkoxy as mentioned above, where the alkyl radical is defined as mentioned above;
C₃-C₆-alkenyloxy-C₁-C₄-alkyl is a C₁-C₄-alkyl radical which is substituted by C₃-C₆-alkenyloxy as mentioned above, where the C₁-C₄-alkyl radical is defined as mentioned above;
C₃-C₆-alkynyloxy-C₁-C₄-alkyl is a C₁-C₄-alkyl radical which is substituted by C₃-C₆-alkynyloxy as mentioned above, where the C₁-C₄-alkyl radical is defined as mentioned above;
C₁-C₆-alkylthio-C₁-C₄-alkyl is a C₁-C₄-alkyl radical which is substituted by C₁-C₆-alkylthio as mentioned above, where the C₁-C₄-alkyl radical is defined as mentioned above;
C₁-C₆-alkoxy-C₁-C₄-alkoxy is a C₁-C₆-alkoxy radical which is substituted by C₁-C₄-alkoxy as mentioned above, where the C₁-C₄-alkoxy radical is defined as mentioned above;
C₃-C₆-alkenyloxy-C₁-C₄-alkoxy is a C₁-C₄-alkoxy radical which is substituted by C₃-C₆-alkenyloxy as mentioned above, where the C₁-C₄-alkoxy radical is defined as mentioned above;
C₃-C₄-alkynyloxy-C₁-C₄-alkoxy is a C₁-C₄-alkoxy radical which is substituted by C₃-C₄-alkynyloxy as mentioned above, where the C₁-C₄-alkoxy radical is defined as mentioned above;
C₁-C₆-alkylthio-C₁-C₄-alkoxy is a C₁-C₄-alkoxy radical which is substituted by C₁-C₆-alkylthio as mentioned above, where the C₁-C₄-alkoxy radical is defined as mentioned above;
C₃-C₆-alkenylthio-C₁-C₄-alkoxy is a C₁-C₄-alkoxy radical which is substituted by C₃-C₆-alkenylthio as mentioned above where the C₁-C₄-alkoxy radical is defined as mentioned above;
C₃-C₆-alkynylthio-C₁-C₄-alkoxy is a C₁-C₄-alkoxy radical which is substituted by C₃-C₆-alkynylthio as mentioned above where the C₁-C₄-alkoxy radical is defined as mentioned above;
C₁-C₆-alkylcarbonyl-C₁-C₄-alkoxy is a C₁-C₄-alkoxy radical which is substituted by C₁-C₆-alkylcarbonyl as mentioned above where the C₁-C₄-alkoxy radical is defined as mentioned above;
C₁-C₆-alkylcarbonyloxy-C₁-C₄-alkoxy is a C₁-C₄-alkoxy radical which is substituted by C₁-C₆-alkylcarbonyloxy as mentioned above where the C₁-C₄-alkoxy radical is defined as mentioned above;
C₁-C₆-alkoxycarbonyl-C₁-C₄-alkoxy is a C₁-C₄-alkoxy radical which is substituted by C₁-C₆-alkoxycarbonyl as mentioned above where the C₁-C₄-alkoxy radical is defined as mentioned above;
C₃-C₄-alkylene is n-propylene (—CH₂CH₂CH₂—) or n-butylene (—CH₂CH₂CH₂CH₂—);
C₃-C₄-alkenylene is a divalent unbranched chain of one or two CH═CH— groups and/or one or two CH₂ groups in any position, for example —CH═CHCH₂—, CH₂CH═CHCH₂, CH═CHCH₂CH₂ or CH═CH—CH═CH₂;
C₁-C₄-alkylamino is a C₁-C₄-alkyl radical as mentioned above which is attached to the skeleton via an amino group (—NH—);
C₁-C₆-alkylamino is a C₁-C₆-alkyl radical as mentioned above which is attached to the skeleton via an amino group (—NH—);
C₁-C₄-dialkylamino are two independent C₁-C₄-alkyl radicals as mentioned above which are attached to the skeleton via a nitrogen atom (>N—);
C₁-C₆-dialkylamino are two independent C₁-C₆-alkyl radicals as mentioned above which are attached to the skeleton via a nitrogen atom (>N—).

With respect to the use of the substituted phenylalanine derivatives I as herbicides, preference is given to those compounds I in which the substituents are as defined above, in each case on their own or in combination:
R¹ is hydrogen, halogen, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₁-C₆-haloalkoxy, C₃-C₆-haloalkenyloxy, C₁-C₆-haloalkylthio, C₃-C₆-haloalkenylthio, C₁-C₆-haloalkylsulfinyl, C₃-C₆-haloalkenylsulfinyl, C₁-C₆-haloalkylsulfonyl or C₃-C₆-haloalkenylsulfonyl;
   preferably hydrogen, halogen, cyano, C₁-C₆-alkyl, C₁-C₆-alkylthio, C₁-C₆-alkylsulfinyl or C₁-C₆-alkylsulfonyl;
   particularly preferably hydrogen, cyano, halogen or C₁-C₆ alkyl;
R² is hydrogen, halogen, nitro, cyano, C₁-C₆-alkyl, C₂-C₆-alkynyl, C₁-C₆-alkoxy, C₃-C₆-alkenyloxy, C₃-C₆-alkynyloxy, C₁-C₆-haloalkyl, C₁-C₆-haloalkoxy, C₃-C₆-haloalkenyloxy or C₃-C₆-halogenalkynyloxy;
   preferably hydrogen, halogen, cyano, C₁-C₆-haloalkyl or C₁-C₆-alkyl;
   particularly preferably hydrogen or C₁-C₆-haloalkyl;
   furthermore particularly preferably halogen or C₁-C₆-alkyl;
   very particularly preferably hydrogen, halogen or C₁-C₆-alkyl;
R³ is hydrogen, halogen, C₁-C₆-alkyl or C₁-C₆-haloalkyl; preferably hydrogen or halogen;
R⁴ is hydrogen, halogen, nitro, cyano, C₁-C₆-alkyl, C₁-C₆-alkoxy, C₃-C₆-alkenyloxy, C₃-C₆-alkynyloxy, C₁-C₆-haloalkyl or C₁-C₆-haloalkoxy;
   preferably hydrogen, halogen, C₁-C₆-alkyl or C₁-C₆-haloalkyl;
   particularly preferably hydrogen or halogen;
   very particularly preferably hydrogen;
R⁵ is hydrogen, halogen, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-haloalkyl, C₁-C₆-haloalkoxy or C₃-C₆-haloalkenyloxy; preferably hydrogen, halogen, C₁-C₆-alkyl or C₁-C₆-haloalkyl, particularly preferably hydrogen;
   likewise particularly preferably C₁-C₆-alkyl or halogen;
R⁶ is hydrogen or C₁-C₆-alkyl;
R⁷ is hydrogen, halogen, C₁-C₆-alkyl, C₂-C₆-alkenyl, C₂-C₆-alkynyl or C₁-C₆-haloalkyl;
   preferably hydrogen, C₁-C₆-alkyl, C₂-C₆-alkenyl or C₂-C₆-alkynyl;
   particularly preferably also C₁-C₆-alkyl or hydrogen;
R⁸ is methyl or methoxy;
   likewise hydroxyl;
R⁹ is hydrogen or methyl;
   preferably hydrogen;
   when R⁸ is hydroxyl, preferably methyl;
R¹⁰ is hydrogen, C₁-C₆-alkyl, C₁-C₆-alkoxycarbonyl, C₁-C₄-haloalkoxycarbonyl;
   preferably hydrogen;
R¹¹ is halogen, nitro, cyano, C₁-C₆-alkyl, C₁-C₆-alkoxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₁-C₆-haloalkoxy, C₁-C₆-haloalkylthio, C₃-C₆-haloalkenylthio, C₁-C₆-haloalkylsulfinyl, C₃-C₆-haloalkenylsulfinyl, C₁-C₆-haloalkylsulfonyl, C₃-C₆-haloalkenylsulfonyl or CO—R¹⁶;
   preferably halogen, cyano, C₁-C₆-alkylthio, C₁-C₆-alkylsulfinyl, C₁-C₆-alkylsulfonyl, C₁-C₆-alkyl, C₁-c₆-haloalkyl or CO—R¹⁶;
   in addition preferably C₁-C₆-haloalkoxy, C₁-C₆-haloalkylthio;
   particularly preferably halogen, cyano, C₁-C₆-alkylthio,
   C₁-C₆-alkylsulfinyl, C₁-C₆-alkylsulfonyl, C₁-C₆-alkyl or C₁-C₆-haloalkyl;
   likewise particularly preferably C₁-C₆-haloalkoxy, C₁-C₆-haloalkylthio;
   very particularly preferably halogen or C₁-C₆-haloalkyl, where the halogen substituent in C₁-C₆-haloalkyl is preferably fluorine;
   furthermore very particularly preferably C₁-C₆-haloalkoxy, C₁-C₆-haloalkylthio, C₁-C₆-alkylsulfonyl or C₁-C₆-alkylsulfinyl, where the halogen substituent in C₁-C₆-haloalkyl, C₁-C₆-haloalkylthio, C₁-C₆-alkylsulfonyl or C₁-C₆-alkylsulfinyl is preferably fluorine;
R¹³ is hydrogen, halogen, nitro, cyano, C₁-C₆-alkyl, C₁-C₆-alkoxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₁-C₆-haloalkoxy, C₁-C₆-haloalkylthio, C₃-C₆-haloalkenylthio, C₁-C₆-haloalkylsulfinyl, C₃-C₆-haloalkenylsulfinyl, C₁-C₆-haloalkylsulfonyl, C₃-C₆-haloalkenylsulfonyl or CO—R¹⁶;
   preferably hydrogen, halogen, cyano, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy or C₁-C₆-haloalkylthio or CO—R¹⁶;
   particularly preferably hydrogen, halogen, cyano, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy or C₁-C₆-haloalkylthio;
   very particularly preferably halogen, such as, for example, chlorine and fluorine, C₁-C₆-alkyl, C₁-C₆-haloalkyl, where the halogen substituent in C₁-C₆-haloalkyl is preferably fluorine;
   likewise very particularly preferably hydrogen;
R¹² and R¹⁴ are hydrogen, halogen, cyano, C₁-C₆-alkyl, C₁-C₆-alkoxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₁-C₆-haloalkoxy, C₁-C₆-haloalkylthio, C₃-C₆-haloalkenylthio, C₁-C₆-haloalkylsulfinyl, C₃-C₆-haloalkenylsulfinyl, C₁-C₆-haloalkylsulfonyl, C₃-C₆-haloalkenylsulfonyl, or CO—R¹⁶;
   preferably hydrogen, halogen, cyano, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy, C₁-C₆-haloalkylthio or CO—R¹⁶;
   particularly preferably hydrogen, halogen, cyano, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy or C₁-C₆-haloalkylthio;
   R¹² is very particularly preferably hydrogen or halogen, such as, for example, chlorine and fluorine, C₁-C₆-alkyl, C₁-C₆-haloalkyl, where the halogen substituent in C₁-C₆-haloalkyl is preferably fluorine;
R¹² is furthermore very particularly preferably cyano, C₁-C₆-haloalkoxy or C₁-C₆-haloalkylthio, where the halogen substituent in C₁-C₆-haloalkyl or C₁-C₆-haloalkylthio is preferably fluorine;
R¹⁴ is furthermore very particularly preferably hydrogen;
R¹⁵ is hydrogen, halogen, C₁-C₆-alkyl or C₁-C₆-haloalkyl;
   preferably hydrogen; and
R¹⁶ is hydrogen, hydroxyl, C₁-C₆-alkyl, C₁-C₆-haloalkyl, C₁-C₆-Alkoxy, C₁-C₆-haloalkoxy, C₁-C₆-alkylamino or di(C₁-C₆-alkyl)amino, preferably C₁-C₆-alkyl, C₁-C₆-haloalkyl, C₁-C₆-alkoxy, C₁-C₆-haloalkoxy, C₁-C₆-alkylamino or di(C₁-C₆-alkyl)amino.

Preference is furthermore given to phenylalanine derivatives of the formula I where in each case independently of one another
R¹ is hydrogen, halogen, such as fluorine, chlorine or bromine, cyano, C₁-C₄-alkyl, such as methyl, ethyl, n-propyl or isopropyl;
   preferably hydrogen, fluorine, methyl;
   furthermore preferably chlorine or ethyl;
R² is hydrogen, C₁-C₄-haloalkyl, such as fluoromethyl, difluoromethyl or trifluoromethyl, halogen, such as fluorine, chlorine or bromine;
   likewise C₁-C₄-alkyl such as methyl, ethyl, n-propyl or isopropyl;
   preferably hydrogen or C₁-C₄-alkyl, such as methyl, ethyl, n-propyl or isopropyl;
   in addition preferably fluorine, chlorine or bromine;
   particularly preferably hydrogen, fluorine, chlorine or methyl;
R³ is hydrogen, halogen, such as fluorine, chlorine or bromine, C₁-C₄-alkyl, such as methyl, ethyl, n-propyl or isopropyl;
   preferably hydrogen, fluorine, chlorine or bromine;
   furthermore preferably methyl;
   particularly preferably hydrogen, fluorine or chlorine;
R⁴ is hydrogen, C₁-C₄-haloalkyl, such as fluoromethyl, difluoromethyl or trifluoromethyl, halogen, such as fluorine, chlorine or bromine, C₁-C₄-alkyl, such as methyl, ethyl, n-propyl or isopropyl;
   preferably hydrogen;
R⁵ is hydrogen, C₁-C₄-haloalkyl such as fluoromethyl, difluoromethyl or trifluoromethyl, halogen, such as fluorine, chlorine or bromine, C₁-C₄-alkyl, such as methyl, ethyl, n-propyl or isopropyl;
   preferably hydrogen;
   in addition preferably fluorine, chlorine or methyl.

Preference is furthermore given to phenylalanine derivatives of the formula I where in each case independently of one another
R⁷ is hydrogen, haloalkyl, such as fluoromethyl, difluoromethyl or trifluoromethyl, halogen, such as fluorine, chlorine or bromine, C₁-C₄-alkyl, such as methyl, ethyl, n-propyl or isopropyl, or C₂-C₄-alkenyl, such as ethenyl, prop-1-en-1-yl, 1-methylethenyl, but-1-en-1-yl, but-1-en-2-yl, 1-methylprop-1-en-1-yl or 2-methylprop-1-en-1-yl, C₂-C₄-alkynyl, such as ethynyl, prop-1-yn-1-yl or n-but-l-yn-1-yl;
preferably hydrogen, C₁-C₄-alkyl, such as methyl or ethyl, or C₂-C₄-alkenyl, such as ethenyl, prop-1-en-1-yl, 1-methylethenyl, but-1-en-1-yl, but-1-en-2-yl, 1-methylprop-1-en-1-yl or 2-methylprop-1-en-1-yl;
   particularly preferably hydrogen or methyl;
   furthermore particularly preferably ethyl; and
R⁶ is hydrogen.

Preference is furthermore given to phenylalanine derivatives of the formula I where R¹⁰ is hydrogen.

Preference is is furthermore given to phenylalanine derivatives of the formula I where in each case independently of one another
R⁸ is C₁-C₆-alkoxy or hydroxyl and
R⁹ is hydrogen, C₁-C₆-alkyl, preferably methyl.

Preference is also given to compounds I in which
R⁸ is methyl or ethyl, preferably methyl, and
R⁹ is hydrogen or C₁-C₆-alkyl, preferably hydrogen.

Particular preference is given to compounds I in which
R⁸ is C₁-C₄-alkoxy, C₁-C₄-alkyl or hydroxyl;
   preferably methoxy, methyl or hydroxyl;
R⁹ is hydrogen, C₁-C₆-alkyl, preferably hydrogen or methyl.

In this case, R⁹ is then preferably methyl, if R⁸ is hydroxyl.

Preference is also given to compounds I in which
R⁸ is methyl and
R⁹ is hydrogen.

Preference is furthermore given to phenylalanine derivatives of the formula I where in each case independently of one another
R¹¹ is cyano, C₁-C₄-alkyl, such as methyl, ethyl, n-propyl or isopropyl, C₁-C₄-haloalkyl, such as fluoromethyl, difluoromethyl or trifluoromethyl, halogen, such as fluorine, chlorine or bromine, C₁-C₄-alkylsulfonyl, such as methylsulfonyl, ethylsulfonyl, n-propylsulfonyl or isopropylsulfonyl, or CO—R¹⁶;
   in addition C₁-C₄-haloalkoxy, such as fluoromethoxy, difluoromethoxy, trifluoromethoxy, or C₁-C₄-haloalkylthio, such as fluorothiomethyl, difluorothiomethyl or trifluorothiomethyl, or C₁-C₄-alkylsulfinyl, such as methylsulfinyl, ethylsulfinyl, n-propylsulfinyl or isopropylsulfinyl;
   preferably cyano, C₁-C₄-alkyl, such as methyl, ethyl, n-propyl or isopropyl, C₁-C₄-haloalkyl, such as fluoromethyl, difluoromethyl or trifluoromethyl, halogen, such as fluorine, chlorine or bromine, C₁-C₄-alkylsulfonyl, such as methylsulfonyl, ethylsulfonyl, n-propylsulfonyl or isopropylsulfonyl;
   likewise preferably C₁-C₄-haloalkoxy, such as fluoromethoxy, difluoromethoxy, or trifluoromethoxy, or C₁-C₄-haloalkylthio, such as fluorothiomethyl, difluorothiomethyl or trifluorothiomethyl, or C₁-C₄-alkylsulfinyl, such as methylsulfinyl, ethylsulfinyl, n-propylsulfinyl or isopropylsulfinyl;
   particularly preferably trifluoromethyl, chlorine, bromine;
   furthermore particularly preferably fluorine, fluoromethyl, difluoromethyl, fluoromethoxy, difluoromethoxy or trifluoromethoxy, fluorothiomethyl, difluorothiomethyl or trifluorothiomethyl, methylsulfonyl or methylsulfinyl;
R¹², R¹³ and R¹⁴ are hydrogen, cyano, halogen, such as fluorine, chlorine or bromine, C₁-C₄-haloalkyl, such as fluoromethyl, difluoromethyl or trifluoromethyl, C₁-C₄-alkyl, such as methyl, ethyl, n-propyl or isopropyl, C₁-C₄-alkylsulfonyl, such as methylsulfonyl, ethylsulfonyl, n-propylsulfonyl or isopropylsulfonyl, C₁-C₄-alkoxy, such as methoxy, ethoxy, n-propoxy or isopropoxy, halomethoxy, such as fluoromethoxy, difluoromethoxy or trifluoromethoxy, or CO—R¹⁶;
   furthermore halomethylthio, such as fluorothiomethyl, difluorothiomethyl or trifluorothiomethyl;
   preferably hydrogen, cyano, halogen, such as fluorine, chlorine or bromine, C₁-C₄-haloalkyl, such as fluoromethyl, difluoromethyl or trifluoromethyl, C₁-C₄-alkyl, such as methyl, ethyl, n-propyl or isopropyl, C₁-C₄-alkylsulfonyl, such as methylsulfonyl, ethylsulfonyl, n-propylsulfonyl or isopropylsulfonyl, C₁-C₄-alkoxy, such as methoxy, ethoxy, n-propoxy or isopropoxy, halomethoxy, such as fluoromethoxy, difluoromethoxy or trifluoromethoxy;
   furthermore halomethylthio, such as fluorothiomethyl, difluorothiomethyl or trifluorothiomethyl;
   particularly preferably hydrogen, halogen, such as fluorine or chlorine, C₁-C₄-haloalkyl, such as fluoromethyl, difluoromethyl or trifluoromethyl, C₁-C₄-alkyl, such as methyl, ethyl, n-propyl or isopropyl;
   likewise particularly preferably halomethoxy, such as fluoromethoxy, difluoromethoxy or trifluoromethoxy, halomethylthio, such as fluorothiomethyl, difluorothiomethyl, or trifluorothiomethyl;
R¹² is very particularly preferably hydrogen, cyano, fluorine, chlorine, methyl, fluoromethyl, difluoromethyl or trifluoromethyl, fluoromethoxy, difluoromethoxy, trifluoromethoxy, fluorothiomethyl, difluorothiomethyl, trifluorothiomethyl,
R¹³ is very particularly preferably hydrogen, fluorine or chlorine;
R¹⁴ is very particularly preferably hydrogen;
R¹⁵ is hydrogen; and
R¹⁶ is C₁-C₄-alkoxy, such as methoxy, ethoxy, n-propoxy, isopropoxy, n-butoxy or t-butoxy, C₁-C₄-alkyl, such as methyl, ethyl, n-propyl or isopropyl, C₁-alkyl, such as fluoromethyl, difluoromethyl or trifluoromethyl, or C₁-haloalkoxy, such as fluoromethoxy, difluoromethoxy or trifluoromethoxy.

Preference is also given to phenylalanine derivatives of the formula I in which the radicals
R¹, R², R⁴ and R⁵ are hydrogen, halogen, hydroxyl, mercapto, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₂-C₆-haloalkenyl, C₂-C₆-haloalkynyl, C₁-C₆-haloalkoxy, C₃-C₆-haloalkenyloxy, C₃-C₆-haloalkynyloxy, C₁-C₆-haloalkylthio, C₃-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, formyl, C₁-C₆-alkylcarbonyloxy, C₁-C₆-alkoxy-C₁-C₄-alkyl, C₃-C₆-alkenyloxy-C₁-C₄-alkyl, C₃-C₄-alkynyloxy-C₁-C₄-alkyl, C₁-C₆-alkylthio-C₁-C₄-alkyl, C₃-C₆-alkenylthio-C₁-C₄-alkyl, C₃-C₄-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkoxycarbonyl-C₁-C₄-alkyl, C₁-C₆-alkoxy-C₁-C₄-alkoxy, C₃-C₆-alkenyloxy-C₁-C₄-alkoxy, C₃-C₄-alkynyloxy-C₁-C₄-alkoxy, C₁-C₆-alkylthio-C₁-C₄-alkoxy, C₃-C₆-alkenylthio-C₁-C₄-alkoxy, C₃-C₆-alkynylthio-C₁-C₄-alkoxy, C₁-C₆-alkylcarbonyl-C₁-C₄-alkoxy, C₁-C₆-alkylcarbonyloxy-C₁-C₄-alkoxy, C₁-C₆-alkoxycarbonyl-C₁-C₄-alkoxy or CO—R¹⁶;
R³ is hydrogen, mercapto, C₁-C₆-alkyl, C₂-C₆-alkenyl, C₂-C₆-alkynyl, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₂-C₆-haloalkenyl, C₂-C₆-haloalkynyl, C₁-C₆-haloalkylthio, C₃-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, C₁-C₆-alkoxy-C₁-C₄-alkyl, C₃-C₆-alkenyloxy-C₁-C₄-alkyl, C₃-C₄-alkynyloxy-C₁-C₄-alkyl, C₁-C₆-alkylthio-C₁-C₄-alkyl, C₃-C₆-alkenylthio-C₁-C₄-alkyl, C₃-C₆-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkyloxycarbonyl-C₁-C₄-alkyl, or CO—R¹⁶.

Preference is also given to phenylalanine derivatives of the formula I in which R¹, R², R³, R⁴ and R⁵ are hydrogen.

Preference is also liven to phenylalanine derivatives of the formula I in which
R¹, R² and R³ in each case independentlly of one another are hydrogen, fluorine, chlorine, methyl or trifluoromethyl;
R⁴, R⁵, R⁶, R⁹, R¹⁰ and R¹⁵ are hydrogen;
R⁷ is hydrogen or methyl;
R⁸ is methyl;
R¹¹, R¹², R¹³ and R¹⁴ in each case independently of one another are hydrogen, bromine, methylsulfonyl, fluorine, chlorine, methyl, trifluoromethyl, difluoromethyl, methoxy, cyano, preferably H, fluorine, chlorine, methyl, trifluoromethyl, difluoromethyl, ethoxy or cyano.

Particular preference is also given to phenylalanine derivatives of the formula I′ (R⁴, R⁶, R¹⁰, R¹⁴ and R¹⁵ are hydrogen) in which 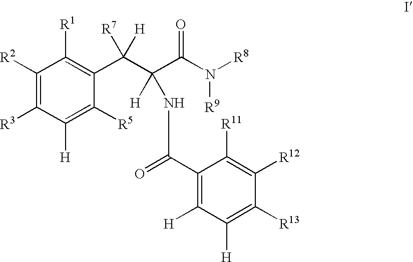
R¹, R², R³, R⁵ in each case independently of one another are hydrogen, fluorine, chlorine, methyl or ethyl;
R⁷ is hydrogen, methyl or ethyl;
R⁸ is methoxy, methyl or hydroxyl;
R⁹ is hydrogen;
   is methyl if R⁸ is hydroxyl;
R¹¹ is fluorine, chlorine, halomethyl, such as fluoromethyl, difluoromethyl, trifluoromethyl, halomethoxy, such as fluoromethoxy, difluoromethoxy, trifluoromethoxy, halothioalkyl, such as fluorothiomethyl, difluorothiomethyl, trifluorothiomethyl, methylsulfinyl or methylsulfonyl;
R¹² is hydrogen, cyano, methyl, fluorine, chlorine, halomethyl, such as fluoromethyl, difluoromethyl, trifluoromethyl, halomethoxy, such as fluoromethoxy, difluoromethoxy, trifluoromethoxy, halothioalkyl, such as fluorothiomethyl, difluorothiomethyl, trifluorothiomethyl;
R¹³ is hydrogen, fluorine, chlorine.

In particular with a view to their use, preference is also given to the compounds I′ compiled in the tables below.

Table 1:

Compounds of the formula I′ (R⁴, R⁶, R¹⁰, R¹⁴ and R¹⁵ are hydrogen) in which R³ is H, R⁵ is H, R⁷ is H, R⁹ is H and R⁸ is CH₃ and the combination of the substituents R¹, R², R¹¹, R¹² and R¹³ for a compound corresponds in each case to a row of table A.

Table 2:

Compounds of the formula I′, in which R³ is H, R⁵ is H, R⁷ is H, R⁹ is H and R⁸ is OCH₃ and the combination of the substituents R¹, R², R¹¹, R¹² and R¹³ for a compound corresponds in each case to a row of table A.

Table 3:

Compounds of the formula I′, in which R³ is H, R⁵ is H, R⁷ is H, R⁹ is H and R⁸ is OH and the combination of the substituents R¹, R², R¹¹, R¹² and R¹³ for a compound corresponds in each case to a row of table A.

Table 4:

Compounds of the formula I′, in which R³ is H, R⁵ is H, R⁷ is H, R⁹ is CH₃ and R⁸ is OH and the combination of the substituents R¹, R², R¹¹, R¹² and R¹³ for a compound corresponds in each case to a row of table A.

Tabelle 5:

Compounds of the formula I′, in which R³ is H, R⁵ is H, R⁷ is CH₃, R⁹ is H and R⁸ is CH₃ and the combination of the substituents R¹, R², R¹¹, R¹² and R¹³ for a compound corresponds in each case to a row of table A.

Table 6:

Compounds of the formula I′, in which R³ is H, R⁵ is H, R⁷ is CH₃, R⁹ is H and R⁸ is OCH₃ and the combination of the substituents R¹, R², R¹¹, R¹² and R¹³ for a compound corresponds in each case to a row of table A.

Table 7:

Compounds of the formula I′, in which R³ is H, R⁵ is H, R⁷ is CH₃, R⁹ is H and R⁸ is OH and the combination of the substituents R¹, R², R¹¹, R¹² and R¹³ for a compound corresponds in each case to a row of table A.

Table 8:

Compounds of the formula I′, in which R³ is H, R⁵ is H, R⁷ is CH₃, R⁹ is CH₃ and R⁸ is OH and the combination of the substituents R¹, R², R¹¹, R¹² and R¹³ for a compound corresponds in each case to a row of table A.

Table 9:

Compounds of the formula I′, in which R³ is H, R⁵ is H, R⁷ is CH₂CH₃, R⁹ is H and R⁸ is CH₃ and the combination of the substituents R¹, R², R¹¹, R¹² and R¹³ for a compound corresponds in each case to a row of table A.

Table 10:

Compounds of the formula I′, in which R³ is H, R⁵ is H, R⁷ is CH₂CH₃, R⁹ is H and R⁸ is OCH₃ and the combination of the substituents R¹, R², R¹¹, R¹² and R¹³ for a compound corresponds in each case to a row of table A.

Table 11:

Compounds of the formula I′, in which R³ is H, R⁵ is H, R⁷ is CH₂CH₃, R⁹ is H and R⁸ is OH and the combination of the substituents R¹, R², R¹¹, R¹² and R¹³ for a compound corresponds in each case to a row of table A.

Table 12:

Compounds of the formula I′, in which R³ is H, R⁵ is H, R⁷ is CH₂CH₃, R⁹ is CH₃ and R⁸ is OH and the combination of the substituents R¹, R², R¹¹, R¹² and R¹³ for a compound corresponds in each case to a row of table A.

Table 13:

Compounds of the formula I′, in which R³ is H, R⁵ is F, R⁷ is H, R⁹ is H and R⁸ is CH₃ and the combination of the substituents R¹, R², R¹¹, R¹² and R¹³ for a compound corresponds in each case to a row of table A.

Table 14:

Compounds of the formula I′, in which R³ is H, R⁵ is F, R⁷ is H, R⁹ is H and R⁸ is OCH₃ and the combination of the substituents R¹, R², R¹¹, R¹² and R¹³ for a compound corresponds in each case to a row of table A.

Table 15:

Compounds of the formula I′, in which R³ is H, R⁵ is F, R⁷ is H, R⁹ is H and R⁸ is OH and the combination of the substituents R¹, R², R¹¹, R¹² and R¹³ for a compound corresponds in each case to a row of table A.

Table 16:

Compounds of the formula I′, in which R³ is H, R⁵ is F, R⁷ is H, R⁹ is CH₃ and R⁸ is OH and the combination of the substituents R¹, R², R¹¹, R¹² and R¹³ for a compound corresponds in each case to a row of table A.

Table 17:

Compounds of the formula II, in which R³ is H, R⁵ is F, R⁷ is CH₃, R⁹ is H and R⁸ is CH₃ and the combination of the substituents R¹, R², R¹¹, R¹² and R¹³ for a compound corresponds in each case to a row of table A.

Table 18:

Compounds of the formula I′, in which R³ is H, R⁵ is F, R⁷ is CH₃, R⁹ is H and R⁸ is OCH₃ and the combination of the substituents R¹, R², R¹¹, R¹² and R¹³ for a compound corresponds in each case to a row of table A.

Table 19:

Compounds of the formula I′, in which R³ is H, R⁵ is F, R⁷ is CH₃, R⁹ is H and R⁸ is OH and the combination of the substituents R¹, R², R¹¹, R¹² and R¹³ for a compound corresponds in each case to a row of table A.

Table 20: Compounds of the formula I′, in which R³ is H, R⁵ is F, R⁷ is CH₃, R⁹ is CH₃ and R⁸ is OH and the combination of the substituents R¹, R², R¹¹, R¹² and R¹³ for a compound corresponds in each case to a row of table A.

Table 21:

Compounds of the formula I′, in which R³ is H, R⁵ is F, R⁷ is CH₂CH₃, R⁹ is H and R⁸ is CH₃ and the combination of the substituents R¹, R², R¹¹, R¹² and R¹³ for a compound corresponds in each case to a row of table A.

Table 22:

Compounds of the formula I′, in which R³ is H, R⁵ is F, R⁷ is CH₂CH₃, R⁹ is H and R⁸ is OCH₃ and the combination of the substituents R¹, R², R¹¹, R¹² and R¹³ for a compound corresponds in each case to a row of table A.

Table 23:

Compounds of the formula I′, in which R³ is H, R⁵ is F, R⁷ is CH₂CH₃, R⁹ is H and R⁸ is OH and the combination of the substituents R¹, R², R¹¹, R¹² and R¹³ for a compound corresponds in each case to a row of table A.

Table 24:

Compounds of the formula I′, in which R³ is H, R⁵ is F, R⁷ is CH₂CH₃, R⁹ is CH₃ and R⁸ is OH and the combination of the substituents R¹, R², R¹¹, R¹² and R¹³ for a compound corresponds in each case to a row of table A.

Table 25:

Compounds of the formula I′, in which R³ is H, R⁵ is Cl, R⁷ is H, R⁹ is H and R⁸ is CH₃ and the combination of the substituents R¹, R², R¹¹, R¹² and R¹³ for a compound corresponds in each case to a row of table A.

Table 26:

Compounds of the formula II, in which R³ is H, R⁵ is Cl, R⁷ is H, R⁹ is H and R⁸ is OCH₃ and the combination of the substituents R¹, R², R¹¹, R¹² and R¹³ for a compound corresponds in each case to a row of table A.

Table 27:

Compounds of the formula I′, in which R³ is H, R⁵ is Cl, R⁷ is H, R⁹ is H and R⁸ is OH and the combination of the substituents R¹, R², R¹¹, R¹² and R¹³ for a compound corresponds in each case to a row of table A.

Table 28:

Compounds of the formula I′, in which R³ is H, R⁵ is Cl, R⁷ is H, R⁹ is CH₃ and R⁸ is OH and the combination of the substituents R¹, R², R¹¹, R¹² and R¹³ for a compound corresponds in each case to a row of table A.

Table 29:

Compounds of the formula I′, in which R³ is H, R⁵ is Cl, R⁷ is CH₃, R⁹ is H and R⁸ is CH₃ and the combination of the substituents R¹, R², R¹¹, R¹² and R¹³ for a compound corresponds in each case to a row of table A.

Table 30:

Compounds of the formula I′, in which R³ is H, R⁵ is Cl, R⁷ is CH₃, R⁹ is H and R⁸ is OCH₃ and the combination of the substituents R¹, R², R¹¹, R¹² and R¹³ for a compound corresponds in each case to a row of table A.

Table 31:

Compounds of the formula I′, in which R³ is H, R⁵ is Cl, R⁷ is CH₃, R⁹ is H and R⁸ is OH and the combination of the substituents R¹, R², R¹¹, R¹² and R¹³ for a compound corresponds in each case to a row of table A.

Table 32:

Compounds of the formula I′, in which R³ is H, R⁵ is Cl, R⁷ is CH₃, R⁹ is CH₃ and R⁸ is OH and the combination of the substituents R¹, R², R¹¹, R¹² and R¹³ for a compound corresponds in each case to a row of table A.

Table 33:

Compounds of the formula I′, in which R³ is H, R⁵ is Cl, R⁷ is CH₂CH₃, R⁹ is H and R⁸ is CH₃ and the combination of the substituents R¹, R², R¹¹, R¹² and R¹³ for a compound corresponds in each case to a row of table A.

Table 34:

Compounds of the formula I′, in which R³ is H, R⁵ is Cl, R⁷ is CH₂CH₃, R⁹ is H and R⁸ is OCH₃ and the combination of the substituents R¹, R², R¹¹, R¹² and R¹³ for a compound corresponds in each case to a row of table A.

Table 35:

Compounds of the formula I′, in which R³ is H, R⁵ is Cl, R⁷ is CH₂CH₃, R⁹ is H and R⁸ is OH and the combination of the substituents R¹, R², R¹¹, R¹² and R¹³ for a compound corresponds in each case to a row of table A.

Table 36:

Compounds of the formula I′, in which R³ is H, R⁵ is Cl, R⁷ is CH₂CH₃, R⁹ is CH₃ and R⁸ is OH and the combination of the substituents R¹, R², R¹¹, R¹² and R¹³ for a compound corresponds in each case to a row of table A.

Table 37:

Compounds of the formula I′, in which R³ is H, R⁵ is CH₃, R⁷ is H, R⁹ is H and R⁸ is CH₃ and the combination of the substituents R¹, R², R¹¹, R¹² and R¹³ for a compound corresponds in each case to a row of table A.

Table 38:

Compounds of the formula I′, in which R³ is H, R⁵ is CH₃, R⁷ is H, R⁹ is H and R⁸ is OCH₃ and the combination of the substituents R¹, R², R¹¹, R¹² and R¹³ for a compound corresponds in each case to a row of table A.

Table 39:

Compounds of the formula I′, in which R³ is H, R⁵ is CH₃, R⁷ is H, R⁹ is H and R⁸ is OH and the combination of the substituents R¹, R², R¹¹, R¹² and R¹³ for a compound corresponds in each case to a row of table A.

Table 40:

Compounds of the formula I′, in which R³ is H, R⁵ is CH₃, R⁷ is H, R⁹ is CH₃ and R⁸ is OH and the combination of the substituents R¹, R², R¹¹, R¹² and R¹³ for a compound corresponds in each case to a row of table A.

Table 41:

Compounds of the, formula I′, in which R³ is H, R⁵ is CH₃, R⁷ is CH₃, R⁹ is H and R⁸ is CH₃ and the combination of the substituents R¹, R², R¹¹, R¹² and R¹³ for a compound corresponds in each case to a row of table A.

Table 42:

Compounds of the formula I′, in which R³ is H, R⁵ is CH₃, R⁷ is CH₃, R⁹ is H and R⁸ is OCH₃ and the combination of the substituents R¹, R², R¹¹, R¹² and R¹³ for a compound corresponds in each case to a row of table A.

Table 43:

Compounds of the formula I′, in which R³ is H, R⁵ is CH₃, R⁷ is CH₃, R⁹ is H and R⁸ is OH and the combination of the substituents R¹, R², R¹¹, R¹² and R¹³ for a compound corresponds in each case to a row of table A.

Table 44:

Compounds of the formula I′, in which R³ is H, R⁵ is CH₃, R⁷ is CH₃, R⁹ is CH₃ and R⁸ is OH and the combination of the substituents R¹, R², R¹¹, R¹² and R¹³ for a compound corresponds in each case to a row of table A.

Table 45:

Compounds of the formula I′, in which R³ is H, R⁵ is CH₃, R⁷ is CH₂CH₃, R⁹ is H and R⁸ is CH₃ and the combination of the substituents R¹, R², R¹¹, R¹² and R¹³ for a compound corresponds in each case to a row of table A.

Table 46:

Compounds of the formula I′, in which R³ is H, R⁵ is CH₃, R⁷ is CH₂CH₃, R⁹ is H and R⁸ is OCH₃ and the combination of the substituents R¹, R², R¹¹, R¹² and R¹³ for a compound corresponds in each case to a row of table A.

Table 47:

Compounds of the formula I′, in which R³ is H, R⁵ is CH₃, R⁷ is CH₂CH₃, R⁹ is H and R⁸ is OH and the combination of the substituents R¹, R², R¹¹, R¹² and R¹³ for a compound corresponds in each case to a row of table A.

Table 48:

Compounds of the formula I′, in which R³ is H, R⁵ is CH₃, R⁷ is CH₂CH₃, R⁹ is CH₃ and R⁸ is OH and the combination of the substituents R¹, R², R¹¹, R¹² and R¹³ for a compound corresponds in each case to a row of table A.

Table 49:

Compounds of the formula I′, in which R³ is F, R⁵ is H, R⁷ is H, R⁹ is H and R⁸ is CH₃ and the combination of the substituents R¹, R², R¹¹, R¹² and R¹³ for a compound corresponds in each case to a row of table A.

Table 50:

Compounds of the formula I′, in which R³ is F, R⁵ is H, R⁷ is H, R⁹ is H and R⁸ is OCH₃ and the combination of the substituents R¹, R², R¹¹, R¹² and R¹³ for a compound corresponds in each case to a row of table A.

Table 51:

Compounds of the formula I′, in which R³ is F, R⁵ is H, R⁷ is H, R⁹ is H and R⁸ is OH and the combination of the substituents R¹, R², R¹¹, R¹² and R¹³ for a compound corresponds in each case to a row of table A.

Table 52:

Compounds of the formula I′, in which R³ is F, R⁵ is H, R⁷ is H, R⁹ is CH₃ and R⁸ is OH and the combination of the substituents R¹, R², R¹¹, R¹² and R¹³ for a compound corresponds in each case to a row of table A.

Table 53:

Compounds of the formula I′, in which R³ is F, R⁵ is H, R⁷ is CH₃, R⁹ is H and R⁸ is CH₃ and the combination of the substituents R¹, R², R¹¹, R¹² and R¹³ for a compound corresponds in each case to a row of table A.

Table 54:

Compounds of the formula I′, in which R³ is F, R⁵ is H, R⁷ is CH₃, R⁹ is H and R⁸ is OCH₃ and the combination of the substituents R¹, R², R¹¹, R¹² and R¹³ for a compound corresponds in each case to a row of table A.

Table 55:

Compounds of the formula I′, in which R³ is F, R⁵ is H, R⁷ is CH₃, R⁹ is H and R⁸ is OH and the combination of the substituents R¹, R², R¹¹, R¹² and R¹³ for a compound corresponds in each case to a row of table A.

Table 56:

Compounds of the formula I′, in which R³ is F, R⁵ is H, R⁷ is CH₃, R⁹ is CH₃ and R⁸ is OH and the combination of the substituents R¹, R², R¹¹, R¹² and R¹³ for a compound corresponds in each case to a row of table A.

Table 57:

Compounds of the formula I′, in which R³ is F, R⁵ is H, R⁷ is CH₂CH₃, R⁹ is H and R⁸ is CH₃ and the combination of the substituents R¹, R², R¹¹, R¹² and R¹³ for a compound corresponds in each case to a row of table A.

Table 58:

Compounds of the formula I′, in which R³ is F, R⁵ is H, R⁷ is CH₂CH₃, R⁹ is H and R⁸ is OCH₃ and the combination of the substituents R¹, R², R¹¹, R¹² and R¹³ for a compound corresponds in each case to a row of table A.

Table 59:

Compounds of the formula I′, in which R³ is F, R⁵ is H, R⁷ is CH₂CH₃, R⁹ is H and R⁸ is OH and the combination of the substituents R¹, R², R¹¹, R¹² and R¹³ for a compound corresponds in each case to a row of table A.

Table 60:

Compounds of the formula I′, in which R³ is F, R⁵ is H, R⁷ is CH₂CH₃, R⁹ is CH₃ and R⁸ is OH and the combination of the substituents R¹, R², R¹¹, R¹² and R¹³ for a compound corresponds in each case to a row of table A.

Table 61:

Compounds of the formula I′, in which R³ is F, R⁵ is F, R⁷ is H, R⁹ is H and R⁸ is CH₃ and the combination of the substituents R¹, R², R¹¹, R¹² and R¹³ for a compound corresponds in each case to a row of table A.

Table 62:

Compounds of the formula I′, in which R³ is F, R⁵ is F, R⁷ is H, R⁹ is H and R⁸ is OCH₃ and the combination of the substituents R¹, R², R¹¹, R¹² and R¹³ for a compound corresponds in each case to a row of table A.

Table 63:

Compounds of the formula I′, in which R³ is F, R⁵ is F, R⁷ is H, R⁹ is H and R⁸ is OH and the combination of the substituents R¹, R², R¹¹, R¹² and R¹³ for a compound corresponds in each case to a row of table A.

Table 64:

Compounds of the formula I′, in which R³ is F, R⁵ is F, R⁷ is H, R⁹ is CH₃ and R⁸ is OH and the combination of the substituents R¹, R², R¹¹, R¹² and R¹³ for a compound corresponds in each case to a row of table A.

Table 65:

Compounds of the formula I′, in which R³ is F, R⁵ is F, R⁷ is CH₃, R⁹ is H and R⁸ is CH₃ and the combination of the substituents R¹, R², R¹¹, R¹² and R¹³ for a compound corresponds in each case to a row of table A.

Table 66:

Compounds of the formula I′, in which R³ is F, R⁵ is F, R⁷ is CH₃, R⁹ is H and R⁸ is OCH₃ and the combination of the substituents R¹, R², R¹¹, R¹² and R¹³ for a compound corresponds in each case to a row of table A.

Table 67:

Compounds of the formula I′, in which R³ is F, R⁵ is F, R⁷ is CH₃, R⁹ is H and R⁸ is OH and the combination of the substituents R¹, R², R¹¹, R¹² and R¹³ for a compound corresponds in each case to a row of table A.

Table 68:

Compounds of the formula I′, in which R³ is F, R⁵ is F, R⁷ is CH₃, R⁹ is CH₃ and R⁸ is OH and the combination of the substituents R¹, R², R¹¹, R¹² and R¹³ for a compound corresponds in each case to a row of table A.

Table 69:

Compounds of the formula I′, in which R³ is F, R⁵ is F, R⁷ is CH₂CH₃, R⁹ is H and R⁸ is CH₃ and the combination of the substituents R¹, R², R¹¹, R¹² and R¹³ for a compound corresponds in each case to a row of table A.

Table 70:

Compounds of the formula I′, in which R³ is F, R⁵ is F, R⁷ is CH₂CH₃, R⁹ is H and R⁸ is OCH₃ and the combination of the substituents R¹, R², R¹, R¹² and R¹³ for a compound corresponds in each case to a row of table A.

Table 71:

Compounds of the formula I′, in which R³ is F, R⁵ is F, R⁷ is CH₂CH₃, R⁹ is H and R⁸ is OH and the combination of the substituents R¹, R², R¹¹, R¹² and R¹³ for a compound corresponds in each case to a row of table A.

Table 72:

Compounds of the formula I′, in which R³ is F, R⁵ is F, R⁷ is CH₂CH₃, R⁹ is CH₃ and R⁸ is OH and the combination of the substituents R¹, R², R¹¹, R¹² and R¹³ for a compound corresponds in each case to a row of table A.

Table 73:

Compounds of the formula I′, in which R³ is F, R⁵ is Cl, R⁷ is H, R⁹ is H and R⁸ is CH₃ and the combination of the substituents R¹, R², R¹¹, R¹² and R¹³ for a compound corresponds in each case to a row of table A.

Table 74:

Compounds of the formula I′, in which R³ is F, R⁵ is Cl, R⁷ is H, R⁹ is H and R⁸ is OCH₃ and the combination of the substituents R¹, R², R¹¹, R¹² and R¹³ for a compound corresponds in each case to a row of table A.

Table 75:

Compounds of the formula I′, in which R³ is F, R⁵ is Cl, R⁷ is H, R⁹ is H and R⁸ is OH and the combination of the substituents R¹, R², R¹¹, R¹² and R¹³ for a compound corresponds in each case to a row of table A.

Table 76:

Compounds of the formula I′, in which R³ is F, R⁵ is Cl, R⁷ is H, R⁹ is CH₃ and R⁸ is OH and the combination of the substituents R¹, R², R¹¹, R¹² and R¹³ for a compound corresponds in each case to a row of table A.

Table 77:

Compounds of the formula I′, in which R³ is F, R⁵ is Cl, R⁷ is CH₃, R⁹ is H and R⁸ is CH₃ and the combination of the substituents R¹, R², R¹¹, R¹² and R¹³ for a compound corresponds in each case to a row of table A.

Table 78:

Compounds of the formula I′, in which R³ is F, R⁵ is Cl, R⁷ is CH₃, R⁹ is H and R⁸ is OCH₃ and the combination of the substituents R¹, R², R¹¹, R¹² and R¹³ for a compound corresponds in each case to a row of table A.

Table 79:

Compounds of the formula I′, in which R³ is F, R⁵ is Cl, R⁷ is CH₃, R⁹ is H and R⁸ is OH and the combination of the substituents R¹, R², R¹¹, R¹² and R¹³ for a compound corresponds in each case to a row of table A.

Table 80:

Compounds of the formula I′, in which R³ is F, R⁵ is Cl, R⁷ is CH₃, R⁹ is CH₃ and R⁸ is OH and the combination of the substituents R¹, R², R¹¹, R¹² and R¹³ for a compound corresponds in each case to a row of table A.

Table 81:

Compounds of the formula I′, in which R³ is F, R⁵ is Cl, R⁷ is CH₂CH₃, R⁹ is H and R⁸ is CH₃ and the combination of the substituents R¹, R², R¹¹, R¹² and R¹³ for a compound corresponds in each case to a row of table A.

Table 82:

Compounds of the formula I′, in which R³ is F, R⁵ is Cl, R⁷ is CH₂CH₃, R⁹ is H and R⁸ is OCH₃ and the combination of the substituents R¹, R², R¹¹, R¹² and R¹³ for a compound corresponds in each case to a row of table A.

Table 83:

Compounds of the formula I′, in which R³ is F, R⁵ is Cl, R⁷ is CH₂CH₃, R⁹ is H and R⁸ is OH and the combination of the substituents R¹, R², R¹¹, R¹² and R¹³ for a compound corresponds in each case to a row of table A.

Table 84:

Compounds of the formula I′, in which R³ is F, R⁵ is Cl, R⁷ is CH₂CH₃, R⁹ is CH₃ and R⁸ is OH and the combination of the substituents R¹, R², R¹¹, R¹² and R¹³ for a compound corresponds in each case to a row of table A.

Table 85:

Compounds of the formula I′, in which R³ is F, R⁵ is CH₃, R⁷ is H, R⁹ is H and R⁸ is CH₃ and the combination of the substituents R¹, R², R¹¹, R¹² and R¹³ for a compound corresponds in each case to a row of table A.

Table 86:

Compounds of the formula I′, in which R³ is F, R⁵ is CH₃, R⁷ is H, R⁹ is H and R⁸ is OCH₃ and the combination of the substituents R¹, R², R¹¹, R¹² and R¹³ for a compound corresponds in each case to a row of table A.

Table 87:

Compounds of the formula I′, in which R³ is F, R⁵ is CH₃, R⁷ is H, R⁹ is H and R⁸ is OH and the combination of the substituents R¹, R², R¹¹, R¹² and R¹³ for a compound corresponds in each case to a row of table A.

Table 88:

Compounds of the formula I′, in which R³ is F, R⁵ is CH₃, R⁷ is H, R⁹ is CH₃ and R⁸ is OH and the combination of the substituents R¹, R², R¹¹, R¹² and R¹³ for a compound corresponds in each case to a row of table A.

Table 89:

Compounds of the formula I′, in which R³ is F, R⁵ is CH₃, R⁷ is CH₃, R⁹ is H and R⁸ is CH₃ and the combination of the substituents R¹, R², R¹¹, R¹² and R¹³ for a compound corresponds in each case to a row of table A.

Table 90:

Compounds of the formula I′, in which R³ is F, R⁵ is CH₃, R⁷ is CH₃, R⁹ is H and R⁸ is OCH₃ and the combination of the substituents R¹, R², R¹¹, R¹² and R¹³ for a compound corresponds in each case to a row of table A.

Table 91:

Compounds of the formula I′, in which R³ is F, R⁵ is CH₃, R⁷ is CH₃, R⁹ is H and R⁸ is OH and the combination of the substituents R¹, R², R¹¹, R¹² and R¹³ for a compound corresponds in each case to a row of table A.

Table 92:

Compounds of the formula I′, in which R³ is F, R⁵ is CH₃, R⁷ is CH₃, R⁹ is CH₃ and R⁸ is OH and the combination of the substituents R¹, R², R¹¹, R¹² and R¹³ for a compound corresponds in each case to a row of table A.

Table 93:

Compounds of the formula I′, in which R³ is F, R⁵ is CH₃, R⁷ is CH₂CH₃, R⁹ is H and R⁸ is CH₃ and the combination of the substituents R¹, R², R¹¹, R¹² and R¹³ for a compound corresponds in each case to a row of table A.

Table 94:

Compounds of the formula I′, in which R³ is F, R⁵ is CH₃, R⁷ is CH₂CH₃, R⁹ is H and R⁸ is OCH₃ and the combination of the substituents R¹, R², R¹¹, R¹² and R¹³ for a compound corresponds in each case to a row of table A.

Table 95:

Compounds of the formula I′, in which R³ is F, R⁵ is CH₃, R⁷ is CH₂CH₃, R⁹ is H and R⁸ is OH and the combination of the substituents R¹, R², R¹¹, R¹² and R¹³ for a compound corresponds in each case to a row of table A.

Table 96:

Compounds of the formula I′, in which R³ is F, R⁵ is CH₃, R⁷ is CH₂CH₃, R⁹ is CH₃ and R⁸ is OH and the combination of the substituents R¹, R², R¹¹, R¹² and R¹³ for a compound corresponds in each case to a row of table A.

TABLE 1

| No. | R¹ | R² | R¹¹ | R¹² | R¹³ |
|---|---|---|---|---|---|
| A-1 | H | H | F | H | H |
| A-2 | F | H | F | H | H |
| A-3 | Cl | H | F | H | H |
| A-4 | CH₃ | H | F | H | H |
| A-5 | CH₂CH₃ | H | F | H | H |
| A-6 | H | H | Cl | H | H |
| A-7 | F | H | Cl | H | H |
| A-8 | Cl | H | Cl | H | H |
| A-9 | CH₃ | H | Cl | H | H |
| A-10 | CH₂CH₃ | H | Cl | H | H |
| A-11 | H | H | CHF₂ | H | H |
| A-12 | F | H | CHF₂ | H | H |
| A-13 | Cl | H | CHF₂ | H | H |
| A-14 | CH₃ | H | CHF₂ | H | H |
| A-15 | CH₂CH₃ | H | CHF₂ | H | H |
| A-16 | H | H | CF₃ | H | H |
| A-17 | F | H | CF₃ | H | H |
| A-18 | Cl | H | CF₃ | H | H |
| A-19 | CH₃ | H | CF₃ | H | H |
| A-20 | CH₂CH₃ | H | CF₃ | H | H |
| A-21 | H | H | SCHF₂ | H | H |
| A-22 | F | H | SCHF₂ | H | H |
| A-23 | Cl | H | SCHF₂ | H | H |
| A-24 | CH₃ | H | SCHF₂ | H | H |
| A-25 | CH₂CH₃ | H | SCHF₂ | H | H |
| A-26 | H | H | SCF₃ | H | H |
| A-27 | F | H | SCF₃ | H | H |
| A-28 | Cl | H | SCF₃ | H | H |
| A-29 | CH₃ | H | SCF₃ | H | H |
| A-30 | CH₂CH₃ | H | SCF₃ | H | H |
| A-31 | H | H | OCHF₂ | H | H |
| A-32 | F | H | OCHF₂ | H | H |
| A-33 | Cl | H | OCHF₂ | H | H |
| A-34 | CH₃ | H | OCHF₂ | H | H |
| A-35 | CH₂CH₃ | H | OCHF₂ | H | H |
| A-36 | H | H | OCF₃ | H | H |
| A-37 | F | H | OCF₃ | H | H |
| A-38 | Cl | H | OCF₃ | H | H |
| A-39 | CH₃ | H | OCF₃ | H | H |
| A-40 | CH₂CH₃ | H | OCF₃ | H | H |
| A-41 | H | H | F | F | H |
| A-42 | F | H | F | F | H |
| A-43 | Cl | H | F | F | H |
| A-44 | CH₃ | H | F | F | H |
| A-45 | CH₂CH₃ | H | F | F | H |
| A-46 | H | H | Cl | F | H |
| A-47 | F | H | Cl | F | H |
| A-48 | Cl | H | Cl | F | H |
| A-49 | CH₃ | H | Cl | F | H |
| A-50 | CH₂CH₃ | H | Cl | F | H |
| A-51 | H | H | CHF₂ | F | H |
| A-52 | F | H | CHF₂ | F | H |
| A-53 | Cl | H | CHF₂ | F | H |
| A-54 | CH₃ | H | CHF₂ | F | H |
| A-55 | CH₂CH₃ | H | CHF₂ | F | H |
| A-56 | H | H | CF₃ | F | H |
| A-57 | F | H | CF₃ | F | H |
| A-58 | Cl | H | CF₃ | F | H |
| A-59 | CH₃ | H | CF₃ | F | H |
| A-60 | CH₂CH₃ | H | CF₃ | F | H |
| A-61 | H | H | SCHF₂ | F | H |
| A-62 | F | H | SCHF₂ | F | H |
| A-63 | Cl | H | SCHF₂ | F | H |
| A-64 | CH₃ | H | SCHF₂ | F | H |
| A-65 | CH₂CH₃ | H | SCHF₂ | F | H |
| A-66 | H | H | SCF₃ | F | H |
| A-67 | F | H | SCF₃ | F | H |
| A-68 | Cl | H | SCF₃ | F | H |
| A-69 | CH₃ | H | SCF₃ | F | H |
| A-70 | CH₂CH₃ | H | SCF₃ | F | H |
| A-71 | H | H | OCHF₂ | F | H |
| A-72 | F | H | OCHF₂ | F | H |
| A-73 | Cl | H | OCHF₂ | F | H |
| A-74 | CH₃ | H | OCHF₂ | F | H |
| A-75 | CH₂CH₃ | H | OCHF₂ | F | H |
| A-76 | H | H | OCF₃ | F | H |
| A-77 | F | H | OCF₃ | F | H |
| A-78 | Cl | H | OCF₃ | F | H |
| A-79 | CH₃ | H | OCF₃ | F | H |
| A-80 | CH₂CH₃ | H | OCF₃ | F | H |
| A-81 | H | H | F | Cl | H |
| A-82 | F | H | F | Cl | H |
| A-83 | Cl | H | F | Cl | H |
| A-84 | CH₃ | H | F | Cl | H |
| A-85 | CH₂CH₃ | H | F | Cl | H |
| A-86 | H | H | Cl | Cl | H |
| A-87 | F | H | Cl | Cl | H |
| A-88 | Cl | H | Cl | Cl | H |
| A-89 | CH₃ | H | Cl | Cl | H |
| A-90 | CH₂CH₃ | H | Cl | Cl | H |
| A-91 | H | H | CHF₂ | Cl | H |
| A-92 | F | H | CHF₂ | Cl | H |
| A-93 | Cl | H | CHF₂ | Cl | H |
| A-94 | CH₃ | H | CHF₂ | Cl | H |
| A-95 | CH₂CH₃ | H | CHF₂ | Cl | H |
| A-96 | H | H | CF₃ | Cl | H |
| A-97 | F | H | CF₃ | Cl | H |
| A-98 | Cl | H | CF₃ | Cl | H |
| A-99 | CH₃ | H | CF₃ | Cl | H |
| A-100 | CH₂CH₃ | H | CF₃ | Cl | H |
| A-101 | H | H | SCHF₂ | Cl | H |
| A-102 | F | H | SCHF₂ | Cl | H |
| A-103 | Cl | H | SCHF₂ | Cl | H |
| A-104 | CH₃ | H | SCHF₂ | Cl | H |
| A-105 | CH₂CH₃ | H | SCHF₂ | Cl | H |
| A-106 | H | H | SCF₃ | Cl | H |
| A-107 | F | H | SCF₃ | Cl | H |
| A-108 | Cl | H | SCF₃ | Cl | H |
| A-109 | CH₃ | H | SCF₃ | Cl | H |
| A-110 | CH₂CH₃ | H | SCF₃ | Cl | H |
| A-111 | H | H | OCHF₂ | Cl | H |
| A-112 | F | H | OCHF₂ | Cl | H |
| A-113 | Cl | H | OCHF₂ | Cl | H |
| A-114 | CH₃ | H | OCHF₂ | Cl | H |
| A-115 | CH₂CH₃ | H | OCHF₂ | Cl | H |
| A-116 | H | H | OCF₃ | Cl | H |
| A-117 | F | H | OCF₃ | Cl | H |
| A-118 | Cl | H | OCF₃ | Cl | H |
| A-119 | CH₃ | H | OCF₃ | Cl | H |
| A-120 | CH₂CH₃ | H | OCF₃ | Cl | H |
| A-121 | H | H | F | CHF₂ | H |
| A-122 | F | H | F | CHF₂ | H |
| A-123 | Cl | H | F | CHF₂ | H |
| A-124 | CH₃ | H | F | CHF₂ | H |
| A-125 | CH₂CH₃ | H | F | CHF₂ | H |
| A-126 | H | H | Cl | CHF₂ | H |
| A-127 | F | H | Cl | CHF₂ | H |
| A-128 | Cl | H | Cl | CHF₂ | H |
| A-129 | CH₃ | H | Cl | CHF₂ | H |
| A-130 | CH₂CH₃ | H | Cl | CHF₂ | H |
| A-131 | H | H | CHF2 | CHF₂ | H |
| A-132 | F | H | CHF2 | CHF₂ | H |
| A-133 | Cl | H | CHF2 | CHF₂ | H |
| A-134 | CH₃ | H | CHF2 | CHF₂ | H |
| A-135 | CH₂CH₃ | H | CHF2 | CHF₂ | H |
| A-136 | H | H | CF₃ | CHF₂ | H |
| A-137 | F | H | CF₃ | CHF₂ | H |
| A-138 | Cl | H | CF₃ | CHF₂ | H |
| A-139 | CH₃ | H | CF₃ | CHF₂ | H |
| A-140 | CH₂CH₃ | H | CF₃ | CHF₂ | H |
| A-141 | H | H | SCHF₂ | CHF₂ | H |
| A-142 | F | H | SCHF₂ | CHF₂ | H |
| A-143 | Cl | H | SCHF₂ | CHF₂ | H |
| A-144 | CH₃ | H | SCHF₂ | CHF₂ | H |
| A-145 | CH₂CH₃ | H | SCHF₂ | CHF₂ | H |
| A-146 | H | H | SCF₃ | CHF₂ | H |
| A-147 | F | H | SCF₃ | CHF₂ | H |
| A-148 | Cl | H | SCF₃ | CHF₂ | H |
| A-149 | CH₃ | H | SCF₃ | CHF₂ | H |
| A-150 | CH₂CH₃ | H | SCF₃ | CHF₂ | H |
| A-151 | H | H | OCHF₂ | CHF₂ | H |
| A-152 | F | H | OCHF₂ | CHF₂ | H |
| A-153 | Cl | H | OCHF₂ | CHF₂ | H |
| A-154 | CH₃ | H | OCHF₂ | CHF₂ | H |
| A-155 | CH₂CH₃ | H | OCHF₂ | CHF₂ | H |
| A-156 | H | H | OCF₃ | CHF₂ | H |
| A-157 | F | H | OCF₃ | CHF₂ | H |
| A-158 | Cl | H | OCF₃ | CHF₂ | H |
| A-159 | CH₃ | H | OCF₃ | CHF₂ | H |
| A-160 | CH₂CH₃ | H | OCF₃ | CHF₂ | H |
| A-161 | H | H | F | CF₃ | H |
| A-162 | F | H | F | CF₃ | H |
| A-163 | Cl | H | F | CF₃ | H |
| A-164 | CH₃ | H | F | CF₃ | H |
| A-165 | CH₂CH₃ | H | F | CF₃ | H |
| A-166 | H | H | Cl | CF₃ | H |
| A-167 | F | H | Cl | CF₃ | H |
| A-168 | Cl | H | Cl | CF₃ | H |
| A-169 | CH₃ | H | Cl | CF₃ | H |
| A-170 | CH₂CH₃ | H | Cl | CF₃ | H |
| A-171 | H | H | CHF2 | CF₃ | H |
| A-172 | F | H | CHF2 | CF₃ | H |
| A-173 | Cl | H | CHF2 | CF₃ | H |
| A-174 | CH₃ | H | CHF2 | CF₃ | H |
| A-175 | CH₂CH₃ | H | CHF2 | CF₃ | H |
| A-176 | H | H | CF₃ | CF₃ | H |
| A-177 | F | H | CF₃ | CF₃ | H |
| A-178 | Cl | H | CF₃ | CF₃ | H |
| A-179 | CH₃ | H | CF₃ | CF₃ | H |
| A-180 | CH₂CH₃ | H | CF₃ | CF₃ | H |
| A-181 | H | H | SCHF₂ | CF₃ | H |
| A-182 | F | H | SCHF₂ | CF₃ | H |
| A-183 | Cl | H | SCHF₂ | CF₃ | H |
| A-184 | CH₃ | H | SCHF₂ | CF₃ | H |
| A-185 | CH₂CH₃ | H | SCHF₂ | CF₃ | H |
| A-186 | H | H | SCF₃ | CF₃ | H |
| A-187 | F | H | SCF₃ | CF₃ | H |
| A-188 | Cl | H | SCF₃ | CF₃ | H |
| A-189 | CH₃ | H | SCF₃ | CF₃ | H |
| A-190 | CH₂CH₃ | H | SCF₃ | CF₃ | H |
| A-191 | H | H | OCHF₂ | CF₃ | H |
| A-192 | F | H | OCHF₂ | CF₃ | H |
| A-193 | Cl | H | OCHF₂ | CF₃ | H |
| A-194 | CH₃ | H | OCHF₂ | CF₃ | H |
| A-195 | CH₂CH₃ | H | OCHF₂ | CF₃ | H |
| A-196 | H | H | OCF₃ | CF₃ | H |
| A-197 | F | H | OCF₃ | CF₃ | H |
| A-198 | Cl | H | OCF₃ | CF₃ | H |
| A-199 | CH₃ | H | OCF₃ | CF₃ | H |
| A-200 | CH₂CH₃ | H | OCF₃ | CF₃ | H |
| A-201 | H | H | F | H | F |
| A-202 | F | H | F | H | F |
| A-203 | Cl | H | F | H | F |
| A-204 | CH₃ | H | F | H | F |
| A-205 | CH₂CH₃ | H | F | H | F |
| A-206 | H | H | Cl | H | F |
| A-207 | F | H | Cl | H | F |
| A-208 | Cl | H | Cl | H | F |
| A-209 | CH₃ | H | Cl | H | F |
| A-210 | CH₂CH₃ | H | Cl | H | F |
| A-211 | H | H | CHF2 | H | F |
| A-212 | F | H | CHF2 | H | F |
| A-213 | Cl | H | CHF2 | H | F |
| A-214 | CH₃ | H | CHF2 | H | F |
| A-215 | CH₂CH₃ | H | CHF2 | H | F |
| A-216 | H | H | CF₃ | H | F |
| A-217 | F | H | CF₃ | H | F |
| A-218 | Cl | H | CF₃ | H | F |
| A-219 | CH₃ | H | CF₃ | H | F |
| A-220 | CH₂CH₃ | H | CF₃ | H | F |
| A-221 | H | H | SCHF₂ | H | F |
| A-222 | F | H | SCHF₂ | H | F |
| A-223 | Cl | H | SCHF₂ | H | F |
| A-224 | CH₃ | H | SCHF₂ | H | F |
| A-225 | CH₂CH₃ | H | SCHF₂ | H | F |
| A-226 | H | H | SCF₃ | H | F |
| A-227 | F | H | SCF₃ | H | F |
| A-228 | Cl | H | SCF₃ | H | F |
| A-229 | CH₃ | H | SCF₃ | H | F |
| A-230 | CH₂CH₃ | H | SCF₃ | H | F |
| A-231 | H | H | OCHF₂ | H | F |
| A-232 | F | H | OCHF₂ | H | F |
| A-233 | Cl | H | OCHF₂ | H | F |
| A-234 | CH₃ | H | OCHF₂ | H | F |
| A-235 | CH₂CH₃ | H | OCHF₂ | H | F |
| A-236 | H | H | OCF₃ | H | F |
| A-237 | F | H | OCF₃ | H | F |
| A-238 | Cl | H | OCF₃ | H | F |
| A-239 | CH₃ | H | OCF₃ | H | F |
| A-240 | CH₂CH₃ | H | OCF₃ | H | F |
| A-241 | H | H | F | F | F |
| A-242 | F | H | F | F | F |
| A-243 | Cl | H | F | F | F |
| A-244 | CH₃ | H | F | F | F |
| A-245 | CH₂CH₃ | H | F | F | F |
| A-246 | H | H | Cl | F | F |
| A-247 | F | H | Cl | F | F |
| A-248 | Cl | H | Cl | F | F |
| A-249 | CH₃ | H | Cl | F | F |
| A-250 | CH₂CH₃ | H | Cl | F | F |
| A-251 | H | H | CHF2 | F | F |
| A-252 | F | H | CHF2 | F | F |
| A-253 | Cl | H | CHF2 | F | F |
| A-254 | CH₃ | H | CHF2 | F | F |
| A-255 | CH₂CH₃ | H | CHF2 | F | F |
| A-256 | H | H | CF₃ | F | F |
| A-257 | F | H | CF₃ | F | F |
| A-258 | Cl | H | CF₃ | F | F |
| A-259 | CH₃ | H | CF₃ | F | F |
| A-260 | CH₂CH₃ | H | CF₃ | F | F |
| A-261 | H | H | SCHF₂ | F | F |
| A-262 | F | H | SCHF₂ | F | F |
| A-263 | Cl | H | SCHF₂ | F | F |
| A-264 | CH₃ | H | SCHF₂ | F | F |
| A-265 | CH₂CH₃ | H | SCHF₂ | F | F |
| A-266 | H | H | SCF₃ | F | F |
| A-267 | F | H | SCF₃ | F | F |
| A-268 | Cl | H | SCF₃ | F | F |
| A-269 | CH₃ | H | SCF₃ | F | F |
| A-270 | CH₂CH₃ | H | SCF₃ | F | F |
| A-271 | H | H | OCHF₂ | F | F |
| A-272 | F | H | OCHF₂ | F | F |
| A-273 | Cl | H | OCHF₂ | F | F |
| A-274 | CH₃ | H | OCHF₂ | F | F |
| A-275 | CH₂CH₃ | H | OCHF₂ | F | F |
| A-276 | H | H | OCF₃ | F | F |
| A-277 | F | H | OCF₃ | F | F |
| A-278 | Cl | H | OCF₃ | F | F |
| A-279 | CH₃ | H | OCF₃ | F | F |
| A-280 | CH₂CH₃ | H | OCF₃ | F | F |
| A-281 | H | H | F | Cl | F |
| A-282 | F | H | F | Cl | F |
| A-283 | Cl | H | F | Cl | F |
| A-284 | CH₃ | H | F | Cl | F |
| A-285 | CH₂CH₃ | H | F | Cl | F |
| A-286 | H | H | Cl | Cl | F |
| A-287 | F | H | Cl | Cl | F |
| A-288 | Cl | H | Cl | Cl | F |
| A-289 | CH₃ | H | Cl | Cl | F |
| A-290 | CH₂CH₃ | H | Cl | Cl | F |
| A-291 | H | H | CHF2 | Cl | F |
| A-292 | F | H | CHF2 | Cl | F |
| A-293 | Cl | H | CHF2 | Cl | F |
| A-294 | CH₃ | H | CHF2 | Cl | F |
| A-295 | CH₂CH₃ | H | CHF2 | Cl | F |
| A-296 | H | H | CF₃ | Cl | F |
| A-297 | F | H | CF₃ | Cl | F |
| A-298 | Cl | H | CF₃ | Cl | F |
| A-299 | CH₃ | H | CF₃ | Cl | F |
| A-300 | CH₂CH₃ | H | CF₃ | Cl | F |
| A-301 | H | H | SCHF₂ | Cl | F |
| A-302 | F | H | SCHF₂ | Cl | F |
| A-303 | Cl | H | SCHF₂ | Cl | F |
| A-304 | CH₃ | H | SCHF₂ | Cl | F |
| A-305 | CH₂CH₃ | H | SCHF₂ | Cl | F |
| A-306 | H | H | SCF₃ | Cl | F |
| A-307 | F | H | SCF₃ | Cl | F |
| A-308 | Cl | H | SCF₃ | Cl | F |
| A-309 | CH₃ | H | SCF₃ | Cl | F |
| A-310 | CH₂CH₃ | H | SCF₃ | Cl | F |
| A-311 | H | H | OCHF₂ | Cl | F |
| A-312 | F | H | OCHF₂ | Cl | F |
| A-313 | Cl | H | OCHF₂ | Cl | F |
| A-314 | CH₃ | H | OCHF₂ | Cl | F |
| A-315 | CH₂CH₃ | H | OCHF₂ | Cl | F |
| A-316 | H | H | OCF₃ | Cl | F |
| A-317 | F | H | OCF₃ | Cl | F |
| A-318 | Cl | H | OCF₃ | Cl | F |
| A-319 | CH₃ | H | OCF₃ | Cl | F |
| A-320 | CH₂CH₃ | H | OCF₃ | Cl | F |
| A-321 | H | H | F | CHF₂ | F |
| A-322 | F | H | F | CHF₂ | F |
| A-323 | Cl | H | F | CHF₂ | F |
| A-324 | CH₃ | H | F | CHF₂ | F |
| A-325 | CH₂CH₃ | H | F | CHF₂ | F |
| A-326 | H | H | Cl | CHF₂ | F |
| A-327 | F | H | Cl | CHF₂ | F |
| A-328 | Cl | H | Cl | CHF₂ | F |
| A-329 | CH₃ | H | Cl | CHF₂ | F |
| A-330 | CH₂CH₃ | H | Cl | CHF₂ | F |
| A-331 | H | H | CHF2 | CHF₂ | F |
| A-332 | F | H | CHF2 | CHF₂ | F |
| A-333 | Cl | H | CHF2 | CHF₂ | F |
| A-334 | CH₃ | H | CHF2 | CHF₂ | F |
| A-335 | CH₂CH₃ | H | CHF2 | CHF₂ | F |
| A-336 | H | H | CF₃ | CHF₂ | F |
| A-337 | F | H | CF₃ | CHF₂ | F |
| A-338 | Cl | H | CF₃ | CHF₂ | F |
| A-339 | CH₃ | H | CF₃ | CHF₂ | F |
| A-340 | CH₂CH₃ | H | CF₃ | CHF₂ | F |
| A-341 | H | H | SCHF₂ | CHF₂ | F |
| A-342 | F | H | SCHF₂ | CHF₂ | F |
| A-343 | Cl | H | SCHF₂ | CHF₂ | F |
| A-344 | CH₃ | H | SCHF₂ | CHF₂ | F |
| A-345 | CH₂CH₃ | H | SCHF₂ | CHF₂ | F |
| A-346 | H | H | SCF₃ | CHF₂ | F |
| A-347 | F | H | SCF₃ | CHF₂ | F |
| A-348 | Cl | H | SCF₃ | CHF₂ | F |
| A-349 | CH₃ | H | SCF₃ | CHF₂ | F |
| A-350 | CH₂CH₃ | H | SCF₃ | CHF₂ | F |
| A-351 | H | H | OCHF₂ | CHF₂ | F |
| A-352 | F | H | OCHF₂ | CHF₂ | F |
| A-353 | Cl | H | OCHF₂ | CHF₂ | F |
| A-354 | CH₃ | H | OCHF₂ | CHF₂ | F |
| A-355 | CH₂CH₃ | H | OCHF₂ | CHF₂ | F |
| A-356 | H | H | OCF₃ | CHF₂ | F |
| A-357 | F | H | OCF₃ | CHF₂ | F |
| A-358 | Cl | H | OCF₃ | CHF₂ | F |
| A-359 | CH₃ | H | OCF₃ | CHF₂ | F |
| A-360 | CH₂CH₃ | H | OCF₃ | CHF₂ | F |
| A-361 | H | H | F | CF₃ | F |
| A-362 | F | H | F | CF₃ | F |
| A-363 | Cl | H | F | CF₃ | F |
| A-364 | CH₃ | H | F | CF₃ | F |
| A-365 | CH₂CH₃ | H | F | CF₃ | F |
| A-366 | H | H | Cl | CF₃ | F |
| A-367 | F | H | Cl | CF₃ | F |
| A-368 | Cl | H | Cl | CF₃ | F |
| A-369 | CH₃ | H | Cl | CF₃ | F |
| A-370 | CH₂CH₃ | H | Cl | CF₃ | F |
| A-371 | H | H | CHF2 | CF₃ | F |
| A-372 | F | H | CHF2 | CF₃ | F |
| A-373 | Cl | H | CHF2 | CF₃ | F |
| A-374 | CH₃ | H | CHF2 | CF₃ | F |
| A-375 | CH₂CH₃ | H | CHF2 | CF₃ | F |
| A-376 | H | H | CF₃ | CF₃ | F |
| A-377 | F | H | CF₃ | CF₃ | F |
| A-378 | Cl | H | CF₃ | CF₃ | F |
| A-379 | CH₃ | H | CF₃ | CF₃ | F |
| A-380 | CH₂CH₃ | H | CF₃ | CF₃ | F |
| A-381 | H | H | SCHF₂ | CF₃ | F |
| A-382 | F | H | SCHF₂ | CF₃ | F |
| A-383 | Cl | H | SCHF₂ | CF₃ | F |
| A-384 | CH₃ | H | SCHF₂ | CF₃ | F |
| A-385 | CH₂CH₃ | H | SCHF₂ | CF₃ | F |
| A-386 | H | H | SCF₃ | CF₃ | F |
| A-387 | F | H | SCF₃ | CF₃ | F |
| A-388 | Cl | H | SCF₃ | CF₃ | F |
| A-389 | CH₃ | H | SCF₃ | CF₃ | F |
| A-390 | CH₂CH₃ | H | SCF₃ | CF₃ | F |
| A-391 | H | H | OCHF₂ | CF₃ | F |
| A-392 | F | H | OCHF₂ | CF₃ | F |
| A-393 | Cl | H | OCHF₂ | CF₃ | F |
| A-394 | CH₃ | H | OCHF₂ | CF₃ | F |
| A-395 | CH₂CH₃ | H | OCHF₂ | CF₃ | F |
| A-396 | H | H | OCF₃ | CF₃ | F |
| A-397 | F | H | OCF₃ | CF₃ | F |
| A-398 | Cl | H | OCF₃ | CF₃ | F |
| A-399 | CH₃ | H | OCF₃ | CF₃ | F |
| A-400 | CH₂CH₃ | H | OCF₃ | CF₃ | F |
| A-401 | H | H | F | H | Cl |
| A-402 | F | H | F | H | Cl |
| A-403 | Cl | H | F | H | Cl |
| A-404 | CH₃ | H | F | H | Cl |
| A-405 | CH₂CH₃ | H | F | H | Cl |
| A-406 | H | H | Cl | H | Cl |
| A-407 | F | H | Cl | H | Cl |
| A-408 | Cl | H | Cl | H | Cl |
| A-409 | CH₃ | H | Cl | H | Cl |
| A-410 | CH₂CH₃ | H | Cl | H | Cl |
| A-411 | H | H | CHF2 | H | Cl |
| A-412 | F | H | CHF2 | H | Cl |
| A-413 | Cl | H | CHF2 | H | Cl |
| A-414 | CH₃ | H | CHF2 | H | Cl |
| A-415 | CH₂CH₃ | H | CHF2 | H | Cl |
| A-416 | H | H | CF₃ | H | Cl |
| A-417 | F | H | CF₃ | H | Cl |
| A-418 | Cl | H | CF₃ | H | Cl |
| A-419 | CH₃ | H | CF₃ | H | Cl |
| A-420 | CH₂CH₃ | H | CF₃ | H | Cl |
| A-421 | H | H | SCHF₂ | H | Cl |
| A-422 | F | H | SCHF₂ | H | Cl |
| A-423 | Cl | H | SCHF₂ | H | Cl |
| A-424 | CH₃ | H | SCHF₂ | H | Cl |
| A-425 | CH₂CH₃ | H | SCHF₂ | H | Cl |
| A-426 | H | H | SCF₃ | H | Cl |
| A-427 | F | H | SCF₃ | H | Cl |
| A-428 | Cl | H | SCF₃ | H | Cl |
| A-429 | CH₃ | H | SCF₃ | H | Cl |
| A-430 | CH₂CH₃ | H | SCF₃ | H | Cl |
| A-431 | H | H | OCHF₂ | H | Cl |
| A-432 | F | H | OCHF₂ | H | Cl |
| A-433 | Cl | H | OCHF₂ | H | Cl |
| A-434 | CH₃ | H | OCHF₂ | H | Cl |
| A-435 | CH₂CH₃ | H | OCHF₂ | H | Cl |
| A-436 | H | H | OCF₃ | H | Cl |
| A-437 | F | H | OCF₃ | H | Cl |
| A-438 | Cl | H | OCF₃ | H | Cl |
| A-439 | CH₃ | H | OCF₃ | H | Cl |
| A-440 | CH₂CH₃ | H | OCF₃ | H | Cl |
| A-441 | H | H | F | F | Cl |
| A-442 | F | H | F | F | Cl |
| A-443 | Cl | H | F | F | Cl |
| A-444 | CH₃ | H | F | F | Cl |
| A-445 | CH₂CH₃ | H | F | F | Cl |
| A-446 | H | H | Cl | F | Cl |
| A-447 | F | H | Cl | F | Cl |
| A-448 | Cl | H | Cl | F | Cl |
| A-449 | CH₃ | H | Cl | F | Cl |
| A-450 | CH₂CH₃ | H | Cl | F | Cl |
| A-451 | H | H | CHF2 | F | Cl |
| A-452 | F | H | CHF2 | F | Cl |
| A-453 | Cl | H | CHF2 | F | Cl |
| A-454 | CH₃ | H | CHF2 | F | Cl |
| A-455 | CH₂CH₃ | H | CHF2 | F | Cl |
| A-456 | H | H | CF₃ | F | Cl |
| A-457 | F | H | CF₃ | F | Cl |
| A-458 | Cl | H | CF₃ | F | Cl |
| A-459 | CH₃ | H | CF₃ | F | Cl |
| A-460 | CH₂CH₃ | H | CF₃ | F | Cl |
| A-461 | H | H | SCHF₂ | F | Cl |
| A-462 | F | H | SCHF₂ | F | Cl |
| A-463 | Cl | H | SCHF₂ | F | Cl |
| A-464 | CH₃ | H | SCHF₂ | F | Cl |
| A-465 | CH₂CH₃ | H | SCHF₂ | F | Cl |
| A-466 | H | H | SCF₃ | F | Cl |
| A-467 | F | H | SCF₃ | F | Cl |
| A-468 | Cl | H | SCF₃ | F | Cl |
| A-469 | CH₃ | H | SCF₃ | F | Cl |
| A-470 | CH₂CH₃ | H | SCF₃ | F | Cl |
| A-471 | H | H | OCHF₂ | F | Cl |
| A-472 | F | H | OCHF₂ | F | Cl |
| A-473 | Cl | H | OCHF₂ | F | Cl |
| A-474 | CH₃ | H | OCHF₂ | F | Cl |
| A-475 | CH₂CH₃ | H | OCHF₂ | F | Cl |
| A-476 | H | H | OCF₃ | F | Cl |
| A-477 | F | H | OCF₃ | F | Cl |
| A-478 | Cl | H | OCF₃ | F | Cl |
| A-479 | CH₃ | H | OCF₃ | F | Cl |
| A-480 | CH₂CH₃ | H | OCF₃ | F | Cl |
| A-481 | H | H | F | Cl | Cl |
| A-482 | F | H | F | Cl | Cl |
| A-483 | Cl | H | F | Cl | Cl |
| A-484 | CH₃ | H | F | Cl | Cl |
| A-485 | CH₂CH₃ | H | F | Cl | Cl |
| A-486 | H | H | Cl | Cl | Cl |
| A-487 | F | H | Cl | Cl | Cl |
| A-488 | Cl | H | Cl | Cl | Cl |
| A-489 | CH₃ | H | Cl | Cl | Cl |
| A-490 | CH₂CH₃ | H | Cl | Cl | Cl |
| A-491 | H | H | CHF2 | Cl | Cl |
| A-492 | F | H | CHF2 | Cl | Cl |
| A-493 | Cl | H | CHF2 | Cl | Cl |
| A-494 | CH₃ | H | CHF2 | Cl | Cl |
| A-495 | CH₂CH₃ | H | CHF2 | Cl | Cl |
| A-496 | H | H | CF₃ | Cl | Cl |
| A-497 | F | H | CF₃ | Cl | Cl |
| A-498 | Cl | H | CF₃ | Cl | Cl |
| A-499 | CH₃ | H | CF₃ | Cl | Cl |
| A-500 | CH₂CH₃ | H | CF₃ | Cl | Cl |
| A-501 | H | H | SCHF₂ | Cl | Cl |
| A-502 | F | H | SCHF₂ | Cl | Cl |
| A-503 | Cl | H | SCHF₂ | Cl | Cl |
| A-504 | CH₃ | H | SCHF₂ | Cl | Cl |
| A-505 | CH₂CH₃ | H | SCHF₂ | Cl | Cl |
| A-506 | H | H | SCF₃ | Cl | Cl |
| A-507 | F | H | SCF₃ | Cl | Cl |
| A-508 | Cl | H | SCF₃ | Cl | Cl |
| A-509 | CH₃ | H | SCF₃ | Cl | Cl |
| A-510 | CH₂CH₃ | H | SCF₃ | Cl | Cl |
| A-511 | H | H | OCHF₂ | Cl | Cl |
| A-512 | F | H | OCHF₂ | Cl | Cl |
| A-513 | Cl | H | OCHF₂ | Cl | Cl |
| A-514 | CH₃ | H | OCHF₂ | Cl | Cl |
| A-515 | CH₂CH₃ | H | OCHF₂ | Cl | Cl |
| A-516 | H | H | OCF₃ | Cl | Cl |
| A-517 | F | H | OCF₃ | Cl | Cl |
| A-518 | Cl | H | OCF₃ | Cl | Cl |
| A-519 | CH₃ | H | OCF₃ | Cl | Cl |
| A-520 | CH₂CH₃ | H | OCF₃ | Cl | Cl |
| A-521 | H | H | F | CHF₂ | Cl |
| A-522 | F | H | F | CHF₂ | Cl |
| A-523 | Cl | H | F | CHF₂ | Cl |
| A-524 | CH₃ | H | F | CHF₂ | Cl |
| A-525 | CH₂CH₃ | H | F | CHF₂ | Cl |
| A-526 | H | H | Cl | CHF₂ | Cl |
| A-527 | F | H | Cl | CHF₂ | Cl |
| A-528 | Cl | H | Cl | CHF₂ | Cl |
| A-529 | CH₃ | H | Cl | CHF₂ | Cl |
| A-530 | CH₂CH₃ | H | Cl | CHF₂ | Cl |
| A-531 | H | H | CHF₂ | CHF2 | Cl |
| A-532 | F | H | CHF₂ | CHF2 | Cl |
| A-533 | Cl | H | CHF₂ | CHF2 | Cl |
| A-534 | CH₃ | H | CHF₂ | CHF2 | Cl |
| A-535 | CH₂CH₃ | H | CHF2 | CHF₂ | Cl |
| A-536 | H | H | CF₃ | CHF₂ | Cl |
| A-537 | F | H | CF₃ | CHF₂ | Cl |
| A-538 | Cl | H | CF₃ | CHF₂ | Cl |
| A-539 | CH₃ | H | CF₃ | CHF₂ | Cl |
| A-540 | CH₂CH₃ | H | CF₃ | CHF₂ | Cl |
| A-541 | H | H | SCHF₂ | CHF₂ | Cl |
| A-542 | F | H | SCHF₂ | CHF₂ | Cl |
| A-543 | Cl | H | SCHF₂ | CHF₂ | Cl |
| A-544 | CH₃ | H | SCHF₂ | CHF₂ | Cl |
| A-545 | CH₂CH₃ | H | SCHF₂ | CHF₂ | Cl |
| A-546 | H | H | SCF₃ | CHF₂ | Cl |
| A-547 | F | H | SCF₃ | CHF₂ | Cl |
| A-548 | Cl | H | SCF₃ | CHF₂ | Cl |
| A-549 | CH₃ | H | SCF₃ | CHF₂ | Cl |
| A-550 | CH₂CH₃ | H | SCF₃ | CHF₂ | Cl |
| A-551 | H | H | OCHF₂ | CHF₂ | Cl |
| A-552 | F | H | OCHF₂ | CHF₂ | Cl |
| A-553 | Cl | H | OCHF₂ | CHF₂ | Cl |
| A-554 | CH₃ | H | OCHF₂ | CHF₂ | Cl |
| A-555 | CH₂CH₃ | H | OCHF₂ | CHF₂ | Cl |
| A-556 | H | H | OCF₃ | CHF₂ | Cl |
| A-557 | F | H | OCF₃ | CHF₂ | Cl |
| A-558 | Cl | H | OCF₃ | CHF₂ | Cl |
| A-559 | CH₃ | H | OCF₃ | CHF₂ | Cl |
| A-560 | CH₂CH₃ | H | OCF₃ | CHF₂ | Cl |
| A-561 | H | H | F | CF₃ | Cl |
| A-562 | F | H | F | CF₃ | Cl |
| A-563 | Cl | H | F | CF₃ | Cl |
| A-564 | CH₃ | H | F | CF₃ | Cl |
| A-565 | CH₂CH₃ | H | F | CF₃ | Cl |
| A-566 | H | H | Cl | CF₃ | Cl |
| A-567 | F | H | Cl | CF₃ | Cl |
| A-568 | Cl | H | Cl | CF₃ | Cl |
| A-569 | CH₃ | H | Cl | CF₃ | Cl |
| A-570 | CH₂CH₃ | H | Cl | CF₃ | Cl |
| A-571 | H | H | CHF2 | CF₃ | Cl |
| A-572 | F | H | CHF2 | CF₃ | Cl |
| A-573 | Cl | H | CHF2 | CF₃ | Cl |
| A-574 | CH₃ | H | CHF2 | CF₃ | Cl |
| A-575 | CH₂CH₃ | H | CHF2 | CF₃ | Cl |
| A-576 | H | H | CF₃ | CF₃ | Cl |
| A-577 | F | H | CF₃ | CF₃ | Cl |
| A-578 | Cl | H | CF₃ | CF₃ | Cl |
| A-579 | CH₃ | H | CF₃ | CF₃ | Cl |
| A-580 | CH₂CH₃ | H | CF₃ | CF₃ | Cl |
| A-581 | H | H | SCHF₂ | CF₃ | Cl |
| A-582 | F | H | SCHF₂ | CF₃ | Cl |
| A-583 | Cl | H | SCHF₂ | CF₃ | Cl |
| A-584 | CH₃ | H | SCHF₂ | CF₃ | Cl |
| A-585 | CH₂CH₃ | H | SCHF₂ | CF₃ | Cl |
| A-586 | H | H | SCF₃ | CF₃ | Cl |
| A-587 | F | H | SCF₃ | CF₃ | Cl |
| A-588 | Cl | H | SCF₃ | CF₃ | Cl |
| A-589 | CH₃ | H | SCF₃ | CF₃ | Cl |
| A-590 | CH₂CH₃ | H | SCF₃ | CF₃ | Cl |
| A-591 | H | H | OCHF₂ | CF₃ | Cl |
| A-592 | F | H | OCHF₂ | CF₃ | Cl |
| A-593 | Cl | H | OCHF₂ | CF₃ | Cl |
| A-594 | CH₃ | H | OCHF₂ | CF₃ | Cl |
| A-595 | CH₂CH₃ | H | OCHF₂ | CF₃ | Cl |
| A-596 | H | H | OCF₃ | CF₃ | Cl |
| A-597 | F | H | OCF₃ | CF₃ | Cl |
| A-598 | Cl | H | OCF₃ | CF₃ | Cl |
| A-599 | CH₃ | H | OCF₃ | CF₃ | Cl |
| A-600 | CH₂CH₃ | H | OCF₃ | CF₃ | Cl |
| A-601 | H | F | F | H | H |
| A-602 | F | F | F | H | H |
| A-603 | Cl | F | F | H | H |
| A-604 | CH₃ | F | F | H | H |
| A-605 | CH₂CH₃ | F | F | H | H |
| A-606 | H | F | Cl | H | H |
| A-607 | F | F | Cl | H | H |
| A-608 | Cl | F | Cl | H | H |
| A-609 | CH₃ | F | Cl | H | H |
| A-610 | CH₂CH₃ | F | Cl | H | H |
| A-611 | H | F | CHF2 | H | H |
| A-612 | F | F | CHF2 | H | H |
| A-613 | Cl | F | CHF2 | H | H |
| A-614 | CH₃ | F | CHF2 | H | H |
| A-615 | CH₂CH₃ | F | CHF2 | H | H |
| A-616 | H | F | CF₃ | H | H |
| A-617 | F | F | CF₃ | H | H |
| A-618 | Cl | F | CF₃ | H | H |
| A-619 | CH₃ | F | CF₃ | H | H |
| A-620 | CH₂CH₃ | F | CF₃ | H | H |
| A-621 | H | F | SCHF₂ | H | H |
| A-622 | F | F | SCHF₂ | H | H |
| A-623 | Cl | F | SCHF₂ | H | H |
| A-624 | CH₃ | F | SCHF₂ | H | H |
| A-625 | CH₂CH₃ | F | SCHF₂ | H | H |
| A-626 | H | F | SCF₃ | H | H |
| A-627 | F | F | SCF₃ | H | H |
| A-628 | Cl | F | SCF₃ | H | H |
| A-629 | CH₃ | F | SCF₃ | H | H |
| A-630 | CH₂CH₃ | F | SCF₃ | H | H |
| A-631 | H | F | OCHF₂ | H | H |
| A-632 | F | F | OCHF₂ | H | H |
| A-633 | Cl | F | OCHF₂ | H | H |
| A-634 | CH₃ | F | OCHF₂ | H | H |
| A-635 | CH₂CH₃ | F | OCHF₂ | H | H |
| A-636 | H | F | OCF₃ | H | H |
| A-637 | F | F | OCF₃ | H | H |
| A-638 | Cl | F | OCF₃ | H | H |
| A-639 | CH₃ | F | OCF₃ | H | H |
| A-640 | CH₂CH₃ | F | OCF₃ | H | H |
| A-641 | H | F | F | F | H |
| A-642 | F | F | F | F | H |
| A-643 | Cl | F | F | F | H |
| A-644 | CH₃ | F | F | F | H |
| A-645 | CH₂CH₃ | F | F | F | H |
| A-646 | H | F | Cl | F | H |
| A-647 | F | F | Cl | F | H |
| A-648 | Cl | F | Cl | F | H |
| A-649 | CH₃ | F | Cl | F | H |
| A-650 | CH₂CH₃ | F | Cl | F | H |
| A-651 | H | F | CHF2 | F | H |
| A-652 | F | F | CHF2 | F | H |
| A-653 | Cl | F | CHF2 | F | H |
| A-654 | CH₃ | F | CHF2 | F | H |
| A-655 | CH₂CH₃ | F | CHF2 | F | H |
| A-656 | H | F | CF₃ | F | H |
| A-657 | F | F | CF₃ | F | H |
| A-658 | Cl | F | CF₃ | F | H |
| A-659 | CH₃ | F | CF₃ | F | H |
| A-660 | CH₂CH₃ | F | CF₃ | F | H |
| A-661 | H | F | SCHF₂ | F | H |
| A-662 | F | F | SCHF₂ | F | H |
| A-663 | Cl | F | SCHF₂ | F | H |
| A-664 | CH₃ | F | SCHF₂ | F | H |
| A-665 | CH₂CH₃ | F | SCHF₂ | F | H |
| A-666 | H | F | SCF₃ | F | H |
| A-667 | F | F | SCF₃ | F | H |
| A-668 | Cl | F | SCF₃ | F | H |
| A-669 | CH₃ | F | SCF₃ | F | H |
| A-670 | CH₂CH₃ | F | SCF₃ | F | H |
| A-671 | H | F | OCHF₂ | F | H |
| A-672 | F | F | OCHF₂ | F | H |
| A-673 | Cl | F | OCHF₂ | F | H |
| A-674 | CH₃ | F | OCHF₂ | F | H |
| A-675 | CH₂CH₃ | F | OCHF₂ | F | H |
| A-676 | H | F | OCF₃ | F | H |
| A-677 | F | F | OCF₃ | F | H |
| A-678 | Cl | F | OCF₃ | F | H |
| A-679 | CH₃ | F | OCF₃ | F | H |
| A-680 | CH₂CH₃ | F | OCF₃ | F | H |
| A-681 | H | F | F | Cl | H |
| A-682 | F | F | F | Cl | H |
| A-683 | Cl | F | F | Cl | H |
| A-684 | CH₃ | F | F | Cl | H |
| A-685 | CH₂CH₃ | F | F | Cl | H |
| A-686 | H | F | Cl | Cl | H |
| A-687 | F | F | Cl | Cl | H |
| A-688 | Cl | F | Cl | Cl | H |
| A-689 | CH₃ | F | Cl | Cl | H |
| A-690 | CH₂CH₃ | F | Cl | Cl | H |
| A-691 | H | F | CHF2 | Cl | H |
| A-692 | F | F | CHF2 | Cl | H |
| A-693 | Cl | F | CHF2 | Cl | H |
| A-694 | CH₃ | F | CHF2 | Cl | H |
| A-695 | CH₂CH₃ | F | CHF2 | Cl | H |
| A-696 | H | F | CF₃ | Cl | H |
| A-697 | F | F | CF₃ | Cl | H |
| A-698 | Cl | F | CF₃ | Cl | H |
| A-699 | CH₃ | F | CF₃ | Cl | H |
| A-700 | CH₂CH₃ | F | CF₃ | Cl | H |
| A-701 | H | F | SCHF₂ | Cl | H |
| A-702 | F | F | SCHF₂ | Cl | H |
| A-703 | Cl | F | SCHF₂ | Cl | H |
| A-704 | CH₃ | F | SCHF₂ | Cl | H |
| A-705 | CH₂CH₃ | F | SCHF₂ | Cl | H |
| A-706 | H | F | SCF₃ | Cl | H |
| A-707 | F | F | SCF₃ | Cl | H |
| A-708 | Cl | F | SCF₃ | Cl | H |
| A-709 | CH₃ | F | SCF₃ | Cl | H |
| A-710 | CH₂CH₃ | F | SCF₃ | Cl | H |
| A-711 | H | F | OCHF₂ | Cl | H |
| A-712 | F | F | OCHF₂ | Cl | H |
| A-713 | Cl | F | OCHF₂ | Cl | H |
| A-714 | CH₃ | F | OCHF₂ | Cl | H |
| A-715 | CH₂CH₃ | F | OCHF₂ | Cl | H |
| A-716 | H | F | OCF₃ | Cl | H |
| A-717 | F | F | OCF₃ | Cl | H |
| A-718 | Cl | F | OCF₃ | Cl | H |
| A-719 | CH₃ | F | OCF₃ | Cl | H |
| A-720 | CH₂CH₃ | F | OCF₃ | Cl | H |
| A-721 | H | F | F | CHF₂ | H |
| A-722 | F | F | F | CHF₂ | H |
| A-723 | Cl | F | F | CHF₂ | H |
| A-724 | CH₃ | F | F | CHF₂ | H |
| A-725 | CH₂CH₃ | F | F | CHF₂ | H |
| A-726 | H | F | Cl | CHF₂ | H |
| A-727 | F | F | Cl | CHF₂ | H |
| A-728 | Cl | F | Cl | CHF₂ | H |
| A-729 | CH₃ | F | Cl | CHF₂ | H |
| A-730 | CH₂CH₃ | F | Cl | CHF₂ | H |
| A-731 | H | F | CHF2 | CHF₂ | H |
| A-732 | F | F | CHF2 | CHF₂ | H |
| A-733 | Cl | F | CHF2 | CHF₂ | H |
| A-734 | CH₃ | F | CHF2 | CHF₂ | H |
| A-735 | CH₂CH₃ | F | CHF2 | CHF₂ | H |
| A-736 | H | F | CF₃ | CHF₂ | H |
| A-737 | F | F | CF₃ | CHF₂ | H |
| A-738 | Cl | F | CF₃ | CHF₂ | H |
| A-739 | CH₃ | F | CF₃ | CHF₂ | H |
| A-740 | CH₂CH₃ | F | CF₃ | CHF₂ | H |
| A-741 | H | F | SCHF₂ | CHF₂ | H |
| A-742 | F | F | SCHF₂ | CHF₂ | H |
| A-743 | Cl | F | SCHF₂ | CHF₂ | H |
| A-744 | CH₃ | F | SCHF₂ | CHF₂ | H |
| A-745 | CH₂CH₃ | F | SCHF₂ | CHF₂ | H |
| A-746 | H | F | SCF₃ | CHF₂ | H |
| A-747 | F | F | SCF₃ | CHF₂ | H |
| A-748 | Cl | F | SCF₃ | CHF₂ | H |
| A-749 | CH₃ | F | SCF₃ | CHF₂ | H |
| A-750 | CH₂CH₃ | F | SCF₃ | CHF₂ | H |
| A-751 | H | F | OCHF₂ | CHF₂ | H |
| A-752 | F | F | OCHF₂ | CHF₂ | H |
| A-753 | Cl | F | OCHF₂ | CHF₂ | H |
| A-754 | CH₃ | F | OCHF₂ | CHF₂ | H |
| A-755 | CH₂CH₃ | F | OCHF₂ | CHF₂ | H |
| A-756 | H | F | OCF₃ | CHF₂ | H |
| A-757 | F | F | OCF₃ | CHF₂ | H |
| A-758 | Cl | F | OCF₃ | CHF₂ | H |
| A-759 | CH₃ | F | OCF₃ | CHF₂ | H |
| A-760 | CH₂CH₃ | F | OCF₃ | CHF₂ | H |
| A-761 | H | F | F | CF₃ | H |
| A-762 | F | F | F | CF₃ | H |
| A-763 | Cl | F | F | CF₃ | H |
| A-764 | CH₃ | F | F | CF₃ | H |
| A-765 | CH₂CH₃ | F | F | CF₃ | H |
| A-766 | H | F | Cl | CF₃ | H |
| A-767 | F | F | Cl | CF₃ | H |
| A-768 | Cl | F | Cl | CF₃ | H |
| A-769 | CH₃ | F | Cl | CF₃ | H |
| A-770 | CH₂CH₃ | F | Cl | CF₃ | H |
| A-771 | H | F | CHF2 | CF₃ | H |
| A-772 | F | F | CHF2 | CF₃ | H |
| A-773 | Cl | F | CHF2 | CF₃ | H |
| A-774 | CH₃ | F | CHF2 | CF₃ | H |
| A-775 | CH₂CH₃ | F | CHF2 | CF₃ | H |
| A-776 | H | F | CF₃ | CF₃ | H |
| A-777 | F | F | CF₃ | CF₃ | H |
| A-778 | Cl | F | CF₃ | CF₃ | H |
| A-779 | CH₃ | F | CF₃ | CF₃ | H |
| A-780 | CH₂CH₃ | F | CF₃ | CF₃ | H |
| A-781 | H | F | SCHF₂ | CF₃ | H |
| A-782 | F | F | SCHF₂ | CF₃ | H |
| A-783 | Cl | F | SCHF₂ | CF₃ | H |
| A-784 | CH₃ | F | SCHF₂ | CF₃ | H |
| A-785 | CH₂CH₃ | F | SCHF₂ | CF₃ | H |
| A-786 | H | F | SCF₃ | CF₃ | H |
| A-787 | F | F | SCF₃ | CF₃ | H |
| A-788 | Cl | F | SCF₃ | CF₃ | H |
| A-789 | CH₃ | F | SCF₃ | CF₃ | H |
| A-790 | CH₂CH₃ | F | SCF₃ | CF₃ | H |
| A-791 | H | F | OCHF₂ | CF₃ | H |
| A-792 | F | F | OCHF₂ | CF₃ | H |
| A-793 | Cl | F | OCHF₂ | CF₃ | H |
| A-794 | CH₃ | F | OCHF₂ | CF₃ | H |
| A-795 | CH₂CH₃ | F | OCHF₂ | CF₃ | H |
| A-796 | H | F | OCF₃ | CF₃ | H |
| A-797 | F | F | OCF₃ | CF₃ | H |
| A-798 | Cl | F | OCF₃ | CF₃ | H |
| A-799 | CH₃ | F | OCF₃ | CF₃ | H |
| A-800 | CH₂CH₃ | F | OCF₃ | CF₃ | H |
| A-801 | H | F | F | H | F |
| A-802 | F | F | F | H | F |
| A-803 | Cl | F | F | H | F |
| A-804 | CH₃ | F | F | H | F |
| A-805 | CH₂CH₃ | F | F | H | F |
| A-806 | H | F | Cl | H | F |
| A-807 | F | F | Cl | H | F |
| A-808 | Cl | F | Cl | H | F |
| A-809 | CH₃ | F | Cl | H | F |
| A-810 | CH₂CH₃ | F | Cl | H | F |
| A-811 | H | F | CHF2 | H | F |
| A-812 | F | F | CHF2 | H | F |
| A-813 | Cl | F | CHF2 | H | F |
| A-814 | CH₃ | F | CHF2 | H | F |
| A-815 | CH₂CH₃ | F | CHF2 | H | F |
| A-816 | H | F | CF₃ | H | F |
| A-817 | F | F | CF₃ | H | F |
| A-818 | Cl | F | CF₃ | H | F |
| A-819 | CH₃ | F | CF₃ | H | F |
| A-820 | CH₂CH₃ | F | CF₃ | H | F |
| A-821 | H | F | SCHF₂ | H | F |
| A-822 | F | F | SCHF₂ | H | F |
| A-823 | Cl | F | SCHF₂ | H | F |
| A-824 | CH₃ | F | SCHF₂ | H | F |
| A-825 | CH₂CH₃ | F | SCHF₂ | H | F |
| A-826 | H | F | SCF₃ | H | F |
| A-827 | F | F | SCF₃ | H | F |
| A-828 | Cl | F | SCF₃ | H | F |
| A-829 | CH₃ | F | SCF₃ | H | F |
| A-830 | CH₂CH₃ | F | SCF₃ | H | F |
| A-831 | H | F | OCHF₂ | H | F |
| A-832 | F | F | OCHF₂ | H | F |
| A-833 | Cl | F | OCHF₂ | H | F |
| A-834 | CH₃ | F | OCHF₂ | H | F |
| A-835 | CH₂CH₃ | F | OCHF₂ | H | F |
| A-836 | H | F | OCF₃ | H | F |
| A-837 | F | F | OCF₃ | H | F |
| A-838 | Cl | F | OCF₃ | H | F |
| A-839 | CH₃ | F | OCF₃ | H | F |
| A-840 | CH₂CH₃ | F | OCF₃ | H | F |
| A-841 | H | F | F | F | F |
| A-842 | F | F | F | F | F |
| A-843 | Cl | F | F | F | F |
| A-844 | CH₃ | F | F | F | F |
| A-845 | CH₂CH₃ | F | F | F | F |
| A-846 | H | F | Cl | F | F |
| A-847 | F | F | Cl | F | F |
| A-848 | Cl | F | Cl | F | F |
| A-849 | CH₃ | F | Cl | F | F |
| A-850 | CH₂CH₃ | F | Cl | F | F |
| A-851 | H | F | CHF2 | F | F |
| A-852 | F | F | CHF2 | F | F |
| A-853 | Cl | F | CHF2 | F | F |
| A-854 | CH₃ | F | CHF2 | F | F |
| A-855 | CH₂CH₃ | F | CHF2 | F | F |
| A-856 | H | F | CF₃ | F | F |
| A-857 | F | F | CF₃ | F | F |
| A-858 | Cl | F | CF₃ | F | F |
| A-859 | CH₃ | F | CF₃ | F | F |
| A-860 | CH₂CH₃ | F | CF₃ | F | F |
| A-861 | H | F | SCHF₂ | F | F |
| A-862 | F | F | SCHF₂ | F | F |
| A-863 | Cl | F | SCHF₂ | F | F |
| A-864 | CH₃ | F | SCHF₂ | F | F |
| A-865 | CH₂CH₃ | F | SCHF₂ | F | F |
| A-866 | H | F | SCF₃ | F | F |
| A-867 | F | F | SCF₃ | F | F |
| A-868 | Cl | F | SCF₃ | F | F |
| A-869 | CH₃ | F | SCF₃ | F | F |
| A-870 | CH₂CH₃ | F | SCF₃ | F | F |
| A-871 | H | F | OCHF₂ | F | F |
| A-872 | F | F | OCHF₂ | F | F |
| A-873 | Cl | F | OCHF₂ | F | F |
| A-874 | CH₃ | F | OCHF₂ | F | F |
| A-875 | CH₂CH₃ | F | OCHF₂ | F | F |
| A-876 | H | F | OCF₃ | F | F |
| A-877 | F | F | OCF₃ | F | F |
| A-878 | Cl | F | OCF₃ | F | F |
| A-879 | CH₃ | F | OCF₃ | F | F |
| A-880 | CH₂CH₃ | F | OCF₃ | F | F |
| A-881 | H | F | F | Cl | F |
| A-882 | F | F | F | Cl | F |
| A-883 | Cl | F | F | Cl | F |
| A-884 | CH₃ | F | F | Cl | F |
| A-885 | CH₂CH₃ | F | F | Cl | F |
| A-886 | H | F | Cl | Cl | F |
| A-887 | F | F | Cl | Cl | F |
| A-888 | Cl | F | Cl | Cl | F |
| A-889 | CH₃ | F | Cl | Cl | F |
| A-890 | CH₂CH₃ | F | Cl | Cl | F |
| A-891 | H | F | CHF2 | Cl | F |
| A-892 | F | F | CHF2 | Cl | F |
| A-893 | Cl | F | CHF2 | Cl | F |
| A-894 | CH₃ | F | CHF2 | Cl | F |
| A-895 | CH₂CH₃ | F | CHF2 | Cl | F |
| A-896 | H | F | CF₃ | Cl | F |
| A-897 | F | F | CF₃ | Cl | F |
| A-898 | Cl | F | CF₃ | Cl | F |
| A-899 | CH₃ | F | CF₃ | Cl | F |
| A-900 | CH₂CH₃ | F | CF₃ | Cl | F |
| A-901 | H | F | SCHF₂ | Cl | F |
| A-902 | F | F | SCHF₂ | Cl | F |
| A-903 | Cl | F | SCHF₂ | Cl | F |
| A-904 | CH₃ | F | SCHF₂ | Cl | F |
| A-905 | CH₂CH₃ | F | SCHF₂ | Cl | F |
| A-906 | H | F | SCF₃ | Cl | F |
| A-907 | F | F | SCF₃ | Cl | F |
| A-908 | Cl | F | SCF₃ | Cl | F |
| A-909 | CH₃ | F | SCF₃ | Cl | F |
| A-910 | CH₂CH₃ | F | SCF₃ | Cl | F |
| A-911 | H | F | OCHF₂ | Cl | F |
| A-912 | F | F | OCHF₂ | Cl | F |
| A-913 | Cl | F | OCHF₂ | Cl | F |
| A-914 | CH₃ | F | OCHF₂ | Cl | F |
| A-915 | CH₂CH₃ | F | OCHF₂ | Cl | F |
| A-916 | H | F | OCF₃ | Cl | F |
| A-917 | F | F | OCF₃ | Cl | F |
| A-918 | Cl | F | OCF₃ | Cl | F |
| A-919 | CH₃ | F | OCF₃ | Cl | F |
| A-920 | CH₂CH₃ | F | OCF₃ | Cl | F |
| A-921 | H | F | F | CHF₂ | F |
| A-922 | F | F | F | CHF₂ | F |
| A-923 | Cl | F | F | CHF₂ | F |
| A-924 | CH₃ | F | F | CHF₂ | F |
| A-925 | CH₂CH₃ | F | F | CHF₂ | F |
| A-926 | H | F | Cl | CHF₂ | F |
| A-927 | F | F | Cl | CHF₂ | F |
| A-928 | Cl | F | Cl | CHF₂ | F |
| A-929 | CH₃ | F | Cl | CHF₂ | F |
| A-930 | CH₂CH₃ | F | Cl | CHF₂ | F |
| A-931 | H | F | CHF2 | CHF₂ | F |
| A-932 | F | F | CHF2 | CHF₂ | F |
| A-933 | Cl | F | CHF2 | CHF₂ | F |
| A-934 | CH₃ | F | CHF2 | CHF₂ | F |
| A-935 | CH₂CH₃ | F | CHF2 | CHF₂ | F |
| A-936 | H | F | CF₃ | CHF₂ | F |
| A-937 | F | F | CF₃ | CHF₂ | F |
| A-938 | Cl | F | CF₃ | CHF₂ | F |
| A-939 | CH₃ | F | CF₃ | CHF₂ | F |
| A-940 | CH₂CH₃ | F | CF₃ | CHF₂ | F |
| A-941 | H | F | SCHF₂ | CHF₂ | F |
| A-942 | F | F | SCHF₂ | CHF₂ | F |
| A-943 | Cl | F | SCHF₂ | CHF₂ | F |
| A-944 | CH₃ | F | SCHF₂ | CHF₂ | F |
| A-945 | CH₂CH₃ | F | SCHF₂ | CHF₂ | F |
| A-946 | H | F | SCF₃ | CHF₂ | F |
| A-947 | F | F | SCF₃ | CHF₂ | F |
| A-948 | Cl | F | SCF₃ | CHF₂ | F |
| A-949 | CH₃ | F | SCF₃ | CHF₂ | F |
| A-950 | CH₂CH₃ | F | SCF₃ | CHF₂ | F |
| A-951 | H | F | OCHF₂ | CHF₂ | F |
| A-952 | F | F | OCHF₂ | CHF₂ | F |
| A-953 | Cl | F | OCHF₂ | CHF₂ | F |
| A-954 | CH₃ | F | OCHF₂ | CHF₂ | F |
| A-955 | CH₂CH₃ | F | OCHF₂ | CHF₂ | F |
| A-956 | H | F | OCF₃ | CHF₂ | F |
| A-957 | F | F | OCF₃ | CHF₂ | F |
| A-958 | Cl | F | OCF₃ | CHF₂ | F |
| A-959 | CH₃ | F | OCF₃ | CHF₂ | F |
| A-960 | CH₂CH₃ | F | OCF₃ | CHF₂ | F |
| A-961 | H | F | F | CF₃ | F |
| A-962 | F | F | F | CF₃ | F |
| A-963 | Cl | F | F | CF₃ | F |
| A-964 | CH₃ | F | F | CF₃ | F |
| A-965 | CH₂CH₃ | F | F | CF₃ | F |
| A-966 | H | F | Cl | CF₃ | F |
| A-967 | F | F | Cl | CF₃ | F |
| A-968 | Cl | F | Cl | CF₃ | F |
| A-969 | CH₃ | F | Cl | CF₃ | F |
| A-970 | CH₂CH₃ | F | Cl | CF₃ | F |
| A-971 | H | F | CHF2 | CF₃ | F |
| A-972 | F | F | CHF2 | CF₃ | F |
| A-973 | Cl | F | CHF2 | CF₃ | F |
| A-974 | CH₃ | F | CHF2 | CF₃ | F |
| A-975 | CH₂CH₃ | F | CHF2 | CF₃ | F |
| A-976 | H | F | CF₃ | CF₃ | F |
| A-977 | F | F | CF₃ | CF₃ | F |
| A-978 | Cl | F | CF₃ | CF₃ | F |
| A-979 | CH₃ | F | CF₃ | CF₃ | F |
| A-980 | CH₂CH₃ | F | CF₃ | CF₃ | F |
| A-981 | H | F | SCHF₂ | CF₃ | F |
| A-982 | F | F | SCHF₂ | CF₃ | F |
| A-983 | Cl | F | SCHF₂ | CF₃ | F |
| A-984 | CH₃ | F | SCHF₂ | CF₃ | F |
| A-985 | CH₂CH₃ | F | SCHF₂ | CF₃ | F |
| A-986 | H | F | SCF₃ | CF₃ | F |
| A-987 | F | F | SCF₃ | CF₃ | F |
| A-988 | Cl | F | SCF₃ | CF₃ | F |
| A-989 | CH₃ | F | SCF₃ | CF₃ | F |
| A-990 | CH₂CH₃ | F | SCF₃ | CF₃ | F |
| A-991 | H | F | OCHF₂ | CF₃ | F |
| A-992 | F | F | OCHF₂ | CF₃ | F |
| A-993 | Cl | F | OCHF₂ | CF₃ | F |
| A-994 | CH₃ | F | OCHF₂ | CF₃ | F |
| A-995 | CH₂CH₃ | F | OCHF₂ | CF₃ | F |
| A-996 | H | F | OCF₃ | CF₃ | F |
| A-997 | F | F | OCF₃ | CF₃ | F |
| A-998 | Cl | F | OCF₃ | CF₃ | F |
| A-999 | CH₃ | F | OCF₃ | CF₃ | F |
| A-1000 | CH₂CH₃ | F | OCF₃ | CF₃ | F |
| A-1001 | H | F | F | H | Cl |
| A-1002 | F | F | F | H | Cl |
| A-1003 | Cl | F | F | H | Cl |
| A-1004 | CH₃ | F | F | H | Cl |
| A-1005 | CH₂CH₃ | F | F | H | Cl |
| A-1006 | H | F | Cl | H | Cl |
| A-1007 | F | F | Cl | H | Cl |
| A-1008 | Cl | F | Cl | H | Cl |
| A-1009 | CH₃ | F | Cl | H | Cl |
| A-1010 | CH₂CH₃ | F | Cl | H | Cl |
| A-1011 | H | F | CHF2 | H | Cl |
| A-1012 | F | F | CHF2 | H | Cl |
| A-1013 | Cl | F | CHF2 | H | Cl |
| A-1014 | CH₃ | F | CHF2 | H | Cl |
| A-1015 | CH₂CH₃ | F | CHF2 | H | Cl |
| A-1016 | H | F | CF₃ | H | Cl |
| A-1017 | F | F | CF₃ | H | Cl |
| A-1018 | Cl | F | CF₃ | H | Cl |
| A-1019 | CH₃ | F | CF₃ | H | Cl |
| A-1020 | CH₂CH₃ | F | CF₃ | H | Cl |
| A-1021 | H | F | SCHF₂ | H | Cl |
| A-1022 | F | F | SCHF₂ | H | Cl |
| A-1023 | Cl | F | SCHF₂ | H | Cl |
| A-1024 | CH₃ | F | SCHF₂ | H | Cl |
| A-1025 | CH₂CH₃ | F | SCHF₂ | H | Cl |
| A-1026 | H | F | SCF₃ | H | Cl |
| A-1027 | F | F | SCF₃ | H | Cl |
| A-1028 | Cl | F | SCF₃ | H | Cl |
| A-1029 | CH₃ | F | SCF₃ | H | Cl |
| A-1030 | CH₂CH₃ | F | SCF₃ | H | Cl |
| A-1031 | H | F | OCHF₂ | H | Cl |
| A-1032 | F | F | OCHF₂ | H | Cl |
| A-1033 | Cl | F | OCHF₂ | H | Cl |
| A-1034 | CH₃ | F | OCHF₂ | H | Cl |
| A-1035 | CH₂CH₃ | F | OCHF₂ | H | Cl |
| A-1036 | H | F | OCF₃ | H | Cl |
| A-1037 | F | F | OCF₃ | H | Cl |
| A-1038 | Cl | F | OCF₃ | H | Cl |
| A-1039 | CH₃ | F | OCF₃ | H | Cl |
| A-1040 | CH₂CH₃ | F | OCF₃ | H | Cl |
| A-1041 | H | F | F | F | Cl |
| A-1042 | F | F | F | F | Cl |
| A-1043 | Cl | F | F | F | Cl |
| A-1044 | CH₃ | F | F | F | Cl |
| A-1045 | CH₂CH₃ | F | F | F | Cl |
| A-1046 | H | F | Cl | F | Cl |
| A-1047 | F | F | Cl | F | Cl |
| A-1048 | Cl | F | Cl | F | Cl |
| A-1049 | CH₃ | F | Cl | F | Cl |
| A-1050 | CH₂CH₃ | F | Cl | F | Cl |
| A-1051 | H | F | CHF2 | F | Cl |
| A-1052 | F | F | CHF2 | F | Cl |
| A-1053 | Cl | F | CHF2 | F | Cl |
| A-1054 | CH₃ | F | CHF2 | F | Cl |
| A-1055 | CH₂CH₃ | F | CHF2 | F | Cl |
| A-1056 | H | F | CF₃ | F | Cl |
| A-1057 | F | F | CF₃ | F | Cl |
| A-1058 | Cl | F | CF₃ | F | Cl |
| A-1059 | CH₃ | F | CF₃ | F | Cl |
| A-1060 | CH₂CH₃ | F | CF₃ | F | Cl |
| A-1061 | H | F | SCHF₂ | F | Cl |
| A-1062 | F | F | SCHF₂ | F | Cl |
| A-1063 | Cl | F | SCHF₂ | F | Cl |
| A-1064 | CH₃ | F | SCHF₂ | F | Cl |
| A-1065 | CH₂CH₃ | F | SCHF₂ | F | Cl |
| A-1066 | H | F | SCF₃ | F | Cl |
| A-1067 | F | F | SCF₃ | F | Cl |
| A-1068 | Cl | F | SCF₃ | F | Cl |
| A-1069 | CH₃ | F | SCF₃ | F | Cl |
| A-1070 | CH₂CH₃ | F | SCF₃ | F | Cl |
| A-1071 | H | F | OCHF₂ | F | Cl |
| A-1072 | F | F | OCHF₂ | F | Cl |
| A-1073 | Cl | F | OCHF₂ | F | Cl |
| A-1074 | CH₃ | F | OCHF₂ | F | Cl |
| A-1075 | CH₂CH₃ | F | OCHF₂ | F | Cl |
| A-1076 | H | F | OCF₃ | F | Cl |
| A-1077 | F | F | OCF₃ | F | Cl |
| A-1078 | Cl | F | OCF₃ | F | Cl |
| A-1079 | CH₃ | F | OCF₃ | F | Cl |
| A-1080 | CH₂CH₃ | F | OCF₃ | F | Cl |
| A-1081 | H | F | F | Cl | Cl |
| A-1082 | F | F | F | Cl | Cl |
| A-1083 | Cl | F | F | Cl | Cl |
| A-1084 | CH₃ | F | F | Cl | Cl |
| A-1085 | CH₂CH₃ | F | F | Cl | Cl |
| A-1086 | H | F | Cl | Cl | Cl |
| A-1087 | F | F | Cl | Cl | Cl |
| A-1088 | Cl | F | Cl | Cl | Cl |
| A-1089 | CH₃ | F | Cl | Cl | Cl |
| A-1090 | CH₂CH₃ | F | Cl | Cl | Cl |
| A-1091 | H | F | CHF2 | Cl | Cl |
| A-1092 | F | F | CHF2 | Cl | Cl |
| A-1093 | Cl | F | CHF2 | Cl | Cl |
| A-1094 | CH₃ | F | CHF2 | Cl | Cl |
| A-1095 | CH₂CH₃ | F | CHF2 | Cl | Cl |
| A-1096 | H | F | CF₃ | Cl | Cl |
| A-1097 | F | F | CF₃ | Cl | Cl |
| A-1098 | Cl | F | CF₃ | Cl | Cl |
| A-1099 | CH₃ | F | CF₃ | Cl | Cl |
| A-1100 | CH₂CH₃ | F | CF₃ | Cl | Cl |
| A-1101 | H | F | SCHF₂ | Cl | Cl |
| A-1102 | F | F | SCHF₂ | Cl | Cl |
| A-1103 | Cl | F | SCHF₂ | Cl | Cl |
| A-1104 | CH₃ | F | SCHF₂ | Cl | Cl |
| A-1105 | CH₂CH₃ | F | SCHF₂ | Cl | Cl |
| A-1106 | H | F | SCF₃ | Cl | Cl |
| A-1107 | F | F | SCF₃ | Cl | Cl |
| A-1108 | Cl | F | SCF₃ | Cl | Cl |
| A-1109 | CH₃ | F | SCF₃ | Cl | Cl |
| A-1110 | CH₂CH₃ | F | SCF₃ | Cl | Cl |
| A-1111 | H | F | OCHF₂ | Cl | Cl |
| A-1112 | F | F | OCHF₂ | Cl | Cl |
| A-1113 | Cl | F | OCHF₂ | Cl | Cl |
| A-1114 | CH₃ | F | OCHF₂ | Cl | Cl |
| A-1115 | CH₂CH₃ | F | OCHF₂ | Cl | Cl |
| A-1116 | H | F | OCF₃ | Cl | Cl |
| A-1117 | F | F | OCF₃ | Cl | Cl |
| A-1118 | Cl | F | OCF₃ | Cl | Cl |
| A-1119 | CH₃ | F | OCF₃ | Cl | Cl |
| A-1120 | CH₂CH₃ | F | OCF₃ | Cl | Cl |
| A-1121 | H | F | F | CHF₂ | Cl |
| A-1122 | F | F | F | CHF₂ | Cl |
| A-1123 | Cl | F | F | CHF₂ | Cl |
| A-1124 | CH₃ | F | F | CHF₂ | Cl |
| A-1125 | CH₂CH₃ | F | F | CHF₂ | Cl |
| A-1126 | H | F | Cl | CHF₂ | Cl |
| A-1127 | F | F | Cl | CHF₂ | Cl |
| A-1128 | Cl | F | Cl | CHF₂ | Cl |
| A-1129 | CH₃ | F | Cl | CHF₂ | Cl |
| A-1130 | CH₂CH₃ | F | Cl | CHF₂ | Cl |
| A-1131 | H | F | CHF2 | CHF₂ | Cl |
| A-1132 | F | F | CHF2 | CHF₂ | Cl |
| A-1133 | Cl | F | CHF2 | CHF₂ | Cl |
| A-1134 | CH₃ | F | CHF2 | CHF₂ | Cl |
| A-1135 | CH₂CH₃ | F | CHF2 | CHF₂ | Cl |
| A-1136 | H | F | CF₃ | CHF₂ | Cl |
| A-1137 | F | F | CF₃ | CHF₂ | Cl |
| A-1138 | Cl | F | CF₃ | CHF₂ | Cl |
| A-1139 | CH₃ | F | CF₃ | CHF₂ | Cl |
| A-1140 | CH₂CH₃ | F | CF₃ | CHF₂ | Cl |
| A-1141 | H | F | SCHF₂ | CHF₂ | Cl |
| A-1142 | F | F | SCHF₂ | CHF₂ | Cl |
| A-1143 | Cl | F | SCHF₂ | CHF₂ | Cl |
| A-1144 | CH₃ | F | SCHF₂ | CHF₂ | Cl |
| A-1145 | CH₂CH₃ | F | SCHF₂ | CHF₂ | Cl |
| A-1146 | H | F | SCF₃ | CHF₂ | Cl |
| A-1147 | F | F | SCF₃ | CHF₂ | Cl |
| A-1148 | Cl | F | SCF₃ | CHF₂ | Cl |
| A-1149 | CH₃ | F | SCF₃ | CHF₂ | Cl |
| A-1150 | CH₂CH₃ | F | SCF₃ | CHF₂ | Cl |
| A-1151 | H | F | OCHF₂ | CHF₂ | Cl |
| A-1152 | F | F | OCHF₂ | CHF₂ | Cl |
| A-1153 | Cl | F | OCHF₂ | CHF₂ | Cl |
| A-1154 | CH₃ | F | OCHF₂ | CHF₂ | Cl |
| A-1155 | CH₂CH₃ | F | OCHF₂ | CHF₂ | Cl |
| A-1156 | H | F | OCF₃ | CHF₂ | Cl |
| A-1157 | F | F | OCF₃ | CHF₂ | Cl |
| A-1158 | Cl | F | OCF₃ | CHF₂ | Cl |
| A-1159 | CH₃ | F | OCF₃ | CHF₂ | Cl |
| A-1160 | CH₂CH₃ | F | OCF₃ | CHF₂ | Cl |
| A-1161 | H | F | F | CF₃ | Cl |
| A-1162 | F | F | F | CF₃ | Cl |
| A-1163 | Cl | F | F | CF₃ | Cl |
| A-1164 | CH₃ | F | F | CF₃ | Cl |
| A-1165 | CH₂CH₃ | F | F | CF₃ | Cl |
| A-1166 | H | F | Cl | CF₃ | Cl |
| A-1167 | F | F | Cl | CF₃ | Cl |
| A-1168 | Cl | F | Cl | CF₃ | Cl |
| A-1169 | CH₃ | F | Cl | CF₃ | Cl |
| A-1170 | CH₂CH₃ | F | Cl | CF₃ | Cl |
| A-1171 | H | F | CHF2 | CF₃ | Cl |
| A-1172 | F | F | CHF2 | CF₃ | Cl |
| A-1173 | Cl | F | CHF2 | CF₃ | Cl |
| A-1174 | CH₃ | F | CHF2 | CF₃ | Cl |
| A-1175 | CH₂CH₃ | F | CHF2 | CF₃ | Cl |
| A-1176 | H | F | CF₃ | CF₃ | Cl |
| A-1177 | F | F | CF₃ | CF₃ | Cl |
| A-1178 | Cl | F | CF₃ | CF₃ | Cl |
| A-1179 | CH₃ | F | CF₃ | CF₃ | Cl |
| A-1180 | CH₂CH₃ | F | CF₃ | CF₃ | Cl |
| A-1181 | H | F | SCHF₂ | CF₃ | Cl |
| A-1182 | F | F | SCHF₂ | CF₃ | Cl |
| A-1183 | Cl | F | SCHF₂ | CF₃ | Cl |
| A-1184 | CH₃ | F | SCHF₂ | CF₃ | Cl |
| A-1185 | CH₂CH₃ | F | SCHF₂ | CF₃ | Cl |
| A-1186 | H | F | SCF₃ | CF₃ | Cl |
| A-1187 | F | F | SCF₃ | CF₃ | Cl |
| A-1188 | Cl | F | SCF₃ | CF₃ | Cl |
| A-1189 | CH₃ | F | SCF₃ | CF₃ | Cl |
| A-1190 | CH₂CH₃ | F | SCF₃ | CF₃ | Cl |
| A-1191 | H | F | OCHF₂ | CF₃ | Cl |
| A-1192 | F | F | OCHF₂ | CF₃ | Cl |
| A-1193 | Cl | F | OCHF₂ | CF₃ | Cl |
| A-1194 | CH₃ | F | OCHF₂ | CF₃ | Cl |
| A-1195 | CH₂CH₃ | F | OCHF₂ | CF₃ | Cl |
| A-1196 | H | F | OCF₃ | CF₃ | Cl |
| A-1197 | F | F | OCF₃ | CF₃ | Cl |
| A-1198 | Cl | F | OCF₃ | CF₃ | Cl |
| A-1199 | CH₃ | F | OCF₃ | CF₃ | Cl |
| A-1200 | CH₂CH₃ | F | OCF₃ | CF₃ | Cl |
| A-1201 | H | Cl | F | H | H |
| A-1202 | F | Cl | F | H | H |
| A-1203 | Cl | Cl | F | H | H |
| A-1204 | CH₃ | Cl | F | H | H |
| A-1205 | CH₂CH₃ | Cl | F | H | H |
| A-1206 | H | Cl | Cl | H | H |
| A-1207 | F | Cl | Cl | H | H |
| A-1208 | Cl | Cl | Cl | H | H |
| A-1209 | CH₃ | Cl | Cl | H | H |
| A-1210 | CH₂CH₃ | Cl | Cl | H | H |
| A-1211 | H | Cl | CHF2 | H | H |
| A-1212 | F | Cl | CHF2 | H | H |
| A-1213 | Cl | Cl | CHF2 | H | H |
| A-1214 | CH₃ | Cl | CHF2 | H | H |
| A-1215 | CH₂CH₃ | Cl | CHF2 | H | H |
| A-1216 | H | Cl | CF₃ | H | H |
| A-1217 | F | Cl | CF₃ | H | H |
| A-1218 | Cl | Cl | CF₃ | H | H |
| A-1219 | CH₃ | Cl | CF₃ | H | H |
| A-1220 | CH₂CH₃ | Cl | CF₃ | H | H |
| A-1221 | H | Cl | SCHF₂ | H | H |
| A-1222 | F | Cl | SCHF₂ | H | H |
| A-1223 | Cl | Cl | SCHF₂ | H | H |
| A-1224 | CH₃ | Cl | SCHF₂ | H | H |
| A-1225 | CH₂CH₃ | Cl | SCHF₂ | H | H |
| A-1226 | H | Cl | SCF₃ | H | H |
| A-1227 | F | Cl | SCF₃ | H | H |
| A-1228 | Cl | Cl | SCF₃ | H | H |
| A-1229 | CH₃ | Cl | SCF₃ | H | H |
| A-1230 | CH₂CH₃ | Cl | SCF₃ | H | H |
| A-1231 | H | Cl | OCHF₂ | H | H |
| A-1232 | F | Cl | OCHF₂ | H | H |
| A-1233 | Cl | Cl | OCHF₂ | H | H |
| A-1234 | CH₃ | Cl | OCHF₂ | H | H |
| A-1235 | CH₂CH₃ | Cl | OCHF₂ | H | H |
| A-1236 | H | Cl | OCF₃ | H | H |
| A-1237 | F | Cl | OCF₃ | H | H |
| A-1238 | Cl | Cl | OCF₃ | H | H |
| A-1239 | CH₃ | Cl | OCF₃ | H | H |
| A-1240 | CH₂CH₃ | Cl | OCF₃ | H | H |
| A-1241 | H | Cl | F | F | H |
| A-1242 | F | Cl | F | F | H |
| A-1243 | Cl | Cl | F | F | H |
| A-1244 | CH₃ | Cl | F | F | H |
| A-1245 | CH₂CH₃ | Cl | F | F | H |
| A-1246 | H | Cl | Cl | F | H |
| A-1247 | F | Cl | Cl | F | H |
| A-1248 | Cl | Cl | Cl | F | H |
| A-1249 | CH₃ | Cl | Cl | F | H |
| A-1250 | CH₂CH₃ | Cl | Cl | F | H |
| A-1251 | H | Cl | CHF2 | F | H |
| A-1252 | F | Cl | CHF2 | F | H |
| A-1253 | Cl | Cl | CHF2 | F | H |
| A-1254 | CH₃ | Cl | CHF2 | F | H |
| A-1255 | CH₂CH₃ | Cl | CHF2 | F | H |
| A-1256 | H | Cl | CF₃ | F | H |
| A-1257 | F | Cl | CF₃ | F | H |
| A-1258 | Cl | Cl | CF₃ | F | H |
| A-1259 | CH₃ | Cl | CF₃ | F | H |
| A-1260 | CH₂CH₃ | Cl | CF₃ | F | H |
| A-1261 | H | Cl | SCHF₂ | F | H |
| A-1262 | F | Cl | SCHF₂ | F | H |
| A-1263 | Cl | Cl | SCHF₂ | F | H |
| A-1264 | CH₃ | Cl | SCHF₂ | F | H |
| A-1265 | CH₂CH₃ | Cl | SCHF₂ | F | H |
| A-1266 | H | Cl | SCF₃ | F | H |
| A-1267 | F | Cl | SCF₃ | F | H |
| A-1268 | Cl | Cl | SCF₃ | F | H |
| A-1269 | CH₃ | Cl | SCF₃ | F | H |
| A-1270 | CH₂CH₃ | Cl | SCF₃ | F | H |
| A-1271 | H | Cl | OCHF₂ | F | H |
| A-1272 | F | Cl | OCHF₂ | F | H |
| A-1273 | Cl | Cl | OCHF₂ | F | H |
| A-1274 | CH₃ | Cl | OCHF₂ | F | H |
| A-1275 | CH₂CH₃ | Cl | OCHF₂ | F | H |
| A-1276 | H | Cl | OCF₃ | F | H |
| A-1277 | F | Cl | OCF₃ | F | H |
| A-1278 | Cl | Cl | OCF₃ | F | H |
| A-1279 | CH₃ | Cl | OCF₃ | F | H |
| A-1280 | CH₂CH₃ | Cl | OCF₃ | F | H |
| A-1281 | H | Cl | F | Cl | H |
| A-1282 | F | Cl | F | Cl | H |
| A-1283 | Cl | Cl | F | Cl | H |
| A-1284 | CH₃ | Cl | F | Cl | H |
| A-1285 | CH₂CH₃ | Cl | F | Cl | H |
| A-1286 | H | Cl | Cl | Cl | H |
| A-1287 | F | Cl | Cl | Cl | H |
| A-1288 | Cl | Cl | Cl | Cl | H |
| A-1289 | CH₃ | Cl | Cl | Cl | H |
| A-1290 | CH₂CH₃ | Cl | Cl | Cl | H |
| A-1291 | H | Cl | CHF2 | Cl | H |
| A-1292 | F | Cl | CHF2 | Cl | H |
| A-1293 | Cl | Cl | CHF2 | Cl | H |
| A-1294 | CH₃ | Cl | CHF2 | Cl | H |
| A-1295 | CH₂CH₃ | Cl | CHF2 | Cl | H |
| A-1296 | H | Cl | CF₃ | Cl | H |
| A-1297 | F | Cl | CF₃ | Cl | H |
| A-1298 | Cl | Cl | CF₃ | Cl | H |
| A-1299 | CH₃ | Cl | CF₃ | Cl | H |
| A-1300 | CH₂CH₃ | Cl | CF₃ | Cl | H |
| A-1301 | H | Cl | SCHF₂ | Cl | H |
| A-1302 | F | Cl | SCHF₂ | Cl | H |
| A-1303 | Cl | Cl | SCHF₂ | Cl | H |
| A-1304 | CH₃ | Cl | SCHF₂ | Cl | H |
| A-1305 | CH₂CH₃ | Cl | SCHF₂ | Cl | H |
| A-1306 | H | Cl | SCF₃ | Cl | H |
| A-1307 | F | Cl | SCF₃ | Cl | H |
| A-1308 | Cl | Cl | SCF₃ | Cl | H |
| A-1309 | CH₃ | Cl | SCF₃ | Cl | H |
| A-1310 | CH₂CH₃ | Cl | SCF₃ | Cl | H |
| A-1311 | H | Cl | OCHF₂ | Cl | H |
| A-1312 | F | Cl | OCHF₂ | Cl | H |
| A-1313 | Cl | Cl | OCHF₂ | Cl | H |
| A-1314 | CH₃ | Cl | OCHF₂ | Cl | H |
| A-1315 | CH₂CH₃ | Cl | OCHF₂ | Cl | H |
| A-1316 | H | Cl | OCF₃ | Cl | H |
| A-1317 | F | Cl | OCF₃ | Cl | H |
| A-1318 | Cl | Cl | OCF₃ | Cl | H |
| A-1319 | CH₃ | Cl | OCF₃ | Cl | H |
| A-1320 | CH₂CH₃ | Cl | OCF₃ | Cl | H |
| A-1321 | H | Cl | F | CHF₂ | H |
| A-1322 | F | Cl | F | CHF₂ | H |
| A-1323 | Cl | Cl | F | CHF₂ | H |
| A-1324 | CH₃ | | F | CHF₂ | H |
| A-1325 | CH₂CH₃ | Cl | F | CHF₂ | H |
| A-1326 | H | Cl | Cl | CHF₂ | H |
| A-1327 | F | Cl | Cl | CHF₂ | H |
| A-1328 | Cl | Cl | Cl | CHF₂ | H |
| A-1329 | CH₃ | Cl | Cl | CHF₂ | H |
| A-1330 | CH₂CH₃ | Cl | Cl | CHF₂ | H |
| A-1331 | H | Cl | CHF2 | CHF₂ | H |
| A-1332 | F | Cl | CHF2 | CHF₂ | H |
| A-1333 | Cl | Cl | CHF2 | CHF₂ | H |
| A-1334 | CH₃ | Cl | CHF2 | CHF₂ | H |
| A-1335 | CH₂CH₃ | Cl | CHF2 | CHF₂ | H |
| A-1336 | H | Cl | CF₃ | CHF₂ | H |
| A-1337 | F | Cl | CF₃ | CHF₂ | H |
| A-1338 | Cl | Cl | CF₃ | CHF₂ | H |
| A-1339 | CH₃ | Cl | CF₃ | CHF₂ | H |
| A-1340 | CH₂CH₃ | Cl | CF₃ | CHF₂ | H |
| A-1341 | H | Cl | SCHF₂ | CHF₂ | H |
| A-1342 | F | Cl | SCHF₂ | CHF₂ | H |
| A-1343 | Cl | Cl | SCHF₂ | CHF₂ | H |
| A-1344 | CH₃ | Cl | SCHF₂ | CHF₂ | H |
| A-1345 | CH₂CH₃ | Cl | SCHF₂ | CHF₂ | H |
| A-1346 | H | Cl | SCF₃ | CHF₂ | H |
| A-1347 | F | Cl | SCF₃ | CHF₂ | H |
| A-1348 | Cl | Cl | SCF₃ | CHF₂ | H |
| A-1349 | CH₃ | Cl | SCF₃ | CHF₂ | H |
| A-1350 | CH₂CH₃ | Cl | SCF₃ | CHF₂ | H |
| A-1351 | H | Cl | OCHF₂ | CHF₂ | H |
| A-1352 | F | Cl | OCHF₂ | CHF₂ | H |
| A-1353 | Cl | Cl | OCHF₂ | CHF₂ | H |
| A-1354 | CH₃ | Cl | OCHF₂ | CHF₂ | H |
| A-1355 | CH₂CH₃ | Cl | OCHF₂ | CHF₂ | H |
| A-1356 | H | Cl | OCF₃ | CHF₂ | H |
| A-1357 | F | Cl | OCF₃ | CHF₂ | H |
| A-1358 | Cl | Cl | OCF₃ | CHF₂ | H |
| A-1359 | CH₃ | Cl | OCF₃ | CHF₂ | H |
| A-1360 | CH₂CH₃ | Cl | OCF₃ | CHF₂ | H |
| A-1361 | H | Cl | F | CF₃ | H |
| A-1362 | F | Cl | F | CF₃ | H |
| A-1363 | Cl | Cl | F | CF₃ | H |
| A-1364 | CH₃ | Cl | F | CF₃ | H |
| A-1365 | CH₂CH₃ | Cl | F | CF₃ | H |
| A-1366 | H | Cl | Cl | CF₃ | H |
| A-1367 | F | Cl | Cl | CF₃ | H |
| A-1368 | Cl | Cl | Cl | CF₃ | H |
| A-1369 | CH₃ | Cl | Cl | CF₃ | H |
| A-1370 | CH₂CH₃ | Cl | Cl | CF₃ | H |
| A-1371 | H | Cl | CHF2 | CF₃ | H |
| A-1372 | F | Cl | CHF2 | CF₃ | H |
| A-1373 | Cl | Cl | CHF2 | CF₃ | H |
| A-1374 | CH₃ | Cl | CHF2 | CF₃ | H |
| A-1375 | CH₂CH₃ | Cl | CHF2 | CF₃ | H |
| A-1376 | H | Cl | CF₃ | CF₃ | H |
| A-1377 | F | Cl | CF₃ | CF₃ | H |
| A-1378 | Cl | Cl | CF₃ | CF₃ | H |
| A-1379 | CH₃ | Cl | CF₃ | CF₃ | H |
| A-1380 | CH₂CH₃ | Cl | CF₃ | CF₃ | H |
| A-1381 | H | Cl | SCHF₂ | CF₃ | H |
| A-1382 | F | Cl | SCHF₂ | CF₃ | H |
| A-1383 | Cl | Cl | SCHF₂ | CF₃ | H |
| A-1384 | CH₃ | Cl | SCHF₂ | CF₃ | H |
| A-1385 | CH₂CH₃ | Cl | SCHF₂ | CF₃ | H |
| A-1386 | H | Cl | SCF₃ | CF₃ | H |
| A-1387 | F | Cl | SCF₃ | CF₃ | H |
| A-1388 | Cl | Cl | SCF₃ | CF₃ | H |
| A-1389 | CH₃ | Cl | SCF₃ | CF₃ | H |
| A-1390 | CH₂CH₃ | Cl | SCF₃ | CF₃ | H |
| A-1391 | H | Cl | OCHF₂ | CF₃ | H |
| A-1392 | F | Cl | OCHF₂ | CF₃ | H |
| A-1393 | Cl | Cl | OCHF₂ | CF₃ | H |
| A-1394 | CH₃ | Cl | OCHF₂ | CF₃ | H |
| A-1395 | CH₂CH₃ | Cl | OCHF₂ | CF₃ | H |
| A-1396 | H | Cl | OCF₃ | CF₃ | H |
| A-1397 | F | Cl | OCF₃ | CF₃ | H |
| A-1398 | Cl | Cl | OCF₃ | CF₃ | H |
| A-1399 | CH₃ | Cl | OCF₃ | CF₃ | H |
| A-1400 | CH₂CH₃ | Cl | OCF₃ | CF₃ | H |
| A-1401 | H | Cl | F | H | F |
| A-1402 | F | | F | H | F |
| A-1403 | Cl | Cl | F | H | F |
| A-1404 | CH₃ | Cl | F | H | F |
| A-1405 | CH₂CH₃ | Cl | F | H | F |
| A-1406 | H | Cl | Cl | H | F |
| A-1407 | F | Cl | Cl | H | F |
| A-1408 | Cl | Cl | Cl | H | F |
| A-1409 | CH₃ | Cl | Cl | H | F |
| A-1410 | CH₂CH₃ | Cl | Cl | H | F |
| A-1411 | H | Cl | CHF2 | H | F |
| A-1412 | F | Cl | CHF2 | H | F |
| A-1413 | Cl | Cl | CHF2 | H | F |
| A-1414 | CH₃ | Cl | CHF2 | H | F |
| A-1415 | CH₂CH₃ | Cl | CHF2 | H | F |
| A-1416 | H | Cl | CF₃ | H | F |
| A-1417 | F | Cl | CF₃ | H | F |
| A-1418 | Cl | Cl | CF₃ | H | F |
| A-1419 | CH₃ | Cl | CF₃ | H | F |
| A-1420 | CH₂CH₃ | Cl | CF₃ | H | F |
| A-1421 | H | Cl | SCHF₂ | H | F |
| A-1422 | F | Cl | SCHF₂ | H | F |
| A-1423 | Cl | Cl | SCHF₂ | H | F |
| A-1424 | CH₃ | Cl | SCHF₂ | H | F |
| A-1425 | CH₂CH₃ | Cl | SCHF₂ | H | F |
| A-1426 | H | Cl | SCF₃ | H | F |
| A-1427 | F | Cl | SCF₃ | H | F |
| A-1428 | Cl | Cl | SCF₃ | H | F |
| A-1429 | CH₃ | Cl | SCF₃ | H | F |
| A-1430 | CH₂CH₃ | Cl | SCF₃ | H | F |
| A-1431 | H | Cl | OCHF₂ | H | F |
| A-1432 | F | Cl | OCHF₂ | H | F |
| A-1433 | Cl | Cl | OCHF₂ | H | F |
| A-1434 | CH₃ | Cl | OCHF₂ | H | F |
| A-1435 | CH₂CH₃ | Cl | OCHF₂ | H | F |
| A-1436 | H | Cl | OCF₃ | H | F |
| A-1437 | F | Cl | OCF₃ | H | F |
| A-1438 | Cl | Cl | OCF₃ | H | F |
| A-1439 | CH₃ | Cl | OCF₃ | H | F |
| A-1440 | CH₂CH₃ | Cl | OCF₃ | H | F |
| A-1441 | H | Cl | F | F | F |
| A-1442 | F | Cl | F | F | F |
| A-1443 | Cl | Cl | F | F | F |
| A-1444 | CH₃ | Cl | F | F | F |
| A-1445 | CH₂CH₃ | Cl | F | F | F |
| A-1446 | H | Cl | Cl | F | F |
| A-1447 | F | Cl | Cl | F | F |
| A-1448 | Cl | Cl | Cl | F | F |
| A-1449 | CH₃ | Cl | Cl | F | F |
| A-1450 | CH₂CH₃ | Cl | Cl | F | F |
| A-1451 | H | Cl | CHF2 | F | F |
| A-1452 | F | Cl | CHF2 | F | F |
| A-1453 | Cl | Cl | CHF2 | F | F |
| A-1454 | CH₃ | Cl | CHF2 | F | F |
| A-1455 | CH₂CH₃ | Cl | CHF2 | F | F |
| A-1456 | H | Cl | CF₃ | F | F |
| A-1457 | F | Cl | CF₃ | F | F |
| A-1458 | Cl | Cl | CF₃ | F | F |
| A-1459 | CH₃ | Cl | CF₃ | F | F |
| A-1460 | CH₂CH₃ | Cl | CF₃ | F | F |
| A-1461 | H | Cl | SCHF₂ | F | F |
| A-1462 | F | Cl | SCHF₂ | F | F |
| A-1463 | Cl | Cl | SCHF₂ | F | F |
| A-1464 | CH₃ | Cl | SCHF₂ | F | F |
| A-1465 | CH₂CH₃ | Cl | SCHF₂ | F | F |
| A-1466 | H | Cl | SCF₃ | F | F |
| A-1467 | F | Cl | SCF₃ | F | F |
| A-1468 | Cl | Cl | SCF₃ | F | F |
| A-1469 | CH₃ | Cl | SCF₃ | F | F |
| A-1470 | CH₂CH₃ | Cl | SCF₃ | F | F |
| A-1471 | H | Cl | OCHF₂ | F | F |
| A-1472 | F | Cl | OCHF₂ | F | F |
| A-1473 | Cl | Cl | OCHF₂ | F | F |
| A-1474 | CH₃ | Cl | OCHF₂ | F | F |
| A-1475 | CH₂CH₃ | Cl | OCHF₂ | F | F |
| A-1476 | H | Cl | OCF₃ | F | F |
| A-1477 | F | Cl | OCF₃ | F | F |
| A-1478 | Cl | Cl | OCF₃ | F | F |
| A-1479 | CH₃ | Cl | OCF₃ | F | F |
| A-1480 | CH₂CH₃ | Cl | OCF₃ | F | F |
| A-1481 | H | Cl | F | Cl | F |
| A-1482 | F | Cl | F | Cl | F |
| A-1483 | Cl | Cl | F | Cl | F |
| A-1484 | CH₃ | Cl | F | Cl | F |
| A-1485 | CH₂CH₃ | Cl | F | Cl | F |
| A-1486 | H | Cl | Cl | Cl | F |
| A-1487 | F | Cl | Cl | Cl | F |
| A-1488 | Cl | Cl | Cl | Cl | F |
| A-1489 | CH₃ | Cl | Cl | Cl | F |
| A-1490 | CH₂CH₃ | Cl | Cl | Cl | F |
| A-1491 | H | Cl | CHF₂ | Cl | F |
| A-1492 | F | Cl | CHF₂ | Cl | F |
| A-1493 | Cl | Cl | CHF₂ | Cl | F |
| A-1494 | CH₃ | Cl | CHF₂ | Cl | F |
| A-1495 | CH₂CH₃ | Cl | CHF₂ | Cl | F |
| A-1496 | H | Cl | CF₃ | Cl | F |
| A-1497 | F | Cl | CF₃ | Cl | F |
| A-1498 | Cl | Cl | CF₃ | Cl | F |
| A-1499 | CH₃ | Cl | CF₃ | Cl | F |
| A-1500 | CH₂CH₃ | Cl | CF₃ | Cl | F |
| A-1501 | H | Cl | SCHF₂ | Cl | F |
| A-1502 | F | Cl | SCHF₂ | Cl | F |
| A-1503 | Cl | Cl | SCHF₂ | Cl | F |
| A-1504 | CH₃ | Cl | SCHF₂ | Cl | F |
| A-1505 | CH₂CH₃ | Cl | SCHF₂ | Cl | F |
| A-1506 | H | Cl | SCF₃ | Cl | F |
| A-1507 | F | Cl | SCF₃ | Cl | F |
| A-1508 | Cl | Cl | SCF₃ | Cl | F |
| A-1509 | CH₃ | Cl | SCF₃ | Cl | F |
| A-1510 | CH₂CH₃ | Cl | SCF₃ | Cl | F |
| A-1511 | H | Cl | OCHF₂ | Cl | F |
| A-1512 | F | Cl | OCHF₂ | Cl | F |
| A-1513 | Cl | Cl | OCHF₂ | Cl | F |
| A-1514 | CH₃ | Cl | OCHF₂ | Cl | F |
| A-1515 | CH₂CH₃ | Cl | OCHF₂ | Cl | F |
| A-1516 | H | Cl | OCF₃ | Cl | F |
| A-1517 | F | Cl | OCF₃ | Cl | F |
| A-1518 | Cl | Cl | OCF₃ | Cl | F |
| A-1519 | CH₃ | Cl | OCF₃ | Cl | F |
| A-1520 | CH₂CH₃ | Cl | OCF₃ | Cl | F |
| A-1521 | H | Cl | F | CHF₂ | F |
| A-1522 | F | Cl | F | CHF₂ | F |
| A-1523 | Cl | Cl | F | CHF₂ | F |
| A-1524 | CH₃ | Cl | F | CHF₂ | F |
| A-1525 | CH₂CH₃ | Cl | F | CHF₂ | F |
| A-1526 | H | Cl | Cl | CHF₂ | F |
| A-1527 | F | Cl | Cl | CHF₂ | F |
| A-1528 | Cl | Cl | Cl | CHF₂ | F |
| A-1529 | CH₃ | Cl | Cl | CHF₂ | F |
| A-1530 | CH₂CH₃ | Cl | Cl | CHF₂ | F |
| A-1531 | H | Cl | CHF₂ | CHF₂ | F |
| A-1532 | F | Cl | CHF₂ | CHF₂ | F |
| A-1533 | Cl | Cl | CHF₂ | CHF₂ | F |
| A-1534 | CH₃ | Cl | CHF₂ | CHF₂ | F |
| A-1535 | CH₂CH₃ | Cl | CHF₂ | CHF₂ | F |
| A-1536 | H | Cl | CF₃ | CHF₂ | F |
| A-1537 | F | Cl | CF₃ | CHF₂ | F |
| A-1538 | Cl | Cl | CF₃ | CHF₂ | F |
| A-1539 | CH₃ | Cl | CF₃ | CHF₂ | F |
| A-1540 | CH₂CH₃ | Cl | CF₃ | CHF₂ | F |
| A-1541 | H | Cl | SCHF₂ | CHF₂ | F |
| A-1542 | F | Cl | SCHF₂ | CHF₂ | F |
| A-1543 | Cl | Cl | SCHF₂ | CHF₂ | F |
| A-1544 | CH₃ | Cl | SCHF₂ | CHF₂ | F |
| A-1545 | CH₂CH₃ | Cl | SCHF₂ | CHF₂ | F |
| A-1546 | H | Cl | SCF₃ | CHF₂ | F |
| A-1547 | F | Cl | SCF₃ | CHF₂ | F |
| A-1548 | Cl | Cl | SCF₃ | CHF₂ | F |
| A-1549 | CH₃ | Cl | SCF₃ | CHF₂ | F |
| A-1550 | CH₂CH₃ | Cl | SCF₃ | CHF₂ | F |
| A-1551 | H | Cl | OCHF₂ | CHF₂ | F |
| A-1552 | F | Cl | OCHF₂ | CHF₂ | F |
| A-1553 | Cl | Cl | OCHF₂ | CHF₂ | F |
| A-1554 | CH₃ | Cl | OCHF₂ | CHF₂ | F |
| A-1555 | CH₂CH₃ | Cl | OCHF₂ | CHF₂ | F |
| A-1556 | H | Cl | OCF₃ | CHF₂ | F |
| A-1557 | F | Cl | OCF₃ | CHF₂ | F |
| A-1558 | Cl | Cl | OCF₃ | CHF₂ | F |
| A-1559 | CH₃ | Cl | OCF₃ | CHF₂ | F |
| A-1560 | CH₂CH₃ | Cl | OCF₃ | CHF₂ | F |
| A-1561 | H | Cl | F | CF₃ | F |
| A-1562 | F | Cl | F | CF₃ | F |
| A-1563 | Cl | Cl | F | CF₃ | F |
| A-1564 | CH₃ | Cl | F | CF₃ | F |
| A-1565 | CH₂CH₃ | Cl | F | CF₃ | F |
| A-1566 | H | Cl | Cl | CF₃ | F |
| A-1567 | F | Cl | Cl | CF₃ | F |
| A-1568 | Cl | Cl | Cl | CF₃ | F |
| A-1569 | CH₃ | Cl | Cl | CF₃ | F |
| A-1570 | CH₂CH₃ | Cl | Cl | CF₃ | F |
| A-1571 | H | Cl | CHF₂ | CF₃ | F |
| A-1572 | F | Cl | CHF₂ | CF₃ | F |
| A-1573 | Cl | Cl | CHF₂ | CF₃ | F |
| A-1574 | CH₃ | Cl | CHF₂ | CF₃ | F |
| A-1575 | CH₂CH₃ | Cl | CHF₂ | CF₃ | F |
| A-1576 | H | Cl | CF₃ | CF₃ | F |
| A-1577 | F | Cl | CF₃ | CF₃ | F |
| A-1578 | Cl | Cl | CF₃ | CF₃ | F |
| A-1579 | CH₃ | Cl | CF₃ | CF₃ | F |
| A-1580 | CH₂CH₃ | Cl | CF₃ | CF₃ | F |
| A-1581 | H | Cl | SCHF₂ | CF₃ | F |
| A-1582 | F | Cl | SCHF₂ | CF₃ | F |
| A-1583 | Cl | Cl | SCHF₂ | CF₃ | F |
| A-1584 | CH₃ | Cl | SCHF₂ | CF₃ | F |
| A-1585 | CH₂CH₃ | Cl | SCHF₂ | CF₃ | F |
| A-1586 | H | Cl | SCF₃ | CF₃ | F |
| A-1587 | F | Cl | SCF₃ | CF₃ | F |
| A-1588 | Cl | Cl | SCF₃ | CF₃ | F |
| A-1589 | CH₃ | Cl | SCF₃ | CF₃ | F |
| A-1590 | CH₂CH₃ | Cl | SCF₃ | CF₃ | F |
| A-1591 | H | Cl | OCHF₂ | CF₃ | F |
| A-1592 | F | Cl | OCHF₂ | CF₃ | F |
| A-1593 | Cl | Cl | OCHF₂ | CF₃ | F |
| A-1594 | CH₃ | Cl | OCHF₂ | CF₃ | F |
| A-1595 | CH₂CH₃ | Cl | OCHF₂ | CF₃ | F |
| A-1596 | H | Cl | OCF₃ | CF₃ | F |
| A-1597 | F | Cl | OCF₃ | CF₃ | F |
| A-1598 | Cl | Cl | OCF₃ | CF₃ | F |
| A-1599 | CH₃ | Cl | OCF₃ | CF₃ | F |
| A-1600 | CH₂CH₃ | Cl | OCF₃ | CF₃ | F |
| A-1601 | H | Cl | F | H | Cl |
| A-1602 | F | Cl | F | H | Cl |
| A-1603 | Cl | Cl | F | H | Cl |
| A-1604 | CH₃ | Cl | F | H | Cl |
| A-1605 | CH₂CH₃ | Cl | F | H | Cl |
| A-1606 | H | Cl | Cl | H | Cl |
| A-1607 | F | Cl | Cl | H | Cl |
| A-1608 | Cl | Cl | Cl | H | Cl |
| A-1609 | CH₃ | Cl | Cl | H | Cl |
| A-1610 | CH₂CH₃ | Cl | Cl | H | Cl |
| A-1611 | H | Cl | CHF₂ | H | Cl |
| A-1612 | F | Cl | CHF₂ | H | Cl |
| A-1613 | Cl | Cl | CHF₂ | H | Cl |
| A-1614 | CH₃ | Cl | CHF₂ | H | Cl |
| A-1615 | CH₂CH₃ | Cl | CHF₂ | H | Cl |
| A-1616 | H | Cl | CF₃ | H | Cl |
| A-1617 | F | Cl | CF₃ | H | Cl |
| A-1618 | Cl | Cl | CF₃ | H | Cl |
| A-1619 | CH₃ | Cl | CF₃ | H | Cl |
| A-1620 | CH₂CH₃ | Cl | CF₃ | H | Cl |
| A-1621 | H | Cl | SCHF₂ | H | Cl |
| A-1622 | F | Cl | SCHF₂ | H | Cl |
| A-1623 | Cl | Cl | SCHF₂ | H | Cl |
| A-1624 | CH₃ | Cl | SCHF₂ | H | Cl |
| A-1625 | CH₂CH₃ | Cl | SCHF₂ | H | Cl |
| A-1626 | H | Cl | SCF₃ | H | Cl |
| A-1627 | F | Cl | SCF₃ | H | Cl |
| A-1628 | Cl | Cl | SCF₃ | H | Cl |
| A-1629 | CH₃ | Cl | SCF₃ | H | Cl |
| A-1630 | CH₂CH₃ | Cl | SCF₃ | H | Cl |
| A-1631 | H | Cl | OCHF₂ | H | Cl |
| A-1632 | F | Cl | OCHF₂ | H | Cl |
| A-1633 | Cl | Cl | OCHF₂ | H | Cl |
| A-1634 | CH₃ | Cl | OCHF₂ | H | Cl |
| A-1635 | CH₂CH₃ | Cl | OCHF₂ | H | Cl |
| A-1636 | H | Cl | OCF₃ | H | Cl |
| A-1637 | F | Cl | OCF₃ | H | Cl |
| A-1638 | Cl | Cl | OCF₃ | H | Cl |
| A-1639 | CH₃ | Cl | OCF₃ | H | Cl |
| A-1640 | CH₂CH₃ | Cl | OCF₃ | H | Cl |
| A-1641 | H | Cl | F | F | Cl |
| A-1642 | F | Cl | F | F | Cl |
| A-1643 | Cl | Cl | F | F | Cl |
| A-1644 | CH₃ | Cl | F | F | Cl |
| A-1645 | CH₂CH₃ | Cl | F | F | Cl |
| A-1646 | H | Cl | Cl | F | Cl |
| A-1647 | F | Cl | Cl | F | Cl |
| A-1648 | Cl | Cl | Cl | F | Cl |
| A-1649 | CH₃ | Cl | Cl | F | Cl |
| A-1650 | CH₂CH₃ | Cl | Cl | F | Cl |
| A-1651 | H | Cl | CHF₂ | F | Cl |
| A-1652 | F | Cl | CHF₂ | F | Cl |
| A-1653 | Cl | Cl | CHF₂ | F | Cl |
| A-1654 | CH₃ | Cl | CHF₂ | F | Cl |
| A-1655 | CH₂CH₃ | Cl | CHF₂ | F | Cl |
| A-1656 | H | Cl | CF₃ | F | Cl |
| A-1657 | F | Cl | CF₃ | F | Cl |
| A-1658 | Cl | Cl | CF₃ | F | Cl |
| A-1659 | CH₃ | Cl | CF₃ | F | Cl |
| A-1660 | CH₂CH₃ | Cl | CF₃ | F | Cl |
| A-1661 | H | Cl | SCHF₂ | F | Cl |
| A-1662 | F | Cl | SCHF₂ | F | Cl |
| A-1663 | Cl | Cl | SCHF₂ | F | Cl |
| A-1664 | CH₃ | Cl | SCHF₂ | F | Cl |
| A-1665 | CH₂CH₃ | Cl | SCHF₂ | F | Cl |
| A-1666 | H | Cl | SCF₃ | F | Cl |
| A-1667 | F | Cl | SCF₃ | F | Cl |
| A-1668 | Cl | Cl | SCF₃ | F | Cl |
| A-1669 | CH₃ | Cl | SCF₃ | F | Cl |
| A-1670 | CH₂CH₃ | Cl | SCF₃ | F | Cl |
| A-1671 | H | Cl | OCHF₂ | F | Cl |
| A-1672 | F | Cl | OCHF₂ | F | Cl |
| A-1673 | Cl | Cl | OCHF₂ | F | Cl |
| A-1674 | CH₃ | Cl | OCHF₂ | F | Cl |
| A-1675 | CH₂CH₃ | Cl | OCHF₂ | F | Cl |
| A-1676 | H | Cl | OCF₃ | F | Cl |
| A-1677 | F | Cl | OCF₃ | F | Cl |
| A-1678 | Cl | Cl | OCF₃ | F | Cl |
| A-1679 | CH₃ | Cl | OCF₃ | F | Cl |
| A-1680 | CH₂CH₃ | Cl | OCF₃ | F | Cl |
| A-1681 | H | Cl | F | Cl | Cl |
| A-1682 | F | Cl | F | Cl | Cl |
| A-1683 | Cl | Cl | F | Cl | Cl |
| A-1684 | CH₃ | Cl | F | Cl | Cl |
| A-1685 | CH₂CH₃ | Cl | F | Cl | Cl |
| A-1686 | H | Cl | Cl | Cl | Cl |
| A-1687 | F | Cl | Cl | Cl | Cl |
| A-1688 | Cl | Cl | Cl | Cl | Cl |
| A-1689 | CH₃ | Cl | Cl | Cl | Cl |
| A-1690 | CH₂CH₃ | Cl | Cl | Cl | Cl |
| A-1691 | H | Cl | CHF₂ | Cl | Cl |
| A-1692 | F | Cl | CHF₂ | Cl | Cl |
| A-1693 | Cl | Cl | CHF₂ | Cl | Cl |
| A-1694 | CH₃ | Cl | CHF₂ | Cl | Cl |
| A-1695 | CH₂CH₃ | Cl | CHF₂ | Cl | Cl |
| A-1696 | H | Cl | CF₃ | Cl | Cl |
| A-1697 | F | Cl | CF₃ | Cl | Cl |
| A-1698 | Cl | Cl | CF₃ | Cl | Cl |
| A-1699 | CH₃ | Cl | CF₃ | Cl | Cl |
| A-1700 | CH₂CH₃ | Cl | CF₃ | Cl | Cl |
| A-1701 | H | Cl | SCHF₂ | Cl | Cl |
| A-1702 | F | Cl | SCHF₂ | Cl | Cl |
| A-1703 | Cl | Cl | SCHF₂ | Cl | Cl |
| A-1704 | CH₃ | Cl | SCHF₂ | Cl | Cl |
| A-1705 | CH₂CH₃ | Cl | SCHF₂ | Cl | Cl |
| A-1706 | H | Cl | SCF₃ | Cl | Cl |
| A-1707 | F | Cl | SCF₃ | Cl | Cl |
| A-1708 | Cl | Cl | SCF₃ | Cl | Cl |
| A-1709 | CH₃ | Cl | SCF₃ | Cl | Cl |
| A-1710 | CH₂CH₃ | Cl | SCF₃ | Cl | Cl |
| A-1711 | H | Cl | OCHF₂ | Cl | Cl |
| A-1712 | F | Cl | OCHF₂ | Cl | Cl |
| A-1713 | Cl | Cl | OCHF₂ | Cl | Cl |
| A-1714 | CH₃ | Cl | OCHF₂ | Cl | Cl |
| A-1715 | CH₂CH₃ | Cl | OCHF₂ | Cl | Cl |
| A-1716 | H | Cl | OCF₃ | Cl | Cl |
| A-1717 | F | Cl | OCF₃ | Cl | Cl |
| A-1718 | Cl | Cl | OCF₃ | Cl | Cl |
| A-1719 | CH₃ | Cl | OCF₃ | Cl | Cl |
| A-1720 | CH₂CH₃ | Cl | OCF₃ | Cl | Cl |
| A-1721 | H | Cl | F | CHF₂ | Cl |
| A-1722 | F | Cl | F | CHF₂ | Cl |
| A-1723 | Cl | Cl | F | CHF₂ | Cl |
| A-1724 | CH₃ | Cl | F | CHF₂ | Cl |
| A-1725 | CH₂CH₃ | Cl | F | CHF₂ | Cl |
| A-1726 | H | Cl | Cl | CHF₂ | Cl |
| A-1727 | F | Cl | Cl | CHF₂ | Cl |
| A-1728 | Cl | Cl | Cl | CHF₂ | Cl |
| A-1729 | CH₃ | Cl | Cl | CHF₂ | Cl |
| A-1730 | CH₂CH₃ | Cl | Cl | CHF₂ | Cl |
| A-1731 | H | Cl | CHF₂ | CHF₂ | Cl |
| A-1732 | F | Cl | CHF₂ | CHF₂ | Cl |
| A-1733 | Cl | Cl | CHF₂ | CHF₂ | Cl |
| A-1734 | CH₃ | Cl | CHF₂ | CHF₂ | Cl |
| A-1735 | CH₂CH₃ | Cl | CHF₂ | CHF₂ | Cl |
| A-1736 | H | Cl | CF₃ | CHF₂ | Cl |
| A-1737 | F | Cl | CF₃ | CHF₂ | Cl |
| A-1738 | Cl | Cl | CF₃ | CHF₂ | Cl |
| A-1739 | CH₃ | Cl | CF₃ | CHF₂ | Cl |
| A-1740 | CH₂CH₃ | Cl | CF₃ | CHF₂ | Cl |
| A-1741 | H | Cl | SCHF₂ | CHF₂ | Cl |
| A-1742 | F | Cl | SCHF₂ | CHF₂ | Cl |
| A-1743 | Cl | Cl | SCHF₂ | CHF₂ | Cl |
| A-1744 | CH₃ | Cl | SCHF₂ | CHF₂ | Cl |
| A-1745 | CH₂CH₃ | Cl | SCHF₂ | CHF₂ | Cl |
| A-1746 | H | Cl | SCF₃ | CHF₂ | Cl |
| A-1747 | F | Cl | SCF₃ | CHF₂ | Cl |
| A-1748 | Cl | Cl | SCF₃ | CHF₂ | Cl |
| A-1749 | CH₃ | Cl | SCF₃ | CHF₂ | Cl |
| A-1750 | CH₂CH₃ | Cl | SCF₃ | CHF₂ | Cl |
| A-1751 | H | Cl | OCHF₂ | CHF₂ | Cl |
| A-1752 | F | Cl | OCHF₂ | CHF₂ | Cl |
| A-1753 | Cl | Cl | OCHF₂ | CHF₂ | Cl |
| A-1754 | CH₃ | Cl | OCHF₂ | CHF₂ | Cl |
| A-1755 | CH₂CH₃ | Cl | OCHF₂ | CHF₂ | Cl |
| A-1756 | H | Cl | OCF₃ | CHF₂ | Cl |
| A-1757 | F | Cl | OCF₃ | CHF₂ | Cl |
| A-1758 | Cl | Cl | OCF₃ | CHF₂ | Cl |
| A-1759 | CH₃ | Cl | OCF₃ | CHF₂ | Cl |
| A-1760 | CH₂CH₃ | Cl | OCF₃ | CHF₂ | Cl |
| A-1761 | H | Cl | F | CF₃ | Cl |
| A-1762 | F | Cl | F | CF₃ | Cl |
| A-1763 | Cl | Cl | F | CF₃ | Cl |
| A-1764 | CH₃ | Cl | F | CF₃ | Cl |
| A-1765 | CH₂CH₃ | Cl | F | CF₃ | Cl |
| A-1766 | H | Cl | Cl | CF₃ | Cl |
| A-1767 | F | Cl | Cl | CF₃ | Cl |
| A-1768 | Cl | Cl | Cl | CF₃ | Cl |
| A-1769 | CH₃ | Cl | Cl | CF₃ | Cl |
| A-1770 | CH₂CH₃ | Cl | Cl | CF₃ | Cl |
| A-1771 | H | Cl | CHF₂ | CF₃ | Cl |
| A-1772 | F | Cl | CHF₂ | CF₃ | Cl |
| A-1773 | Cl | Cl | CHF₂ | CF₃ | Cl |
| A-1774 | CH₃ | Cl | CHF₂ | CF₃ | Cl |
| A-1775 | CH₂CH₃ | Cl | CHF₂ | CF₃ | Cl |
| A-1776 | H | Cl | CF₃ | CF₃ | Cl |
| A-1777 | F | Cl | CF₃ | CF₃ | Cl |
| A-1778 | Cl | Cl | CF₃ | CF₃ | Cl |
| A-1779 | CH₃ | Cl | CF₃ | CF₃ | Cl |
| A-1780 | CH₂CH₃ | Cl | CF₃ | CF₃ | Cl |
| A-1781 | H | Cl | SCHF₂ | CF₃ | Cl |
| A-1782 | F | Cl | SCHF₂ | CF₃ | Cl |
| A-1783 | Cl | Cl | SCHF₂ | CF₃ | Cl |
| A-1784 | CH₃ | Cl | SCHF₂ | CF₃ | Cl |
| A-1785 | CH₂CH₃ | Cl | SCHF₂ | CF₃ | Cl |
| A-1786 | H | Cl | SCF₃ | CF₃ | Cl |
| A-1787 | F | Cl | SCF₃ | CF₃ | Cl |
| A-1788 | Cl | Cl | SCF₃ | CF₃ | Cl |
| A-1789 | CH₃ | Cl | SCF₃ | CF₃ | Cl |
| A-1790 | CH₂CH₃ | Cl | SCF₃ | CF₃ | Cl |
| A-1791 | H | Cl | OCHF₂ | CF₃ | Cl |
| A-1792 | F | Cl | OCHF₂ | CF₃ | Cl |
| A-1793 | Cl | Cl | OCHF₂ | CF₃ | Cl |
| A-1794 | CH₃ | Cl | OCHF₂ | CF₃ | Cl |
| A-1795 | CH₂CH₃ | Cl | OCHF₂ | CF₃ | Cl |
| A-1796 | H | Cl | OCF₃ | CF₃ | Cl |
| A-1797 | F | Cl | OCF₃ | CF₃ | Cl |
| A-1798 | Cl | Cl | OCF₃ | CF₃ | Cl |
| A-1799 | CH₃ | Cl | OCF₃ | CF₃ | Cl |
| A-1800 | CH₂CH₃ | Cl | OCF₃ | CF₃ | Cl |
| A-1801 | H | CH₃ | F | H | H |
| A-1802 | F | CH₃ | F | H | H |
| A-1803 | Cl | CH₃ | F | H | H |
| A-1804 | CH₃ | CH₃ | F | H | H |
| A-1805 | CH₂CH₃ | CH₃ | F | H | H |
| A-1806 | H | CH₃ | Cl | H | H |
| A-1807 | F | CH₃ | Cl | H | H |
| A-1808 | Cl | CH₃ | Cl | H | H |
| A-1809 | CH₃ | CH₃ | Cl | H | H |
| A-1810 | CH₂CH₃ | CH₃ | Cl | H | H |
| A-1811 | H | CH₃ | CHF₂ | H | H |
| A-1812 | F | CH₃ | CHF₂ | H | H |
| A-1813 | Cl | CH₃ | CHF₂ | H | H |
| A-1814 | CH₃ | CH₃ | CHF₂ | H | H |
| A-1815 | CH₂CH₃ | CH₃ | CHF₂ | H | H |
| A-1816 | H | CH₃ | CF₃ | H | H |
| A-1817 | F | CH₃ | CF₃ | H | H |
| A-1818 | Cl | CH₃ | CF₃ | H | H |
| A-1819 | CH₃ | CH₃ | CF₃ | H | H |
| A-1820 | CH₂CH₃ | CH₃ | CF₃ | H | H |
| A-1821 | H | CH₃ | SCHF₂ | H | H |
| A-1822 | F | CH₃ | SCHF₂ | H | H |
| A-1823 | Cl | CH₃ | SCHF₂ | H | H |
| A-1824 | CH₃ | CH₃ | SCHF₂ | H | H |
| A-1825 | CH₂CH₃ | CH₃ | SCHF₂ | H | H |
| A-1826 | H | CH₃ | SCF₃ | H | H |
| A-1827 | F | CH₃ | SCF₃ | H | H |
| A-1828 | Cl | CH₃ | SCF₃ | H | H |
| A-1829 | CH₃ | CH₃ | SCF₃ | H | H |
| A-1830 | CH₂CH₃ | CH₃ | SCF₃ | H | H |
| A-1831 | H | CH₃ | OCHF₂ | H | H |
| A-1832 | F | CH₃ | OCHF₂ | H | H |
| A-1833 | Cl | CH₃ | OCHF₂ | H | H |
| A-1834 | CH₃ | CH₃ | OCHF₂ | H | H |
| A-1835 | CH₂CH₃ | CH₃ | OCHF₂ | H | H |
| A-1836 | H | CH₃ | OCF₃ | H | H |
| A-1837 | F | CH₃ | OCF₃ | H | H |
| A-1838 | Cl | CH₃ | OCF₃ | H | H |
| A-1839 | CH₃ | CH₃ | OCF₃ | H | H |
| A-1840 | CH₂CH₃ | CH₃ | OCF₃ | H | H |
| A-1841 | H | CH₃ | F | F | H |
| A-1842 | F | CH₃ | F | F | H |
| A-1843 | Cl | CH₃ | F | F | H |
| A-1844 | CH₃ | CH₃ | F | F | H |
| A-1845 | CH₂CH₃ | CH₃ | F | F | H |
| A-1846 | H | CH₃ | Cl | F | H |
| A-1847 | F | CH₃ | Cl | F | H |
| A-1848 | Cl | CH₃ | Cl | F | H |
| A-1849 | CH₃ | CH₃ | Cl | F | H |
| A-1850 | CH₂CH₃ | CH₃ | Cl | F | H |
| A-1851 | H | CH₃ | CHF₂ | F | H |
| A-1852 | F | CH₃ | CHF₂ | F | H |
| A-1853 | Cl | CH₃ | CHF₂ | F | H |
| A-1854 | CH₃ | CH₃ | CHF₂ | F | H |
| A-1855 | CH₂CH₃ | CH₃ | CHF₂ | F | H |
| A-1856 | H | CH₃ | CF₃ | F | H |
| A-1857 | F | CH₃ | CF₃ | F | H |
| A-1858 | Cl | CH₃ | CF₃ | F | H |
| A-1859 | CH₃ | CH₃ | CF₃ | F | H |
| A-1860 | CH₂CH₃ | CH₃ | CF₃ | F | H |
| A-1861 | H | CH₃ | SCHF₂ | F | H |
| A-1862 | F | CH₃ | SCHF₂ | F | H |
| A-1863 | Cl | CH₃ | SCHF₂ | F | H |
| A-1864 | CH₃ | CH₃ | SCHF₂ | F | H |
| A-1865 | CH₂CH₃ | CH₃ | SCHF₂ | F | H |
| A-1866 | H | CH₃ | SCF₃ | F | H |
| A-1867 | F | CH₃ | SCF₃ | F | H |
| A-1868 | Cl | CH₃ | SCF₃ | F | H |
| A-1869 | CH₃ | CH₃ | SCF₃ | F | H |
| A-1870 | CH₂CH₃ | CH₃ | SCF₃ | F | H |
| A-1871 | H | CH₃ | OCHF₂ | F | H |
| A-1872 | F | CH₃ | OCHF₂ | F | H |
| A-1873 | Cl | CH₃ | OCHF₂ | F | H |
| A-1874 | CH₃ | CH₃ | OCHF₂ | F | H |
| A-1875 | CH₂CH₃ | CH₃ | OCHF₂ | F | H |
| A-1876 | H | CH₃ | OCF₃ | F | H |
| A-1877 | F | CH₃ | OCF₃ | F | H |
| A-1878 | Cl | CH₃ | OCF₃ | F | H |
| A-1879 | CH₃ | CH₃ | OCF₃ | F | H |
| A-1880 | CH₂CH₃ | CH₃ | OCF₃ | F | H |
| A-1881 | H | CH₃ | F | Cl | H |
| A-1882 | F | CH₃ | F | Cl | H |
| A-1883 | Cl | CH₃ | F | Cl | H |
| A-1884 | CH₃ | CH₃ | F | Cl | H |
| A-1885 | CH₂CH₃ | CH₃ | F | Cl | H |
| A-1886 | H | CH₃ | Cl | Cl | H |
| A-1887 | F | CH₃ | Cl | Cl | H |
| A-1888 | Cl | CH₃ | Cl | Cl | H |
| A-1889 | CH₃ | CH₃ | Cl | Cl | H |
| A-1890 | CH₂CH₃ | CH₃ | Cl | Cl | H |
| A-1891 | H | CH₃ | CHF₂ | Cl | H |
| A-1892 | F | CH₃ | CHF₂ | Cl | H |
| A-1893 | Cl | CH₃ | CHF₂ | Cl | H |
| A-1894 | CH₃ | CH₃ | CHF₂ | Cl | H |
| A-1895 | CH₂CH₃ | CH₃ | CHF₂ | Cl | H |
| A-1896 | H | CH₃ | CF₃ | Cl | H |
| A-1897 | F | CH₃ | CF₃ | Cl | H |
| A-1898 | Cl | CH₃ | CF₃ | Cl | H |
| A-1899 | CH₃ | CH₃ | CF₃ | Cl | H |
| A-1900 | CH₂CH₃ | CH₃ | CF₃ | Cl | H |
| A-1901 | H | CH₃ | SCHF₂ | Cl | H |
| A-1902 | F | CH₃ | SCHF₂ | Cl | H |
| A-1903 | Cl | CH₃ | SCHF₂ | Cl | H |
| A-1904 | CH₃ | CH₃ | SCHF₂ | Cl | H |
| A-1905 | CH₂CH₃ | CH₃ | SCHF₂ | Cl | H |
| A-1906 | H | CH₃ | SCF₃ | Cl | H |
| A-1907 | F | CH₃ | SCF₃ | Cl | H |
| A-1908 | Cl | CH₃ | SCF₃ | Cl | H |
| A-1909 | CH₃ | CH₃ | SCF₃ | Cl | H |
| A-1910 | CH₂CH₃ | CH₃ | SCF₃ | Cl | H |
| A-1911 | H | CH₃ | OCHF₂ | Cl | H |
| A-1912 | F | CH₃ | OCHF₂ | Cl | H |
| A-1913 | Cl | CH₃ | OCHF₂ | Cl | H |
| A-1914 | CH₃ | CH₃ | OCHF₂ | Cl | H |
| A-1915 | CH₂CH₃ | CH₃ | OCHF₂ | Cl | H |
| A-1916 | H | CH₃ | OCF₃ | Cl | H |
| A-1917 | F | CH₃ | OCF₃ | Cl | H |
| A-1918 | Cl | CH₃ | OCF₃ | Cl | H |
| A-1919 | CH₃ | CH₃ | OCF₃ | Cl | H |
| A-1920 | CH₂CH₃ | CH₃ | OCF₃ | Cl | H |
| A-1921 | H | CH₃ | F | CHF₂ | H |
| A-1922 | F | CH₃ | F | CHF₂ | H |
| A-1923 | Cl | CH₃ | F | CHF₂ | H |
| A-1924 | CH₃ | CH₃ | F | CHF₂ | H |
| A-1925 | CH₂CH₃ | CH₃ | F | CHF₂ | H |
| A-1926 | H | CH₃ | Cl | CHF₂ | H |
| A-1927 | F | CH₃ | Cl | CHF₂ | H |
| A-1928 | Cl | CH₃ | Cl | CHF₂ | H |
| A-1929 | CH₃ | CH₃ | Cl | CHF₂ | H |
| A-1930 | CH₂CH₃ | CH₃ | Cl | CHF₂ | H |
| A-1931 | H | CH₃ | CHF₂ | CHF₂ | H |
| A-1932 | F | CH₃ | CHF₂ | CHF₂ | H |
| A-1933 | Cl | CH₃ | CHF₂ | CHF₂ | H |
| A-1934 | CH₃ | CH₃ | CHF₂ | CHF₂ | H |
| A-1935 | CH₂CH₃ | CH₃ | CHF₂ | CHF₂ | H |
| A-1936 | H | CH₃ | CF₃ | CHF₂ | H |
| A-1937 | F | CH₃ | CF₃ | CHF₂ | H |
| A-1938 | Cl | CH₃ | CF₃ | CHF₂ | H |
| A-1939 | CH₃ | CH₃ | CF₃ | CHF₂ | H |
| A-1940 | CH₂CH₃ | CH₃ | CF₃ | CHF₂ | H |
| A-1941 | H | CH₃ | SCHF₂ | CHF₂ | H |
| A-1942 | F | CH₃ | SCHF₂ | CHF₂ | H |
| A-1943 | Cl | CH₃ | SCHF₂ | CHF₂ | H |
| A-1944 | CH₃ | CH₃ | SCHF₂ | CHF₂ | H |
| A-1945 | CH₂CH₃ | CH₃ | SCHF₂ | CHF₂ | H |
| A-1946 | H | CH₃ | SCF₃ | CHF₂ | H |
| A-1947 | F | CH₃ | SCF₃ | CHF₂ | H |
| A-1948 | Cl | CH₃ | SCF₃ | CHF₂ | H |
| A-1949 | CH₃ | CH₃ | SCF₃ | CHF₂ | H |
| A-1950 | CH₂CH₃ | CH₃ | SCF₃ | CHF₂ | H |
| A-1951 | H | CH₃ | OCHF₂ | CHF₂ | H |
| A-1952 | F | CH₃ | OCHF₂ | CHF₂ | H |
| A-1953 | Cl | CH₃ | OCHF₂ | CHF₂ | H |
| A-1954 | CH₃ | CH₃ | OCHF₂ | CHF₂ | H |
| A-1955 | CH₂CH₃ | CH₃ | OCHF₂ | CHF₂ | H |
| A-1956 | H | CH₃ | OCF₃ | CHF₂ | H |
| A-1957 | F | CH₃ | OCF₃ | CHF₂ | H |
| A-1958 | Cl | CH₃ | OCF₃ | CHF₂ | H |
| A-1959 | CH₃ | CH₃ | OCF₃ | CHF₂ | H |
| A-1960 | CH₂CH₃ | CH₃ | OCF₃ | CHF₂ | H |
| A-1961 | H | CH₃ | F | CF₃ | H |
| A-1962 | F | CH₃ | F | CF₃ | H |
| A-1963 | Cl | CH₃ | F | CF₃ | H |
| A-1964 | CH₃ | CH₃ | F | CF₃ | H |
| A-1965 | CH₂CH₃ | CH₃ | F | CF₃ | H |
| A-1966 | H | CH₃ | Cl | CF₃ | H |
| A-1967 | F | CH₃ | Cl | CF₃ | H |
| A-1968 | Cl | CH₃ | Cl | CF₃ | H |
| A-1969 | CH₃ | CH₃ | Cl | CF₃ | H |
| A-1970 | CH₂CH₃ | CH₃ | Cl | CF₃ | H |
| A-1971 | H | CH₃ | CHF₂ | CF₃ | H |
| A-1972 | F | CH₃ | CHF₂ | CF₃ | H |
| A-1973 | Cl | CH₃ | CHF₂ | CF₃ | H |
| A-1974 | CH₃ | CH₃ | CHF₂ | CF₃ | H |
| A-1975 | CH₂CH₃ | CH₃ | CHF₂ | CF₃ | H |
| A-1976 | H | CH₃ | CF₃ | CF₃ | H |
| A-1977 | F | CH₃ | CF₃ | CF₃ | H |
| A-1978 | Cl | CH₃ | CF₃ | CF₃ | H |
| A-1979 | CH₃ | CH₃ | CF₃ | CF₃ | H |
| A-1980 | CH₂CH₃ | CH₃ | CF₃ | CF₃ | H |
| A-1981 | H | CH₃ | SCHF₂ | CF₃ | H |
| A-1982 | F | CH₃ | SCHF₂ | CF₃ | H |
| A-1983 | Cl | CH₃ | SCHF₂ | CF₃ | H |
| A-1984 | CH₃ | CH₃ | SCHF₂ | CF₃ | H |
| A-1985 | CH₂CH₃ | CH₃ | SCHF₂ | CF₃ | H |
| A-1986 | H | CH₃ | SCF₃ | CF₃ | H |
| A-1987 | F | CH₃ | SCF₃ | CF₃ | H |
| A-1988 | Cl | CH₃ | SCF₃ | CF₃ | H |
| A-1989 | CH₃ | CH₃ | SCF₃ | CF₃ | H |
| A-1990 | CH₂CH₃ | CH₃ | SCF₃ | CF₃ | H |
| A-1991 | H | CH₃ | OCHF₂ | CF₃ | H |
| A-1992 | F | CH₃ | OCHF₂ | CF₃ | H |
| A-1993 | Cl | CH₃ | OCHF₂ | CF₃ | H |
| A-1994 | CH₃ | CH₃ | OCHF₂ | CF₃ | H |
| A-1995 | CH₂CH₃ | CH₃ | OCHF₂ | CF₃ | H |
| A-1996 | H | CH₃ | OCF₃ | CF₃ | H |
| A-1997 | F | CH₃ | OCF₃ | CF₃ | H |
| A-1998 | Cl | CH₃ | OCF₃ | CF₃ | H |
| A-1999 | CH₃ | CH₃ | OCF₃ | CF₃ | H |
| A-2000 | CH₂CH₃ | CH₃ | OCF₃ | CF₃ | H |
| A-2001 | H | CH₃ | F | H | F |
| A-2002 | F | CH₃ | F | H | F |
| A-2003 | Cl | CH₃ | F | H | F |
| A-2004 | CH₃ | CH₃ | F | H | F |
| A-2005 | CH₂CH₃ | CH₃ | F | H | F |
| A-2006 | H | CH₃ | Cl | H | F |
| A-2007 | F | CH₃ | Cl | H | F |
| A-2008 | Cl | CH₃ | Cl | H | F |
| A-2009 | CH₃ | CH₃ | Cl | H | F |
| A-2010 | CH₂CH₃ | CH₃ | Cl | H | F |
| A-2011 | H | CH₃ | CHF₂ | H | F |
| A-2012 | F | CH₃ | CHF₂ | H | F |
| A-2013 | Cl | CH₃ | CHF₂ | H | F |
| A-2014 | CH₃ | CH₃ | CHF₂ | H | F |
| A-2015 | CH₂CH₃ | CH₃ | CHF₂ | H | F |
| A-2016 | H | CH₃ | CF₃ | H | F |
| A-2017 | F | CH₃ | CF₃ | H | F |
| A-2018 | Cl | CH₃ | CF₃ | H | F |
| A-2019 | CH₃ | CH₃ | CF₃ | H | F |
| A-2020 | CH₂CH₃ | CH₃ | CF₃ | H | F |
| A-2021 | H | CH₃ | SCHF₂ | H | F |
| A-2022 | F | CH₃ | SCHF₂ | H | F |
| A-2023 | Cl | CH₃ | SCHF₂ | H | F |
| A-2024 | CH₃ | CH₃ | SCHF₂ | H | F |
| A-2025 | CH₂CH₃ | CH₃ | SCHF₂ | H | F |
| A-2026 | H | CH₃ | SCF₃ | H | F |
| A-2027 | F | CH₃ | SCF₃ | H | F |
| A-2028 | Cl | CH₃ | SCF₃ | H | F |
| A-2029 | CH₃ | CH₃ | SCF₃ | H | F |
| A-2030 | CH₂CH₃ | CH₃ | SCF₃ | H | F |
| A-2031 | H | CH₃ | OCHF₂ | H | F |
| A-2032 | F | CH₃ | OCHF₂ | H | F |
| A-2033 | Cl | CH₃ | OCHF₂ | H | F |
| A-2034 | CH₃ | CH₃ | OCHF₂ | H | F |
| A-2035 | CH₂CH₃ | CH₃ | OCHF₂ | H | F |
| A-2036 | H | CH₃ | OCF₃ | H | F |
| A-2037 | F | CH₃ | OCF₃ | H | F |
| A-2038 | Cl | CH₃ | OCF₃ | H | F |
| A-2039 | CH₃ | CH₃ | OCF₃ | H | F |
| A-2040 | CH₂CH₃ | CH₃ | OCF₃ | H | F |
| A-2041 | H | CH₃ | F | F | F |
| A-2042 | F | CH₃ | F | F | F |
| A-2043 | Cl | CH₃ | F | F | F |
| A-2044 | CH₃ | CH₃ | F | F | F |
| A-2045 | CH₂CH₃ | CH₃ | F | F | F |
| A-2046 | H | CH₃ | Cl | F | F |
| A-2047 | F | CH₃ | Cl | F | F |
| A-2048 | Cl | CH₃ | Cl | F | F |
| A-2049 | CH₃ | CH₃ | Cl | F | F |
| A-2050 | CH₂CH₃ | CH₃ | Cl | F | F |
| A-2051 | H | CH₃ | CHF₂ | F | F |
| A-2052 | F | CH₃ | CHF₂ | F | F |
| A-2053 | Cl | CH₃ | CHF₂ | F | F |
| A-2054 | CH₃ | CH₃ | CHF₂ | F | F |
| A-2055 | CH₂CH₃ | CH₃ | CHF₂ | F | F |
| A-2056 | H | CH₃ | CF₃ | F | F |
| A-2057 | F | CH₃ | CF₃ | F | F |
| A-2058 | Cl | CH₃ | CF₃ | F | F |
| A-2059 | CH₃ | CH₃ | CF₃ | F | F |
| A-2060 | CH₂CH₃ | CH₃ | CF₃ | F | F |
| A-2061 | H | CH₃ | SCHF₂ | F | F |
| A-2062 | F | CH₃ | SCHF₂ | F | F |
| A-2063 | Cl | CH₃ | SCHF₂ | F | F |
| A-2064 | CH₃ | CH₃ | SCHF₂ | F | F |
| A-2065 | CH₂CH₃ | CH₃ | SCHF₂ | F | F |
| A-2066 | H | CH₃ | SCF₃ | F | F |
| A-2067 | F | CH₃ | SCF₃ | F | F |
| A-2068 | Cl | CH₃ | SCF₃ | F | F |
| A-2069 | CH₃ | CH₃ | SCF₃ | F | F |
| A-2070 | CH₂CH₃ | CH₃ | SCF₃ | F | F |
| A-2071 | H | CH₃ | OCHF₂ | F | F |
| A-2072 | F | CH₃ | OCHF₂ | F | F |
| A-2073 | Cl | CH₃ | OCHF₂ | F | F |
| A-2074 | CH₃ | CH₃ | OCHF₂ | F | F |
| A-2075 | CH₂CH₃ | CH₃ | OCHF₂ | F | F |
| A-2076 | H | CH₃ | OCF₃ | F | F |
| A-2077 | F | CH₃ | OCF₃ | F | F |
| A-2078 | Cl | CH₃ | OCF₃ | F | F |
| A-2079 | CH₃ | CH₃ | OCF₃ | F | F |
| A-2080 | CH₂CH₃ | CH₃ | OCF₃ | F | F |
| A-2081 | H | CH₃ | F | Cl | F |
| A-2082 | F | CH₃ | F | Cl | F |
| A-2083 | Cl | CH₃ | F | Cl | F |
| A-2084 | CH₃ | CH₃ | F | Cl | F |
| A-2085 | CH₂CH₃ | CH₃ | F | Cl | F |
| A-2086 | H | CH₃ | Cl | Cl | F |
| A-2087 | F | CH₃ | Cl | Cl | F |
| A-2088 | Cl | CH₃ | Cl | Cl | F |
| A-2089 | CH₃ | CH₃ | Cl | Cl | F |
| A-2090 | CH₂CH₃ | CH₃ | Cl | Cl | F |
| A-2091 | H | CH₃ | CHF₂ | Cl | F |
| A-2092 | F | CH₃ | CHF₂ | Cl | F |
| A-2093 | Cl | CH₃ | CHF₂ | Cl | F |
| A-2094 | CH₃ | CH₃ | CHF₂ | Cl | F |
| A-2095 | CH₂CH₃ | CH₃ | CHF₂ | Cl | F |
| A-2096 | H | CH₃ | CF₃ | Cl | F |
| A-2097 | F | CH₃ | CF₃ | Cl | F |
| A-2098 | Cl | CH₃ | CF₃ | Cl | F |
| A-2099 | CH₃ | CH₃ | CF₃ | Cl | F |
| A-2100 | CH₂CH₃ | CH₃ | CF₃ | Cl | F |
| A-2101 | H | CH₃ | SCHF₂ | Cl | F |
| A-2102 | F | CH₃ | SCHF₂ | Cl | F |
| A-2103 | Cl | CH₃ | SCHF₂ | Cl | F |
| A-2104 | CH₃ | CH₃ | SCHF₂ | Cl | F |
| A-2105 | CH₂CH₃ | CH₃ | SCHF₂ | Cl | F |
| A-2106 | H | CH₃ | SCF₃ | Cl | F |
| A-2107 | F | CH₃ | SCF₃ | Cl | F |
| A-2108 | Cl | CH₃ | SCF₃ | Cl | F |
| A-2109 | CH₃ | CH₃ | SCF₃ | Cl | F |
| A-2110 | CH₂CH₃ | CH₃C | SCF₃ | Cl | F |
| A-2111 | H | CH₃C | OCHF₂ | Cl | F |
| A-2112 | F | CH₃ | OCHF₂ | Cl | F |
| A-2113 | Cl | CH₃ | OCHF₂ | Cl | F |
| A-2114 | CH₃ | CH₃C | OCHF₂ | Cl | F |
| A-2115 | CH₂CH₃ | CH₃C | OCHF₂ | Cl | F |
| A-2116 | H | CH₃ | OCF₃ | Cl | F |
| A-2117 | F | CH₃ | OCF₃ | Cl | F |
| A-2118 | Cl | CH₃ | OCF₃ | Cl | F |
| A-2119 | CH₃ | CH₃ | OCF₃ | Cl | F |
| A-2120 | CH₂CH₃ | CH₃ | OCF₃ | Cl | F |
| A-2121 | H | CH₃ | F | CHF₂ | F |
| A-2122 | F | CH₃ | F | CHF₂ | F |
| A-2123 | Cl | CH₃ | F | CHF₂ | F |
| A-2124 | CH₃ | CH₃ | F | CHF₂ | F |
| A-2125 | CH₂CH₃ | CH₃ | F | CHF₂ | F |
| A-2126 | H | CH₃ | Cl | CHF₂ | F |
| A-2127 | F | CH₃ | Cl | CHF₂ | F |
| A-2128 | Cl | CH₃ | Cl | CHF₂ | F |
| A-2129 | CH₃ | CH₃ | Cl | CHF₂ | F |
| A-2130 | CH₂CH₃ | CH₃ | Cl | CHF₂ | F |
| A-2131 | H | CH₃ | CHF₂ | CHF₂ | F |
| A-2132 | F | CH₃ | CHF₂ | CHF₂ | F |
| A-2133 | Cl | CH₃ | CHF₂ | CHF₂ | F |
| A-2134 | CH₃ | CH₃ | CHF₂ | CHF₂ | F |
| A-2135 | CH₂CH₃ | CH₃ | CHF₂ | CHF₂ | F |
| A-2136 | H | CH₃ | CF₃ | CHF₂ | F |
| A-2137 | F | CH₃ | CF₃ | CHF₂ | F |
| A-2138 | Cl | CH₃ | CF₃ | CHF₂ | F |
| A-2139 | CH₃ | CH₃ | CF₃ | CHF₂ | F |
| A-2140 | CH₂CH₃ | CH₃ | CF₃ | CHF₂ | F |
| A-2141 | H | CH₃ | SCHF₂ | CHF₂ | F |
| A-2142 | F | CH₃ | SCHF₂ | CHF₂ | F |
| A-2143 | Cl | CH₃ | SCHF₂ | CHF₂ | F |
| A-2144 | CH₃ | CH₃ | SCHF₂ | CHF₂ | F |
| A-2145 | CH₂CH₃ | CH₃ | SCHF₂ | CHF₂ | F |
| A-2146 | H | CH₃ | SCF₃ | CHF₂ | F |
| A-2147 | F | CH₃ | SCF₃ | CHF₂ | F |
| A-2148 | Cl | CH₃ | SCF₃ | CHF₂ | F |
| A-2149 | CH₃ | CH₃ | SCF₃ | CHF₂ | F |
| A-2150 | CH₂CH₃ | CH₃ | SCF₃ | CHF₂ | F |
| A-2151 | H | CH₃ | OCHF₂ | CHF₂ | F |
| A-2152 | F | CH₃ | OCHF₂ | CHF₂ | F |
| A-2153 | Cl | CH₃ | OCHF₂ | CHF₂ | F |
| A-2154 | CH₃ | CH₃ | OCHF₂ | CHF₂ | F |
| A-2155 | CH₂CH₃ | CH₃ | OCHF₂ | CHF₂ | F |
| A-2156 | H | CH₃ | OCF₃ | CHF₂ | F |
| A-2157 | F | CH₃ | OCF₃ | CHF₂ | F |
| A-2158 | Cl | CH₃ | OCF₃ | CHF₂ | F |
| A-2159 | CH₃ | CH₃ | OCF₃ | CHF₂ | F |
| A-2160 | CH₂CH₃ | CH₃ | OCF₃ | CHF₂ | F |
| A-2161 | H | CH₃ | F | CF₃ | F |
| A-2162 | F | CH₃ | F | CF₃ | F |
| A-2163 | Cl | CH₃ | F | CF₃ | F |
| A-2164 | CH₃ | CH₃ | F | CF₃ | F |
| A-2165 | CH₂CH₃ | CH₃ | F | CF₃ | F |
| A-2166 | H | CH₃ | Cl | CF₃ | F |
| A-2167 | F | CH₃ | Cl | CF₃ | F |
| A-2168 | Cl | CH₃ | Cl | CF₃ | F |
| A-2169 | CH₃ | CH₃ | Cl | CF₃ | F |
| A-2170 | CH₂CH₃ | CH₃ | Cl | CF₃ | F |
| A-2171 | H | CH₃ | CHF₂ | CF₃ | F |
| A-2172 | F | CH₃ | CHF₂ | CF₃ | F |
| A-2173 | Cl | CH₃ | CHF₂ | CF₃ | F |
| A-2174 | CH₃ | CH₃ | CHF₂ | CF₃ | F |
| A-2175 | CH₂CH₃ | CH₃ | CHF₂ | CF₃ | F |
| A-2176 | H | CH₃ | CF₃ | CF₃ | F |
| A-2177 | F | CH₃ | CF₃ | CF₃ | F |
| A-2178 | Cl | CH₃ | CF₃ | CF₃ | F |
| A-2179 | CH₃ | CH₃ | CF₃ | CF₃ | F |
| A-2180 | CH₂CH₃ | CH₃ | CF₃ | CF₃ | F |
| A-2181 | H | CH₃ | SCHF₂ | CF₃ | F |
| A-2182 | F | CH₃ | SCHF₂ | CF₃ | F |
| A-2183 | Cl | CH₃ | SCHF₂ | CF₃ | F |
| A-2184 | CH₃ | CH₃ | SCHF₂ | CF₃ | F |
| A-2185 | CH₂CH₃ | CH₃ | SCHF₂ | CF₃ | F |
| A-2186 | H | CH₃ | SCF₃ | CF₃ | F |
| A-2187 | F | CH₃ | SCF₃ | CF₃ | F |
| A-2188 | Cl | CH₃ | SCF₃ | CF₃ | F |
| A-2189 | CH₃ | CH₃ | SCF₃ | CF₃ | F |
| A-2190 | CH₂CH₃ | CH₃ | SCF₃ | CF₃ | F |
| A-2191 | H | CH₃ | OCHF₂ | CF₃ | F |
| A-2192 | F | CH₃ | OCHF₂ | CF₃ | F |
| A-2193 | Cl | CH₃ | OCHF₂ | CF₃ | F |
| A-2194 | CH₃ | CH₃ | OCHF₂ | CF₃ | F |
| A-2195 | CH₂CH₃ | CH₃ | OCHF₂ | CF₃ | F |
| A-2196 | H | CH₃ | OCF₃ | CF₃ | F |
| A-2197 | F | CH₃ | OCF₃ | CF₃ | F |
| A-2198 | Cl | CH₃ | OCF₃ | CF₃ | F |
| A-2199 | CH₃ | CH₃ | OCF₃ | CF₃ | F |
| A-2200 | CH₂CH₃ | CH₃ | OCF₃ | CF₃ | F |
| A-2201 | H | CH₃ | F | H | Cl |
| A-2202 | F | CH₃ | F | H | Cl |
| A-2203 | Cl | CH₃ | F | H | Cl |
| A-2204 | CH₃ | CH₃ | F | H | Cl |
| A-2205 | CH₂CH₃ | CH₃ | F | H | Cl |
| A-2206 | H | CH₃ | Cl | H | Cl |
| A-2207 | F | CH₃ | Cl | H | Cl |
| A-2208 | Cl | CH₃ | Cl | H | Cl |
| A-2209 | CH₃ | CH₃ | Cl | H | Cl |
| A-2210 | CH₂CH₃ | CH₃ | Cl | H | Cl |
| A-2211 | H | CH₃ | CHF₂ | H | Cl |
| A-2212 | F | CH₃ | CHF₂ | H | Cl |
| A-2213 | Cl | CH₃ | CHF₂ | H | Cl |
| A-2214 | CH₃ | CH₃ | CHF₂ | H | Cl |
| A-2215 | CH₂CH₃ | CH₃ | CHF₂ | H | Cl |
| A-2216 | H | CH₃ | CF₃ | H | Cl |
| A-2217 | F | CH₃ | CF₃ | H | Cl |
| A-2218 | Cl | CH₃ | CF₃ | H | Cl |
| A-2219 | CH₃ | CH₃ | CF₃ | H | Cl |
| A-2220 | CH₂CH₃ | CH₃ | CF₃ | H | Cl |
| A-2221 | H | CH₃ | SCHF₂ | H | Cl |
| A-2222 | F | CH₃ | SCHF₂ | H | Cl |
| A-2223 | Cl | CH₃ | SCHF₂ | H | Cl |
| A-2224 | CH₃ | CH₃ | SCHF₂ | H | Cl |
| A-2225 | CH₂CH₃ | CH₃ | SCHF₂ | H | Cl |
| A-2226 | H | CH₃ | SCF₃ | H | Cl |
| A-2227 | F | CH₃ | SCF₃ | H | Cl |
| A-2228 | Cl | CH₃ | SCF₃ | H | Cl |
| A-2229 | CH₃ | CH₃ | SCF₃ | H | Cl |
| A-2230 | CH₂CH₃ | CH₃ | SCF₃ | H | Cl |
| A-2231 | H | CH₃ | OCHF₂ | H | Cl |
| A-2232 | F | CH₃ | OCHF₂ | H | Cl |
| A-2233 | Cl | CH₃ | OCHF₂ | H | Cl |
| A-2234 | CH₃ | CH₃ | OCHF₂ | H | Cl |
| A-2235 | CH₂CH₃ | CH₃ | OCHF₂ | H | Cl |
| A-2236 | H | CH₃ | OCF₃ | H | Cl |
| A-2237 | F | CH₃ | OCF₃ | H | Cl |
| A-2238 | Cl | CH₃ | OCF₃ | H | Cl |
| A-2239 | CH₃ | CH₃ | OCF₃ | H | Cl |
| A-2240 | CH₂CH₃ | CH₃ | OCF₃ | H | Cl |
| A-2241 | H | CH₃ | F | F | Cl |
| A-2242 | F | CH₃ | F | F | Cl |
| A-2243 | Cl | CH₃ | F | F | Cl |
| A-2244 | CH₃ | CH₃ | F | F | Cl |
| A-2245 | CH₂CH₃ | CH₃ | F | F | Cl |
| A-2246 | H | CH₃ | Cl | F | Cl |
| A-2247 | F | CH₃ | Cl | F | Cl |
| A-2248 | Cl | CH₃ | Cl | F | Cl |
| A-2249 | CH₃ | CH₃ | Cl | F | Cl |
| A-2250 | CH₂CH₃ | CH₃ | Cl | F | Cl |
| A-2251 | H | CH₃ | CHF₂ | F | Cl |
| A-2252 | F | CH₃ | CHF₂ | F | Cl |
| A-2253 | Cl | CH₃ | CHF₂ | F | Cl |
| A-2254 | CH₃ | CH₃ | CHF₂ | F | Cl |
| A-2255 | CH₂CH₃ | CH₃ | CHF₂ | F | Cl |
| A-2256 | H | CH₃ | CF₃ | F | Cl |
| A-2257 | F | CH₃ | CF₃ | F | Cl |
| A-2258 | Cl | CH₃ | CF₃ | F | Cl |
| A-2259 | CH₃ | CH₃ | CF₃ | F | Cl |
| A-2260 | CH₂CH₃ | CH₃ | CF₃ | F | Cl |
| A-2261 | H | CH₃ | SCHF₂ | F | Cl |
| A-2262 | F | CH₃ | SCHF₂ | F | Cl |
| A-2263 | Cl | CH₃ | SCHF₂ | F | Cl |
| A-2264 | CH₃ | CH₃ | SCHF₂ | F | Cl |
| A-2265 | CH₂CH₃ | CH₃ | SCHF₂ | F | Cl |
| A-2266 | H | CH₃ | SCF₃ | F | Cl |
| A-2267 | F | CH₃ | SCF₃ | F | Cl |
| A-2268 | Cl | CH₃ | SCF₃ | F | Cl |
| A-2269 | CH₃ | CH₃ | SCF₃ | F | Cl |
| A-2270 | CH₂CH₃ | CH₃ | SCF₃ | F | Cl |
| A-2271 | H | CH₃ | OCHF₂ | F | Cl |
| A-2272 | F | CH₃ | OCHF₂ | F | Cl |
| A-2273 | Cl | CH₃ | OCHF₂ | F | Cl |
| A-2274 | CH₃ | CH₃ | OCHF₂ | F | Cl |
| A-2275 | CH₂CH₃ | CH₃ | OCHF₂ | F | Cl |
| A-2276 | H | CH₃ | OCF₃ | F | Cl |
| A-2277 | F | CH₃ | OCF₃ | F | Cl |
| A-2278 | Cl | CH₃ | OCF₃ | F | Cl |
| A-2279 | CH₃ | CH₃ | OCF₃ | F | Cl |
| A-2280 | CH₂CH₃ | CH₃ | OCF₃ | F | Cl |
| A-2281 | H | CH₃ | F | Cl | Cl |
| A-2282 | F | CH₃ | F | Cl | Cl |
| A-2283 | Cl | CH₃ | F | Cl | Cl |
| A-2284 | CH₃ | CH₃ | F | Cl | Cl |
| A-2285 | CH₂CH₃ | CH₃ | F | Cl | Cl |
| A-2286 | H | CH₃ | Cl | Cl | Cl |
| A-2287 | F | CH₃ | Cl | Cl | Cl |
| A-2288 | Cl | CH₃ | Cl | Cl | Cl |
| A-2289 | CH₃ | CH₃ | Cl | Cl | Cl |
| A-2290 | CH₂CH₃ | CH₃ | Cl | Cl | Cl |
| A-2291 | H | CH₃ | CHF₂ | Cl | Cl |
| A-2292 | F | CH₃ | CHF₂ | Cl | Cl |
| A-2293 | Cl | CH₃ | CHF₂ | Cl | Cl |
| A-2294 | CH₃ | CH₃ | CHF₂ | Cl | Cl |
| A-2295 | CH₂CH₃ | CH₃ | CHF₂ | Cl | Cl |
| A-2296 | H | CH₃ | CF₃ | Cl | Cl |
| A-2297 | F | CH₃ | CF₃ | Cl | Cl |
| A-2298 | Cl | CH₃ | CF₃ | Cl | Cl |
| A-2299 | CH₃ | CH₃ | CF₃ | Cl | Cl |
| A-2300 | CH₂CH₃ | CH₃ | CF₃ | Cl | Cl |
| A-2301 | H | CH₃ | SCHF₂ | Cl | Cl |
| A-2302 | F | CH₃ | SCHF₂ | Cl | Cl |
| A-2303 | Cl | CH₃ | SCHF₂ | Cl | Cl |
| A-2304 | CH₃ | CH₃ | SCHF₂ | Cl | Cl |
| A-2305 | CH₂CH₃ | CH₃ | SCHF₂ | Cl | Cl |
| A-2306 | H | CH₃ | SCF₃ | Cl | Cl |
| A-2307 | F | CH₃ | SCF₃ | Cl | Cl |
| A-2308 | Cl | CH₃ | SCF₃ | Cl | Cl |
| A-2309 | CH₃ | CH₃ | SCF₃ | Cl | Cl |
| A-2310 | CH₂CH₃ | CH₃ | SCF₃ | Cl | Cl |
| A-2311 | H | CH₃ | OCHF₂ | Cl | Cl |
| A-2312 | F | CH₃ | OCHF₂ | Cl | Cl |
| A-2313 | Cl | CH₃ | OCHF₂ | Cl | Cl |
| A-2314 | CH₃ | CH₃ | OCHF₂ | Cl | Cl |
| A-2315 | CH₂CH₃ | CH₃ | OCHF₂ | Cl | Cl |
| A-2316 | H | CH₃ | OCF₃ | Cl | Cl |
| A-2317 | F | CH₃ | OCF₃ | Cl | Cl |
| A-2318 | Cl | CH₃ | OCF₃ | Cl | Cl |
| A-2319 | CH₃ | CH₃ | OCF₃ | Cl | Cl |
| A-2320 | CH₂CH₃ | CH₃ | OCF₃ | Cl | Cl |
| A-2321 | H | CH₃ | F | CHF₂ | Cl |
| A-2322 | F | CH₃ | F | CHF₂ | Cl |
| A-2323 | Cl | CH₃ | F | CHF₂ | Cl |
| A-2324 | CH₃ | CH₃ | F | CHF₂ | Cl |
| A-2325 | CH₂CH₃ | CH₃ | F | CHF₂ | Cl |
| A-2326 | H | CH₃ | Cl | CHF₂ | Cl |
| A-2327 | F | CH₃ | Cl | CHF₂ | Cl |
| A-2328 | Cl | CH₃ | Cl | CHF₂ | Cl |
| A-2329 | CH₃ | CH₃ | Cl | CHF₂ | Cl |
| A-2330 | CH₂CH₃ | CH₃ | Cl | CHF₂ | Cl |
| A-2331 | H | CH₃ | CHF₂ | CHF₂ | Cl |
| A-2332 | F | CH₃ | CHF₂ | CHF₂ | Cl |
| A-2333 | Cl | CH₃ | CHF₂ | CHF₂ | Cl |
| A-2334 | CH₃ | CH₃ | CHF₂ | CHF₂ | Cl |
| A-2335 | CH₂CH₃ | CH₃ | CHF₂ | CHF₂ | Cl |
| A-2336 | H | CH₃ | CF₃ | CHF₂ | Cl |
| A-2337 | F | CH₃ | CF₃ | CHF₂ | Cl |
| A-2338 | Cl | CH₃ | CF₃ | CHF₂ | Cl |
| A-2339 | CH₃ | CH₃ | CF₃ | CHF₂ | Cl |
| A-2340 | CH₂CH₃ | CH₃ | CF₃ | CHF₂ | Cl |
| A-2341 | H | CH₃ | SCHF₂ | CHF₂ | Cl |
| A-2342 | F | CH₃ | SCHF₂ | CHF₂ | Cl |
| A-2343 | Cl | CH₃ | SCHF₂ | CHF₂ | Cl |
| A-2344 | CH₃ | CH₃ | SCHF₂ | CHF₂ | Cl |
| A-2345 | CH₂CH₃ | CH₃ | SCHF₂ | CHF₂ | Cl |
| A-2346 | H | CH₃ | SCF₃ | CHF₂ | Cl |
| A-2347 | F | CH₃ | SCF₃ | CHF₂ | Cl |
| A-2348 | Cl | CH₃ | SCF₃ | CHF₂ | Cl |
| A-2349 | CH₃ | CH₃ | SCF₃ | CHF₂ | Cl |
| A-2350 | CH₂CH₃ | CH₃ | SCF₃ | CHF₂ | Cl |
| A-2351 | H | CH₃ | OCHF₂ | CHF₂ | Cl |
| A-2352 | F | CH₃ | OCHF₂ | CHF₂ | Cl |
| A-2353 | Cl | CH₃ | OCHF₂ | CHF₂ | Cl |
| A-2354 | CH₃ | CH₃ | OCHF₂ | CHF₂ | Cl |
| A-2355 | CH₂CH₃ | CH₃ | OCHF₂ | CHF₂ | Cl |
| A-2356 | H | CH₃ | OCF₃ | CHF₂ | Cl |
| A-2357 | F | CH₃ | OCF₃ | CHF₂ | Cl |
| A-2358 | Cl | CH₃ | OCF₃ | CHF₂ | Cl |
| A-2359 | CH₃ | CH₃ | OCF₃ | CHF₂ | Cl |
| A-2360 | CH₂CH₃ | CH₃ | OCF₃ | CHF₂ | Cl |
| A-2361 | H | CH₃ | F | CF₃ | Cl |
| A-2362 | F | CH₃ | F | CF₃ | Cl |
| A-2363 | Cl | CH₃ | F | CF₃ | Cl |
| A-2364 | CH₃ | CH₃ | F | CF₃ | Cl |
| A-2365 | CH₂CH₃ | CH₃ | F | CF₃ | Cl |
| A-2366 | H | CH₃ | Cl | CF₃ | Cl |
| A-2367 | F | CH₃ | Cl | CF₃ | Cl |
| A-2368 | Cl | CH₃ | Cl | CF₃ | Cl |
| A-2369 | CH₃ | CH₃ | Cl | CF₃ | Cl |
| A-2370 | CH₂CH₃ | CH₃ | Cl | CF₃ | Cl |
| A-2371 | H | CH₃ | CHF₂ | CF₃ | Cl |
| A-2372 | F | CH₃ | CHF₂ | CF₃ | Cl |
| A-2373 | Cl | CH₃ | CHF₂ | CF₃ | Cl |
| A-2374 | CH₃ | CH₃ | CHF₂ | CF₃ | Cl |
| A-2375 | CH₂CH₃ | CH₃ | CHF₂ | CF₃ | Cl |
| A-2376 | H | CH₃ | CF₃ | CF₃ | Cl |
| A-2377 | F | CH₃ | CF₃ | CF₃ | Cl |
| A-2378 | Cl | CH₃ | CF₃ | CF₃ | Cl |
| A-2379 | CH₃ | CH₃ | CF₃ | CF₃ | Cl |
| A-2380 | CH₂CH₃ | CH₃ | CF₃ | CF₃ | Cl |
| A-2381 | H | CH₃ | SCHF₂ | CF₃ | Cl |
| A-2382 | F | CH₃ | SCHF₂ | CF₃ | Cl |
| A-2383 | Cl | CH₃ | SCHF₂ | CF₃ | Cl |
| A-2384 | CH₃ | CH₃ | SCHF₂ | CF₃ | Cl |
| A-2385 | CH₂CH₃ | CH₃ | SCHF₂ | CF₃ | Cl |
| A-2386 | H | CH₃ | SCF₃ | CF₃ | Cl |
| A-2387 | F | CH₃ | SCF₃ | CF₃ | Cl |
| A-2388 | Cl | CH₃ | SCF₃ | CF₃ | Cl |
| A-2389 | CH₃ | CH₃ | SCF₃ | CF₃ | Cl |
| A-2390 | CH₂CH₃ | CH₃ | SCF₃ | CF₃ | Cl |
| A-2391 | H | CH₃ | OCHF₂ | CF₃ | Cl |
| A-2392 | F | CH₃ | OCHF₂ | CF₃ | Cl |
| A-2393 | Cl | CH₃ | OCHF₂ | CF₃ | Cl |
| A-2394 | CH₃ | CH₃ | OCHF₂ | CF₃ | Cl |
| A-2395 | CH₂CH₃ | CH₃ | OCHF₂ | CF₃ | Cl |
| A-2396 | H | CH₃ | OCF₃ | CF₃ | Cl |
| A-2397 | F | CH₃ | OCF₃ | CF₃ | Cl |
| A-2398 | Cl | CH₃ | OCF₃ | CF₃ | Cl |
| A-2399 | CH₃ | CH₃ | OCF₃ | CF₃ | Cl |
| A-2400 | CH₂CH₃ | CH₃ | OCF₃ | CF₃ | Cl |

With respect to their use, very particular preference is given to the compounds I″ (R², R³, R⁴, R⁵, R⁶, R⁹, R¹⁰, R¹⁴ and R¹⁵ are hydrogen and R⁸ is methyl) 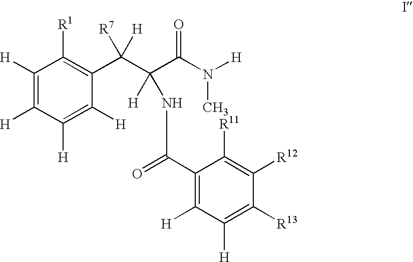
and in which
R¹ is hydrogen, fluorine or methyl;
R⁷ is hydrogen, methyl or ethyl;
R¹¹ is chlorine;
R¹² is trifluoromethyl;
R¹³ is hydrogen.

With respect to their use, very particular preference is also given to the compounds I′ in which
R¹ is hydrogen, fluorine or methyl;
R⁷ is hydrogen, methyl or ethyl;
R¹¹ is trifluoromethyl;
R¹² is hydrogen;
R¹³ is fluorine.

As mentioned at the outset, the S enantiomers or S diastereomers, with reference to the α carbon atom of the compounds listed in tables 1 to 96 are preferred.

The substituted phenylalanine derivatives of the formula I can be obtained by different routes, for example by solid-phase synthesis according to process 1 or 2:

Process 1:

A) Linking the Phenylalanine Derivative to a Carrier Resin

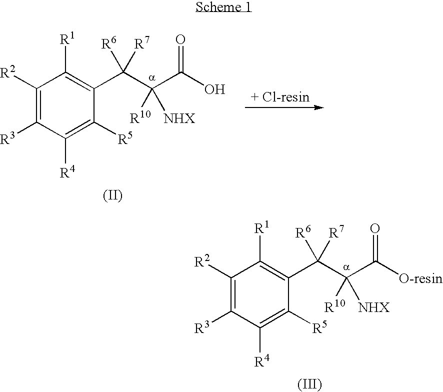

How to attach amino acid derivatives to a carrier resin is known and described, for example, in Barlos K. et al., Int J Pept Protein Res 37 (1991), 513; Barlos K. et al., Int J Pept Protein Res 47 (1991), 148; Barlos K. et al., Tetrahedron Lett. 30 (1989), 3943; Barlos K. et al., Tetrahedron Lett. 32 (1991), 471; Chhabra S. R. et al., Tetrahedron Lett. 39 (1998), 1603. A phenylalanine derivative II protected at the nitrogen function by a protective group X, for example by a 9-fluorenylmethoxycarbonyl (FMOC) protective group, a phenylmethoxycarbonyl (Cbz) group, a nitrobenzenelsulfenyl (Nps) group or a 1,1-dimethylethoxycarbonyl (Boc) group, is, in an esterification, attached to a resin which carries hydroxyl groups (see Scheme 1). The preparation of compounds II is known and is carried out analogously to known methods as described, for example, in Barlos K. et al., Int J Pept Protein Res 37 (1991), 513; Barlos K. et al., Int J Pept Protein Res 47 (1991), 148; Barlos K. et al., Tetrahedron Lett. 30 (1989), 3943; Barlos K. et al., Tetrahedron Lett. 32 (1991), 471; Chhabra S. R. et al., Tetrahedron Lett. 39 (1998), 1603. Furthermore, a large number of compounds II is commercially available. Here, the esterification is preferably carried out in the presence of a base, the ratio of base to compound II being approximately 2:1. Examples of suitable bases are amines, such as ethyldiisopropylamine, triethylamine or N-methylmorpholine. Suitable resins are for example resins based on polystyrene and having Wang or trityl linkers. The reaction is generally carried out in an inert organic solvent, for example an aromatic hydrocarbon such as benzene or toluene, or in a chlorinated hydrocarbon such as dichloromethane, or in an aprotic dipolar organic solvent such as dimethylformamide (DMF), dimethylacetamide (DMA) or N-methylpyrrolidone (NMP), or in an ether such as methyl t-butyl ether, diethyl ether or tetrahydrofuran (THF). The reaction can be carried out at temperatures of from 0° C. to the boiling point of the reaction mixture, preferably at room temperature.
B) Removal of the Protective Group X

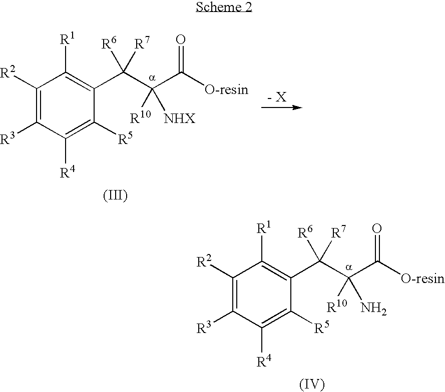

In step B, the protective group X (see Scheme 2) is removed similarly to known methods, in the case of an FMOC protective group by adding a base such as, for example, piperidine or 1,5-diazabicyclo[4.3.0]non-5-ene in an aprotic dipolar organic solvent such as dimethylformamide (DMF), dimethylacetamide (DMA) or N-methylpyrrolidone (NMP) in a ratio of 1:1 to 1:5, giving compounds IV. The reaction can be carried out at temperatures of from 0° C. to the boiling point of the reaction mixture, preferably at room temperature.

C) N-Acylation

The N-acylation of step C can be carried out a) using a substituted benzoic acid V (process variant C.1) or b) using a benzoic acid derivative, for example a substituted benzoyl halide VI (process variant C.2), similarly to known processses, as described, for example, in Neustadt B. R. et al., Tetrahedron Lett. 39 (1998), 5317.
C.1) N-Acylation Using a Substituted Benzoic Acid

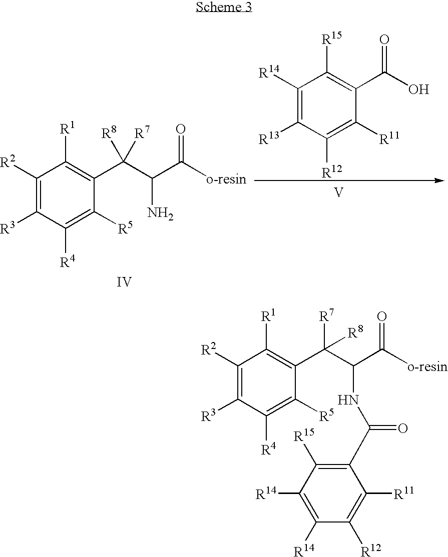

Using compounds VI, compounds V can be converted into compounds III (see Scheme 3), for example by activating the carboxyl group of V with electrophilic reagents such as, for example, dicyclohexylcarbodiimide (DCC) or diisopropylcarbodiimide (DIC) in the presence of a catalytic amount of an organic base such as, for example, 4-dimethylaminopyridine or pyridine. If appropriate, further activation of the reaction can be achieved by using 1-hydroxybenzotriazole. The reaction is carried out until complete conversion is achieved, over a period of 4-12 h at temperatures of from 0° C. to the boiling point of the reaction mixture, preferably at room temperature, in an inert organic solvent such as, for example, an aromatic hydrocarbon, such as benzene or toluene, or in a chlorinated hydrocarbon, such as dichloromethane, or in organic solvents, such as dimethylformamide (DMF), dimethylacetamide (DMA) or N-methylpyrrolidone (NMP), methyl t-butyl ether, diethyl ether or tetrahydrofuran (THF). The compounds V can be prepared similarly to known processes, as described, for example, in Houben-Weyl, “Methoden der organischen Chemie” [Methods of Organic Chemistry], 4^{th} edition, Ed. J. Talbe, New York 1985, pp. 193-585. Furthermore, a large number of compounds V is also commercially available.
C.2) N-Acylation Using a Substituted Benzoyl Halide

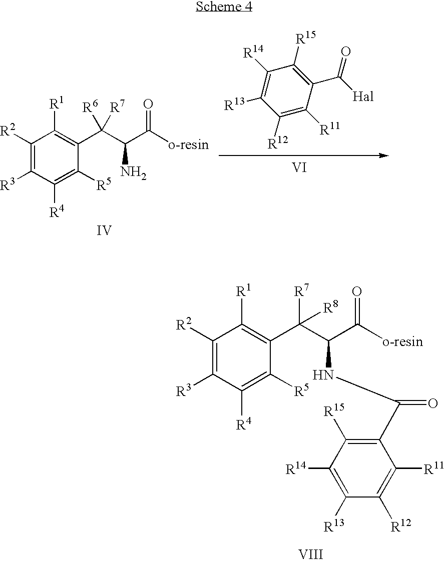

To prepare compound VIII, compound IV can be reacted with a substituted benzoyl halide VI, by adding an organic base such as triethylamine, N-methylmorpholine or diisopropylethylamine (DIPEA) or else pyridine, if appropriate in the presence of a catalytic amount of 4-dimethylaminopyridine (see Scheme 4). The reaction takes place at temperatures of from 0° C. to the boiling point of the reaction mixture, preferably at room temperature, in an inert organic solvent, such as, for example, an aromatic hydrocarbon, such as benzene or toluene, or in a chlorinated hydrocarbon, such as dichloromethane, or in organic solvents such as dimethylformamide (DMF), dimethylacetamide (DMA), N-methylpyrrolidone (NMP), methyl t-butyl ether, diethyl ether or tetrahydrofuran (THF). The compounds VI can be prepared similarly to known methods, as described, for example, in Houben-Weyl, “Methoden der organischen Chemie”, 4^{th} edition, Ed. J. Talbe, pp. 587-615. Furthermore, a large number of the compounds VI is also 30 commercially available.

The derivatized amino acid attached to the resin is then cleaved from the resin using an acid, such as trifluoroacetic acid or acetic acid, in a polar solvent, such as 2,2,2-trifluoroethanol, dichloromethane or mixtures of the solvents mentioned above, if appropriate in the presence of water. It is possible to use, for example, mixtures of 2,2,2-trifluoroethanol/acetic acid/dichloromethane.
D) Conversion of the N-Substituted Phenylalanine Derivative into Compound I

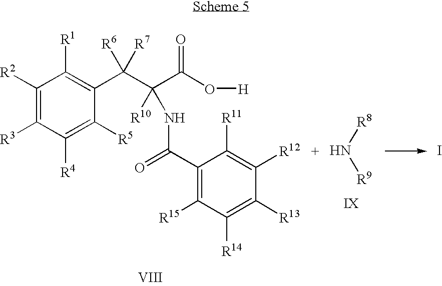

The conversion of the compound VIII into the phenylalanine derivatives of the formula I is carried out similarly to processes known from the literature, as described, for example, in Guan et al., J. Comb. Chem. 2 (2000), 297. Thus, the conversion of the derivatized amino acid into the amide I according to the invention can be carried out by adding an amine of the formula IX (see Scheme 5) in the presence of a resin-bound condensing agent, such as, for example, polystyrene-bound dicyclohexylcarbodiimide, at temperatures of from 0° C. to the boiling point of the reaction mixture, preferably at room temperature, in an inert aprotic dipolar organic solvent, such as dimethylformamide (DMF), dimethylacetamide (DMA) or N-methylpyrrolidone (NMP). Amines of the formula IX can be synthesized similarly to methods known to the person skilled in the art. Moreover, a large number of the amines IX is commercially available.

Process 2

Process 2 describes the preparation of compounds I in which R⁹=hydrogen.
A Reductive Amination of a Polymer Resin X

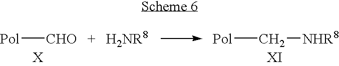

The reductive amination of a polymer-bound aldehyde is carried out similarly to known methods as described, for example, in Fivush et al., Tetrahedron Lett. 38 (1997), 7151; del Fresno et al., Tetrahedron Lett. 39 (1998), 2639 and Bilodeau et al., J Org Chem. 63 (1998), 2800.

A suitable polymer resin, for example a 4-(4-formyl-3-methoxyphenoxy)butyrylaminomethylpolystyrene resin (Pol-CHO) X is, in the presence of a reducing agent, such as sodium cyanoborohydride or else sodium trisacetoxyborohydrid, if appropriate with addition of acetic acid, methanol or ethanol, reacted in an organic solvent, such as dimethylformamide (DMF), dimethylacetamide (DMA) or N-methylpyrrolidone (NMP), with an amine IX, giving an aminated resin XI (see Scheme 6). The reaction is carried out until complete conversion is achieved, for a period of 12-24 h, at temperatures of from 0° C. to the boiling point of the reaction mixture, preferably at 40-60° C.
B N-Acylation Using a Substituted Phenylalanine Derivative

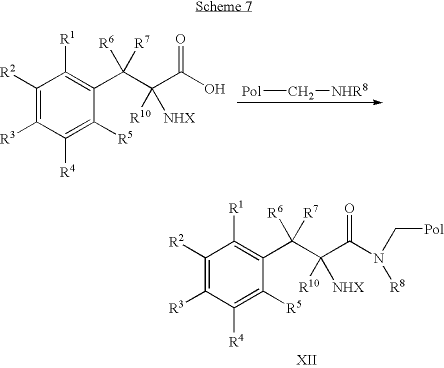

The compounds XI can be reacted with a phenylalanine derivative II which is protected at the nitrogen function by a protective group X, for example by a 9-fluorenylmethoxycarbonyl (FMOC) protective group, a phenylmethoxycarbonyl (Cbz) group, a nitrobenzenesulfenyl (Nps) group or a 1,1-dimethylethoxycarbonyl (Boc) group, to give the compounds XII. This can be achieved, for example, by activating the carboxyl group of II with electrophilic reagents, such as, for example, benzotriazol-1-yloxytrispyrrolidinophosphonium hexafluorophosphate (PyBOP) or else with the aid of condensing agents, such as dicyclohexylcarbodiimide (DCC) or diisopropylcarbodiimide and addition of a catalytic amount of an organic base, such as, for example, N-methylmorpholine or 4-dimethylaminopyridine. The reaction is carried out until complete conversion is achieved, for a period of 12-24 h, at temperatures of from 0° C. to the boiling point of the reaction mixture, preferably at room temperature, in an inert organic solvent, such as, for example, an aromatic hydrocarbon, such as benzene or toluene, or in a chlorinated hydrocarbon, such as dichloromethane, or in organic solvents, such as dimethylformamide (DMF), dimethylacetamide (DMA), N-methylpyrrolidone (NMP), methyl t-butyl ether, diethyl ether or tetrahydrofuran (THF).

C) Removal of the Protective Group X

The protective group X is removed analogously to step B of process 1, giving compounds XIII 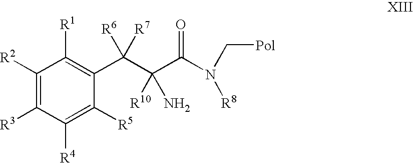
D) N-Acylation

The subsequent N-acylation to give the compounds I can be carried out similarly to the procedure described in step C.1 or C.2 of process 1, using a) a substituted benzoic acid V or [lacuna] a benzoic acid derivative, for example a substituted benzoyl halide VI, giving the compounds XIV

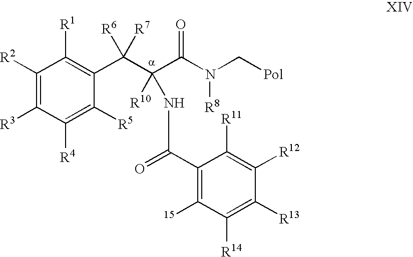

The derivatized amino acid which is attached to the resin is then cleaved from the resin using an acid, such as trifluoroacetic acid or acetic acid, in a polar solvent, such as 2,2,2-trifluoroethanol, dichloromethane or mixtures of the solvents mentioned above, if appropriate in the presence of water. It is possible, for example, to use mixtures of 2,2,2-trifluoroethanol/acetic acid/dichloromethane, giving the compounds I in which R⁹=hydrogen.

It is furthermore possible to prepare compounds I in liquid phase.

Process 3

A) Amination

Here, a phenylalanine derivative II protected at the nitrogen function by a protective group X, for example by a 9-fluorenylmethoxycarbonyl (FMOC) protective group, a phenylmethoxycarbonyl (Cbz) group, a nitrobenzenesulfenyl (Nps) group or a 1,1-dimethylethoxycarbonyl (Boc) group, is initially reacted with an amine IX in the presence of a suitable condensing agent, such as, for example, dicyclohexylcarbodiimide or diisopropylcarbodiimide, to give the compounds XV

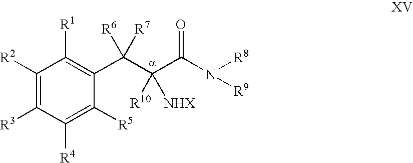

If appropriate, further activation of the reaction can be achieved by using 1-hydroxybenzotriazole. The reaction is carried out until complete conversion has been achieved, over a period of 4-12 h, at temperatures of from 0° C. to the boiling point of the reaction mixture, preferably at room temperature, in an inert organic solvent, such as, for example, an aromatic hydrocarbon, such as benzene or toluene, or in a chlorinated hydrocarbon, such as dichloromethane, or in organic solvents, such as dimethylformamide (DMF), methyl t-butyl ether, diethyl ether or tetrahydrofuran (THF). The reaction is carried out similarly to known methods as described, for example, in Bouygues et al., Med. Chem. 33 (1998) 445-450.

B) Removal of the Protective Group X

Depending on the protective group used, the protective group X is removed under basic, acidic or reductive conditions, for the Fmoc protective group, for example, analogously to step B of process 1, giving compounds XVI 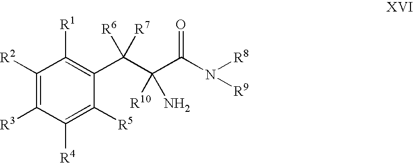
C) N-Acylation

The subsequent N-acylation to give the compounds I can be carried out similarly to the procedure described in step C.1 or C.2 of process 1, using a) a substituted benzoic acid V or [lacuna] a benzoic acid derivative, for example a substituted benzoyl halide VI.

Process 4

Substituted phenylalanine derivatives I in which R¹⁰=hydrogen can also be prepared analogously to the “malonic ester synthesis” using an aminomalonic acid ester such as diethyl aminomalonate.

Step A)

Here, the salt (for example the chloride) of an ammoniummalonic acid ester 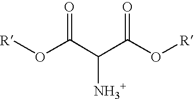
in which R¹ is a low-molecular-weight organic radical, for example a C₁-C₄-alkyl radical, preferably an easily obtainable, cheap compound, such as, for example, diethyl aminomalonate or dimethyl aminomalonate is initially reacted
with a substituted benzoic acid, for example a substituted benzoyl halide VI, in the presence of a base, such as ethyldiisopropylamine, triethylamine or N-methylmorpholine, giving compounds XVII

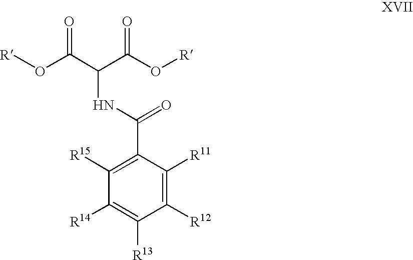

The reaction is carried out until complete conversion has been achieved, for a period of 4-12 h, at temperatures of from −15° C. to the boiling point of the reaction mixture, preferably at 0° C., in an inert organic solvent, such as, for example, an aromatic hydrocarbon, such as benzene or toluene, or in a chlorinated hydrocarbon, such as dichloromethane, or in organic solvents, such as dimethylformamide (DMF), methyl t-butyl ether, diethyl ether or tetrahydrofuran (THF).

Step B)

The product obtained in step A) is reacted with a benzyl derivative XVIII 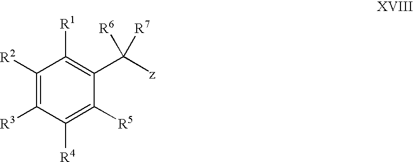
carrying a leaving group z, in an organic solvent, such as, for example, a cyclic ether, such as tetrahydrofuran (THF) or dioxane, in the presence of a base such as potassium tert-butoxide, sodium ethoxide, potassium carbonate or sodium carbonate, to give the diesters XIX

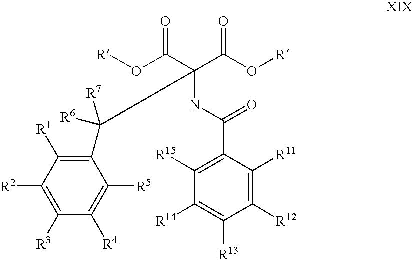

Suitable leaving groups z are, for example, halide or organosulfonyl groups. The reaction is carried out until complete conversion has been achieved, for a period of 4-12 h, at temperatures of from 0° C. to the boiling point of the reaction mixture, preferably at 80° C.

Step C)

Decarboxylation and hydrolysis of the diester XIX to give the compounds XX 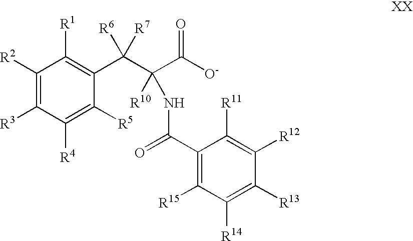
are carried out in the presence of a base and water, for example aqueous sodium hydroxide solution or aqueous potassium hydroxide solution, in one of the organic solvents mentioned in step B. The mixture is subsequently neutralized to a pH below 7, preferably a pH of 1-2, using a strong mineral acid, such as, for example, hydrochloric acid.
Step D)

The reaction of the acid of XX with an amine IX in the presence of resin-bound dicyclohexylcarbodiimide (DCC) is carried out analogously to the reaction conditions described in process 1, step D.

Process 5

Alternatively, the compounds of the formula 1 according to the invention can also be obtained by reacting the benzyl derivative XVIII with an alkylating agent XXI to give the compounds XXII. The methods for this purpose are known to the person skilled in the art (see, for example, 0 Donnell et al., Aldrichimica Acta Vol. 34 No. 1, 2001, pages 3 to 15) known.

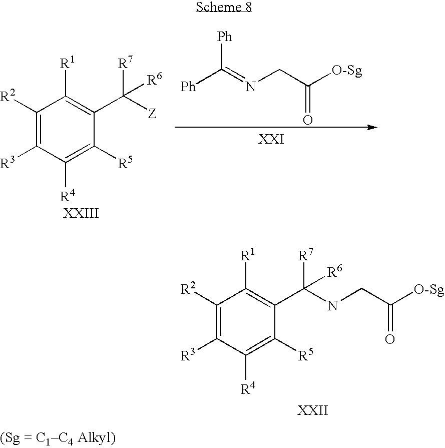

The further conversion into XXIII can be carried out analogously to the methods described in process 1, step C.1 or step C.2 by reacting the compound XXII with the benzyl derivative V or VI to give compound XXIII.

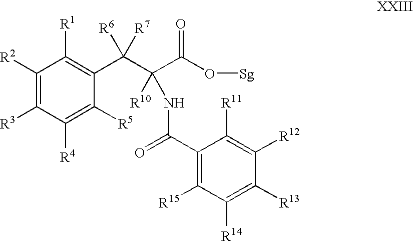

Subsequent conversion of XXIII into the compounds I can be effected using amine IX. Methods for this purpose can be found, for example, in DE 3917880 or J. het. Chem. 1991, 28, 33 ff.

The compounds I and their agriculturally useful salts are suitable, both in the form of isomer mixtures and in the form of the pure isomers, as herbicides. The herbicidal compositions comprising compounds of the formula I control vegetation on non-crop areas very efficiently, especially at high rates of application. They act against broad-leaved weeds and harmful grasses in crops such as wheat, rice, maize, soya and cotton without causing any significant damage to the crop plants. This effect is mainly observed at low rates of application.

Depending on the application method used, the compounds I or the herbicidal compositions comprising them, can additionally be employed in a further number of crop plants for eliminating undesirable plants. Examples of suitable crops are the following:

Allium cepa, Ananas comosus, Arachis hypogaea, Asparagus officinalis, Beta vulgaris spec. altissima, Beta vulgaris spec. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera and Zea mays.

In addition, the compounds I may also be used in crops which tolerate the action of herbicides owing to breeding, including genetic engineering methods.

The application should also include the use as growth regulator. The customary “WR” part was introduced here. If this does not cover the effects observed or if amendments are desired, please get back to me.

Furthermore, the compounds of the formula I are also suitable for regulating the growth of plants of plants.

The compounds I, or the herbicidal compositions comprising them, can be used for example in the form of ready-to-spray aqueous solutions, powders, suspensions, also highly-concentrated aqueous, oily or other suspensions or dispersions, emulsions, oil dispersions, pastes, dusts, materials for broadcasting or granules, by means of spraying, atomizing, dusting, broadcasting or watering. The use forms depend on the intended aims; in any case, they should ensure a very fine distribution of the active compounds according to the invention.

Essentially, suitable inert auxiliaries include: mineral oil fractions of medium to high boiling point, such as kerosene and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, or strongly polar solvents, e.g. amines such as N-methylpyrrolidone, and water.

Aqueous use forms can be prepared from emulsion concentrates, suspensions, pastes, wettable powders or water-dispersible granules by adding water. To prepare emulsions, pastes or oil dispersions, the phenylalanine derivatives, either as such or dissolved in an oil or solvent, can be homogenized in water by means of a wetting agent, tackifier, dispersant or emulsifier. Alternatively, it is possible to prepare concentrates consisting of active substance, wetting agent, tackifier, dispersant or emulsifier and, if desired, solvent or oil, which are suitable for dilution with water.

Suitable surfactants (adjuvants) are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene, or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or grinding the active substances together with a solid carrier.

Granules, e.g. coated granules, impregnated granules and homogeneous granules, can be prepared by binding the active compounds to solid carriers. Solid carriers are mineral earths, such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate and ureas, and products of vegetable origin, such as cereal meal, tree bark meal, wood meal and nutshell meal, cellulose powders, or other solid carriers.

The concentrations of the active compounds of the formula I in the ready-to-use preparations can be varied within wide ranges. In general, the formulations comprise from about 0.001 to 98% by weight, preferably from 0.01 to 95% by weight of at least one active compound. The active compounds are employed in a purity of from 90% to 100%, preferably from 95% to 100% (according to the NMR spectrum).

The compounds I according to the invention can be formulated, for example, as follows:
I. 20 parts by weight of the compound No. I-19 are dissolved in a mixture consisting of 80 parts by weight of alkylated benzene, 10 parts by weight of the adduct of 8 to 10 mol of ethylene oxide to 1 mol of oleic acid N-monoethanolamide, 5 parts by weight of calcium dodecylbenzenesulfonate and 5 parts by weight of the adduct of 40 mol of ethylene oxide to 1 mol of castor oil. Pouring the solution into 100,000 parts by weight of water and finely distributing it therein gives an aqueous dispersion which comprises 0.02% by weight of the active compound.
II. 20 parts by weight of the compound No. I-24 are dissolved in a mixture consisting of 40 parts by weight of cyclohexanone, 30 parts by weight of isobutanol, 20 parts by weight of the adduct of 7 mol of ethylene oxide to 1 mol of isooctylphenol and 10 parts by weight of the adduct of 40 mol of ethylene oxide to 1 mol of castor oil. Pouring the solution into 100,000 parts by weight of water and finely distributing it therein gives an aqueous dispersion which comprises 0.02% by weight of the active compound.
III. 20 parts by weight of the active compound No. I-25 are dissolved in a mixture consisting of 25 parts by weight of cyclohexanone, 65 parts by weight of a mineral oil fraction of boiling point 210 to 280° C. and 10 parts by weight of the adduct of 40 mol of ethylene oxide to 1 mol of castor oil. Pouring the solution into 100,000 parts by weight of water and finely distributing it therein gives an aqueous dispersion which comprises 0.02% by weight of the active compound.
IV. 20 parts by weight of the active compound No. I-32 are mixed thoroughly with 3 parts by weight of sodium diisobutylnaphthalenesulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20,000 parts by weight of water gives a spray mixture which comprises 0.1% by weight of the active compound.
V. 3 parts by weight of the active compound No. I-49 are mixed with 97 parts by weight of finely divided kaolin. This gives a dust which comprises 3% by weight of the active compound.
VI. 20 parts by weight of the active compound No. I-44 are mixed intimately with 2 parts by weight of the calcium salt of dodecylbenzenesulfonate, 8 parts by weight of fatty alcohol polyglycol ether, 2 parts by weight of the sodium salt of a phenol/urea/formaldehyde condensate and 68 parts by weight of a paraffinic mineral oil. This gives a stable oily dispersion.
VII. 1 part by weight of the compound No. I-26 is dissolved in a mixture consisting of 70 parts by weight of cyclohexanone, 20 parts by weight of ethoxylated isooctylphenol and 10 parts by weight of ethoxylated castor oil. This gives a stable emulsion concentrate.
VIII. 1 part by weight of the compound No. I-3 is dissolved in a mixture consisting of 80 parts by weight of cyclohexanone and 20 parts by weight of Wettol® EM 31 (nonionic emulsifier based on ethoxylated castor oil). This gives a stable emulsion concentrate.

The active compounds I or the herbicidal compositions can be applied pre- or post-emergence. If the active compounds are less well tolerated by certain crop plants, application techniques may be used in which the herbicidal compositions are sprayed, with the aid of the spraying equipment, in such a way that they come into contact as little as possible, if at all, with the leaves of the sensitive crop plants, while the active compounds reach the leaves of undesirable plants growing underneath, or the bare soil surface (post-directed, lay-by).

The growth-regulating compositions can be applied by the pre-emergence method or by the post-emergence method.

Depending on the season, the control target, the target plants and the growth stage, the application rates of the growth-regulating compositions of the formula I are, when used to regulate growth, from 0.001 to 5.0, preferably from 0.01 to 1.0, kg of active substance (a.s.)/ha:

The compounds of the formula I are capable of influencing virtually all development stages of a plant in various ways and are therefore used as growth regulators. The wide range of activity of the plant growth regualtors depends in particular
a) on the plant species and variety;
b) on the time of application, based on the stage of development of the plant, and on the season;
c) on the site of application and method of application, for example (seed dressing, soil treatment, foliage application or trunk injection in the case of trees
d) on climatic factors, for example temperature, amount of precipitation and also length of day and intensity of light;
e) on the soil characteristics (including fertilizer application),
f) on the formulation or application form of the growth-regulating composition of the formula I and finally
g) on the concentrations in which the active substance is used.

Of the number of different possible methods of application of the compound I as growth regulator in plant cultivation, in agriculture and in horticulture, some are stated below.

A. The compounds which can be used according to the invention permit considerable inhibition of the vegetative growth of the plants, which is evident in particular from a reduction in the growth in length. Accordingly, the treated plants exhibit stunted growth; in addition, a dark leaf coloration is observed. Reduced intensity of the growth of grasses at the edges of roads, in hedges, on canal embankments and on lawn areas such as parks, sports facilities, orchards, ornamental lawns and airfields, proves advantageous in practice, making it possible to reduce the labor-intensive and expensive cutting of grass.

The increase in the stability of crops susceptible to lodging, such as cereals, corn, sunflowers and soybean, is also of economic interest. The resulting shortening and strengthening of the stem reduce or eliminate the danger of lodging (bending) of plants under unfavorable weather conditions prior to harvesting.

The use of growth regulators for inhibiting the growth in length and for changing the time of ripening of cotton is also important. This permits completely mechanized harvesting of this important crop.

In the case of fruit trees and other trees, the growth regulators can be used to save pruning costs. In addition, the alternate bearing of fruit trees can be broken by means of growth regulators.

By using growth regulators, it is also possible to increase or inhibit the lateral branching of the plants. This is of interest when, for example in the case of tobacco plants, it is intended to inhibit the formation of side shoots in favor of leaf growth.

Growth regulators can also be used to effect a considerable increase in frost resistance, for example in the case of winter rape. On the one hand, the growth in length and the development to form a leaf or plant mass which is excessively luxuriant (and therefore particularly susceptible to frost) are inhibited. On the other hand, the young rape plants are held back in the vegetative stage of development after sowing and prior to the onset of the winter frosts, in spite of favorable growth conditions. This also eliminates the danger of frost damage to plants which tend toward a premature decline in the inhibition of blooming and toward a transition into the generative phase. In other crops too, for example winter cereals, it is advantageous if the crops are well tillered as a result of treatment with novel compounds in the fall but do not begin the winter with excessively luxuriant foliage. Increased sensitivity to frost and, owing to the relatively small leaf or plant mass, attack by various diseases (for example fungal disease) can thus be prevented. In addition, the inhibition of vegetative growth permits denser planting of the soil in the case of many crops, so that it is possible to achieve a higher yield, based on the soil area.

B. With the compounds of the formula I, it is possible to achieve higher yields of both plant parts and plant ingredients. Thus, it is possible, for example, to induce the growth of larger amounts of buds, blooms, leaves, fruits, seeds, roots and tubers, to increase the content of sugar in sugar beets, sugar cane and citrus fruits, to increase the protein content of cereals or soybean or to stimulate greater latex flow in rubber trees. The compounds of the formula I can produce increases in the yield by intervening in the metabolism of the plant or by promoting or inhibiting the vegetative and/or generative growth.

C. Finally, plant growth regulators can be used both for shortening or lengthening the stages of development and for accelerating or slowing down the ripening of the plant parts to be harvested prior to the harvest or of the harvested plant parts after harvesting.

For example, facilitating harvesting is of commercial interest and is permitted by concentrated dropping of fruit or a reduction of the strength of attachment to the tree in the case of citrus fruits, olives or other species and varieties of pomes, drupes and shell fruit. The same mechanism, ie. the promotion of the formation of abscission tissue between fruit part or leaf part and shoot part of the plant is also essential for readily controllable defoliation of useful plants, for example cotton.

D. Furthermore, the compounds of the formula I can be used to reduce the water consumption of plants. This is particularly important for agriculturally useful areas which have to be irrigated at high cost, for example in arid or semiarid regions. By using the novel substances, it is possible to reduce the intensity of irrigation and hence to carry out more economical farming. Under the influence of the compounds of the formula I, better utilization of the available water is achieved because, inter alia,
the extent of opening of the stomata is reduced
a thicker epidermis and cuticle are formed
the root penetration of the soil is improved and
the microclimate in the crop is advantageously influenced by more compact growth.

The compounds of the formula I which are to be used according to the invention as growth regulators can be fed to the crops both via the seed (as seed dressing) and via the soil, i.e. through the roots and, particularly preferably, via the foliage by spraying.

To widen the activity spectrum and to achieve synergistic effects, the phenylalanine derivatives of the formula I may be mixed with a large number of representatives of other herbicidal or growth-regulating active compound groups and then applied concomitantly. Suitable components for mixtures are, for example, 1,2,4-thiadiazoles, 1,3,4-thiadiazoles, amides, aminophosphoric acid and its derivatives, aminotriazoles, anilides, (het)aryloxy-alkanoic acids and their derivatives, benzoic acid and its derivatives, benzothiadiazinones, 2-(aroyl/hetaroyl)-1,3-cyclohexanediones, hetaryl aryl ketones, benzylisoxazolidinones, meta-CF₃-phenyl derivatives, carbamates, quinolinecarboxylic acid and its derivatives, chloroacetanilides, cyclohexenone oxime ether derivatives, diazines, dichloropropionic acid and its derivatives, dihydrobenzofurans, dihydrofuran-3-ones, dinitro-anilines, dinitrophenols, diphenyl ethers, dipyridyls, halocarboxylic acids and their derivatives, ureas, 3-phenyl-uracils, imidazoles, imidazolinones, N-phenyl-3,4,5,6-tetra-hydrophthalimides, oxadiazoles, oxiranes, phenols, aryloxy- and heteroaryloxyphenoxypropionic esters, phenylacetic acid and its derivatives, phenylpropionic acid and its derivatives, pyrazoles, phenylpyrazoles, pyridazines, pyridinecarboxylic acid and its derivatives, pyrimidyl ethers, sulfonamides, sulfonylureas, triazines, triazinones, triazolinones, triazolecarboxamides and uracils.

It may furthermore be advantageous to apply the compounds of the formula I, alone or else concomitantly in combination with other herbicides, or in the form of a mixture with other crop protection agents, for example together with agents for controlling pests or phytopathogenic fungi or bacteria. Also of interest is the miscibility with mineral salt solutions, which are employed for treating nutritional and trace element deficiencies. Non-phytotoxic oils and oil concentrates may also be added.

The application rates of the active compound are from 0.001 to 3.0, preferably from 0.01 to 1.0 kg/ha of active substance (a.s.), depending on the control target, the season, the target plants and the growth stage.

### PREPARATION EXAMPLES

Preparation of the Compound I-44

A) Reductive Amination of a Polymer Resin

20 g of 4-(4-formyl-3-methoxyphenoxy)butyryl-aminomethylpolystyrene resin were initially charged in 200 ml of dimethylformamide and 2 ml of acetic acid, 49 ml of methylamine, 10.7 ml of trimethyl orthoformate and 6.2 g of sodium cyanoborhydride were added and the mixture was shaken at 50° C. for 18 hours. After cooling to room temperature, the resin was filtered off, washed with in each case 100 ml of dimethylformamide (2×), methanol (1×), tetrahydrofuran (3×) and dichloromethane (3×) and dried at room temperature.

B) N-Acylation Using a Substituted Phenylalanine Derivative

5 g of the resin prepared in step A were initially charged in 50 ml of dichloromethan/dimethylformamide 1:1, 4.4 g of Fmoc-2-fluorophenylalanine and 5.6 g of benzotriazol-1-yloxy-trispyrrolidinophosphonium hexafluorophosphate (PyBOP) were added and the mixture was shaken at room temperature for 5 min. 1.9 ml of N-methylmorpholine were then added, and the mixture was shaken at room temperature for 18 hours. The resin was filtered off and then washed with in each case 20 ml of dimethylformamide (5×).

C) Removal of the Protective Group X

To remove the Fmoc protective group, the resin was suspended in 50 ml of dimethylformamide/piperidine 1:1 and shaken at room temperature for 1 h. The resin was then filtered off and washed with in each case 20 ml of dimethylformamide (2×), methanol (1×), tetrahydrofuran (3×) and dichloromethane (3×). The resin was dried at room temperature.

D) N-Acylation

250 mg of the resin from step C, 133 mg of 2,4-dichloro-3-(difluoromethyl)benzoic acid and 286 mg of benzotriazol-1-yloxytrispyrrolidinophosphonium hexafluorophosphate (PyBOP) were initially charged in dichloromethane/dimethylformamide 1:1 (2.5 ml). After 5 minutes of shaking, 97 μl of N-methylmorpholine were added, and the mixture was shaken at room temperature for 18 h. The resin was then filtered off and washed with in each case 3 ml of dimethylformamide (2×), methanol (1×), tetrahydrofuran (3×) and dichloromethane (3×). To cleave the product from the solid support, about 2 ml of trifluoroacetic acid/dichloromethane 1:3 were added to the resin. The mixture was shaken for 30 min and then filtered, and the filtrate was concentrated for further use.

*) 2,4-Dichloro-3-(difluoromethyl)benzoic acid was prepared as follows: Reaction of 1,3-dichloro-2-methylbenzene with acetyl chloride and subsequent oxidation to give 1,3-dichloro-2-methylbenzoic acid, conversion of the benzoic acid into the methyl ester, followed by bromination of the methyl group located in position 2, oxidation of the brominated methyl group to give the corresponding aldehyde, fluorination of the resulting product with diethylaminosulfur trifluoride and subsequent hydrolysis of the resulting methyl 2,4-dichloro-2-difluoromethylbenzoate to give 2,4-dichloro-3-(difluoromethyl)benzoic acid.

Yield: 48%

Preparation of the Compound I-32 by Process 4

Step A

13.8 ml of triethylamine were added to 5.29 g of diethyl aminomalonate hydrochloride in 100 ml of dichloromethane. With ice-cooling, trifluoromethylbenzoyl chloride was added to the resulting suspension, which was then shaken at room temperature overnight. The mixture was then extracted with 50 ml of water and the organic phase was separated off and dried over magnesium sulfate.

Step B

0.8 g of 1-(2-fluorophenyl)ethyl methanesulfonate *) and 0.673 g of potassium tert-butoxide were added to 1.27 g of the ester formed in step A in 20 ml of dioxane, and the mixture was incubated at 80° C. with shaking overnight. Water was then added at room temperature, followed by extraction with dichloromethane and subsequent drying over magnesium sulfate.

*) 1-(2-fluorophenyl)ethyl methanesulfonate was prepared from 1-(2-fluorophenyl)ethanol by reaction with methanesulfonic anhydride.

Step C

1 ml of concentrated (about 45% by weight strength) aqueous sodium hydroxide solution was added to 0.8 g of the diester formed in step B in 10 ml of dioxane, and the mixture was incubated at 80° C. with stirring overnight. Water was then added at room temperature. Following addition of hydrochloric acid until a pH of 2 had beep reached, the mixture was extracted with ethyl acetate and the organic phase was separated off and concentrated.

Step D

3.58 g of polymer-bound DCC and 0.315 g of methylamine (40% by volume in water) were added to 0.75 g of the acid formed in step C, the mixture was shaken at room temperature overnight and the resin was filtered off.

The compounds listed in Table I below were prepared by appropriate modification of the process described above. The compounds II required for the synthesis of the compounds were obtained from Fluka and Advanced Chem Tech, the substituted benzoic acids V and the substituted benzoyl chlorides VI were obtained from Aldrich and ABCR and the amines IX were obtained from from Aldrich.

The resulting phenylalanine derivatives of the formula I where R⁴, R⁵, R⁶, R⁸, R¹⁴ and R¹⁵=hydrogen and R⁹=methyl, as shown below, 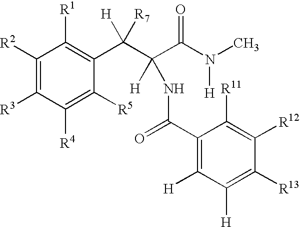
are listed in Table I together with physical data and the mass signal (M+). The measurements were carried out by by LC-MS (HP-1100, Agilent) using the following conditions:

LC-MS conditions:
Buffer A (isopropanol, 0.05% trifluoroacetic acid)
Buffer B (water, 0.05% trifluoroaceetic acid)
Flow rate: 1.2 ml/min
Injection volume: 2 μl
Fragmentation voltage: 20V, positive ionization mass range (m/z): 130-700
Column: Merck ROD column (50×4.6 mm)

N₂ detection:
(Method UV-MS-N₂)
Injection volume: 5 μl
Fragmentation voltage: 20V, positive ionization mass range (m/z): 130-700
   Preparation of Compound II-15 by Process 5
   Preparation of the Intermediate 1-(2-fluorophenyl)-1-bromopropane
   Step 1

At −20° C., 100 ml of a 1 M solution of ethylmagnesium bromide in THF were added to 10.0 g (0.081 mol) of 2-F-benzaldehyde in 150 ml of THF, the mixture was incubated with stirring for 1.5 h and 100 ml of saturated NH₄Cl solution was added dropwise. The mixture was saturated with NaCl and the organic phase was then separated off, the aqueous phase was extracted with ethyl acetate and the combined organic phases were concentrated.

1H-NMR signals (CDCl₃): 7.6-7.0 (m, 4 H), 5.0 (t, 1 H), 2.0 br.s. 1 H), 1.8 (m, 2 H), 1.0 (t, 3 H)

Yield: 11.2 g as a crude product of a purity of about 70% which was used without further purification for step 2

Step 2

11.2 g of the 1-(2-fluorophenyl)-1-bromopropane obtained in step 1 were dissolved in 150 ml of CH₂Cl₂, 90 ml of a 1 M solution of BBr3 in CH₂Cl₂ were added at 0° C. and the mixture was, after 1 h at 0° C., poured into ice-water. The organic phase was removed and the aqueous phase was then extracted with CH₂Cl₂, and the combined organic phases were concentrated.

1H-NMR signals (CDCl3): 7.4-7.0 (m, 4 H), 5.3 (m, 1 H), 2.3 (m, 1 H), 2.1 (m, 1 H), 1.0 (t, 3 H)

Yield: 14.2 g of the title compound, which was reacted further as a crude product of a purity of about 85%

Preparation of Nα-(2-trifluoromethyl-4-fluorobenzoyl)-2-(1-methyl-1-(2-fluorophenyl))glycine-N-methylamide (compound II-15)

Step 1

8.61 g of ethyl diphenylmethylideneglycinate, 7.0 g of 1-(1-bromopropyl)-2-fluorobenzene, 13.6 g (0.1 mol) of K2CO3 and 1.06 g (0.003 mol) of tetrabutylammonium bromide in 200 ml of acetonitrile were stirred under reflux for 43 h, cooled and filtered off. After concentration, the filtrate was dissolved in 150 ml of THF and stirred with 150 ml of 10% strength citric acid until the conversion was complete. After removal of the THF, the mixture was extracted with MTBE (methyl tert-butyl ether), the aqueous phase was saturated with K₂CO₃ and the product was extracted 3 times with in each case 100 ml of ethyl acetate. Drying and concentration gave 4.92.4 g of crude product which was used without further purification for the next step.

Step 2

2.4 g of the ethyl 2-(1-methyl-1-(2-(-fluorophenyl))glyinate from step 1 were dissolved in 100 ml of methylene chloride, 3.48 g of NEt3 were added and, at 0° C., 1.27 g (0.01 mol) of 2-trifluoromethyl-4-F-benzoyl chloride were added dropwise. The mixture was stirred at room temperature for 16 h and then diluted with 200 ml of ethyl acetate and washed with in each case 100 ml of 1N HCl and water, and the organic phase was removed under reduced pressure. Chromatographic separation on silica gel (mobile phase cyclohexane/ethyl acetate 8/1) gave 0.7 g of the pure diastereomer A of ethyl Nα-(2-trifluoromethyl-4-fluorobenzoyl)-2-(1-methyl-1-(2-fluorophenyl))glycinate, 0.22 g of a 1:1 mixture of the two diastereomers A and B of ethyl Nα-(2-trifluoromethyl-4-fluorobenzoyl)-2-(1-methyl-1-(2-fluorophenyl))glycinate and 0.6 g of the diastereomer B of ethyl Nα-(2-trifluoromethyl-4-fluorobenzoyl)-2-(1-methyl-1-(2-fluorophenyl))glycinate. Diastereomers A and B were separately characterized by spectroscopy, and all three fractions were then combined for the further conversion in step 3 to 1.55 g of a 1:1 diastereomer mixture.

Signals in the 1H-NMR (CDCl₃) of diastereomer A ethyl (Nα-(2-trifluoromethyl-4-fluorobenzoyl)-2-(1-methyl-1-(2-fluorophenyl))glycinate): 7.5-7.0 (m, 7 H), 6.1 (br. d 1H), 5.1 (m, 1 H), 4.3 (m, 2 H), 3.5 (m, 1 H9, 2.1-2.0 (m, 2 H), 1.3 (t, 3 H), 1.0 (t, 3 H).

Signals in the 1H-NMR (CDCl₃): of diastereomer B ethyl (Nα-(2-trifluoromethyl-4-fluorobenzoyl)-2-(1-methyl-1-(2-fluorophenyl))glycinate): 7.6-7.0 (m, 7 H), 6.3 (br. d, 1 H), 5.1 (m, 1 H), 4.1 (m, 2 H), 3.3 (m, 1 H), 2.0 (mc 2 H), 1.1 (t, 3 H), 0.8 (t, 3 H).

Step 3

1.5 g of the diastereomer mixture formed in step 2 were dissolved in 100 ml of ethanol. Subsequently, gaseous methylamine was added to the solution until saturation had been reached. After 4 days of stirring at room temperature, the mixture was concentrated and 200 ml of MTBE were added. The resulting solid was filtered off and dried. The resulting product was a 1:1 mixture of the diastereomers of compound II-15.

Yield: 0.261 g

Melting point: 201-202° C.

1H-NMR signals (d6-DMSO): 9.0 (br. d, 1 H), 8.7 (d, 1 H), 8.2 (d, 1 H), 7.8-7.1 (m, 14 H), 6.8 (m, 1 H), 4.9 (m, 1 H), 4.8 (m, 1 H), 3.3 (m, 2 H), 1.9 (m, 1 H), 1.6 (m, 3 H) 2.6 (d, 3 H), 2.4 (d, 3 H), 0.8 (m, 6 H).

The compounds listed in table II below were prepared by modifying the process described above in an appropriate manner. The starting materials required for synthesizing the compounds were obtained from Fluka and Advanced Chem Tech, the substituted benzoic acids V and the substituted benzoyl chlorides VI from Aldrich and ABCR and the amines IX from from Aldrich.

The resulting phenylalanine derivatives of the formula I where R⁹, R¹⁰, R¹⁴ and R¹⁵=hydrogen as shown below 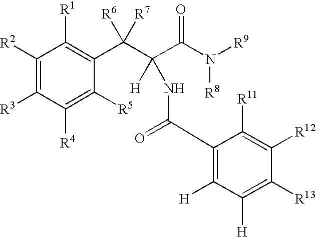
are [lacuna] in table II together with the melting point or physical data (mass signal (M+) and LC-MS mesurements using conditions a or i).

LC-MS conditions a:
Buffer A (acetonitrile, 0.1% trifluoroacetic acid)
Buffer B (water, 0.1% trifluoroacetic acid)
Flow rate: 1.8 ml/min
Temperature: 80° C.
Injection volume: 2 μl
Fragmentation voltage: 80V, positive ionization, mass range (m/z): 100-700
Column: Merck ROD column (50×4.6 mm)

LC-MS conditions i:
Buffer A (isopropanol, 0.05% trifluoroacetic acid)
Buffer B (water 0.05% trifluoroacetic acid)
Flow rate: 1.5 ml/min
Injection volume: 2 μl
Temperature: 40° C.
Fragmentation voltage: 20V, positive ionization mass range (m/z): 130-700

Column: Merck ROD column (50×4.6 mm)

TABLE I

| No. | R¹ | R² | R³ | R⁷ | R¹¹ | R¹² | R¹³ | R¹⁴ | Configuration | M+ |
|---|---|---|---|---|---|---|---|---|---|---|
| I-1 | F | H | H | H | F | H | H | H | Racemate | 319 |
| I-2 | F | H | H | H | Cl | Cl | H | H | Racemate | 369 |
| I-3 | F | H | H | H | CF₃ | H | H | H | Racemate | 369 |
| I-4 | H | F | H | H | F | H | H | H | Racemate | 319 |
| I-5 | H | F | H | H | Cl | Cl | H | H | Racemate | 370 |
| I-6 | H | F | H | H | Br | H | H | H | Racemate | 380 |
| I-7 | H | F | H | H | CF₃ | H | H | H | Racemate | 369 |
| I-8 | H | Cl | H | H | F | H | H | H | Racemate | 335 |
| I-9 | H | Cl | H | H | Cl | Cl | H | H | Racemate | 386 |
| I-10 | H | Cl | H | H | Br | H | H | H | Racemate | 396 |
| I-11 | H | Cl | H | H | CF₃ | H | H | H | Racemate | 384 |
| I-12 | Cl | H | H | H | F | H | H | H | Racemate | 335 |
| I-13 | Cl | H | H | H | Cl | Cl | H | H | Racemate | 386 |
| I-14 | Cl | H | H | H | Br | H | H | H | Racemate | 396 |
| I-15 | Cl | H | H | H | CF₃ | H | H | H | Racemate | 385 |
| I-16 | CH₃ | H | H | H | F | H | H | H | Racemate | 315 |
| I-17 | CH₃ | H | H | H | Cl | Cl | H | H | Racemate | 366 |
| I-18 | CH₃ | H | H | H | Br | H | H | H | Racemate | 376 |
| I-19 | CH₃ | H | H | H | CF₃ | H | H | H | S | 365 |
| I-20 | H | CH₃ | H | H | F | H | H | H | Racemate | 315 |
| I-21 | H | CH₃ | H | H | Cl | Cl | H | H | Racemate | 366 |
| I-22 | H | CH₃ | H | H | Br | H | H | H | Racemate | 376 |
| I-23 | H | CH₃ | H | H | CF₃ | H | H | H | Racemate | 365 |
| I-24 | H | F | H | H | CF₃ | F | H | H | S | 387 |
| I-25 | H | F | H | H | CF₃ | H | H | F | S | 387 |
| I-26 | H | H | H | H | CF₃ | H | H | H | S | 351 |
| I-27 | H | H | H | H | Cl | Cl | H | H | Racemate | 352 |
| I-28 | CH₃ | H | H | H | CF₃ | H | H | H | Racemate | 365 |
| I-29 | CH₃ | H | H | H | Cl | Cl | H | H | Racemate | 366 |
| I-30 | F | H | H | H | CF₃ | H | H | H | R | 369 |
| I-31 | F | H | H | H | Cl | Cl | H | H | R | 370 |
| I-32 | F | H | H | CH₃ | CF₃ | H | H | H | Diastereomer | 383 |
| I-33 | CH₃ | H | H | H | Cl | CF₃ | H | H | Racemate | 399 |
| I-34 | CH₃ | H | H | H | CF₃ | H | F | H | Racemate | 383 |
| I-35 | CH₃ | H | H | H | CF₃ | F | H | H | Racemate | 383 |
| I-36 | H | H | F | H | CF₃ | H | H | H | Racemate | 369 |
| I-37 | H | H | Cl | H | CF₃ | H | H | H | Racemate | 385 |
| I-38 | H | H | F | H | Cl | Cl | H | H | Racemate | 370 |
| I-39 | H | H | Cl | H | Cl | Cl | H | H | Racemate | 386 |
| I-40 | F | H | H | H | Cl | CF₃ | H | H | S | 403 |
| I-41 | F | H | H | H | Cl | H | NO₂ | H | S | 380 |
| I-42 | F | H | H | H | Cl | H | SO₂CH₃ | H | S | 413 |
| I-43 | F | H | H | H | Cl | CN | OCH₃ | H | S | 390 |
| I-44 | F | H | H | H | Cl | CHF₂ | Cl | H | S | 420 |
| I-45 | F | H | H | H | Cl | CH₃ | NO₂ | H | S | 394 |
| I-46 | CH₃ | H | H | H | Cl | H | NO₂ | H | S | 376 |
| I-47 | CH₃ | H | H | H | Cl | H | SO₂CH₃ | H | S | 409 |
| I-48 | CH₃ | H | H | H | Cl | CN | OCH₃ | H | S | 386 |
| I-49 | CH₃ | H | H | H | Cl | CHF₂ | Cl | H | S | 416 |
| I-50 | CH₃ | H | H | H | Cl | CH₃ | NO₂ | H | S | 390 |
| I-51 | CH₃ | H | H | H | CF₃ | H | F | H | S | 383 |
| I-52 | CH₃ | H | H | H | Cl | CF₃ | H | H | S | 399 |
| I-53 | CH₃ | H | H | H | CF₃ | F | H | H | S | 383 |
| I-54 | F | H | H | H | CF₃ | H | H | H | S | 369 |
| I-55 | F | H | H | H | Cl | Cl | H | H | S | 370 |
| I-56 | F | H | H | H | Cl | H | Cl | H | S | 370 |
| I-57 | F | H | H | H | Cl | H | F | H | S | 353 |
| I-58 | CF₃ | H | H | H | CF₃ | H | H | H | S | 419 |
| I-59 | CF₃ | H | H | H | Cl | Cl | H | H | S | 419 |
| I-60 | CH₃ | H | H | H | Cl | H | Cl | H | S | 365 |
| I-61 | CH₃ | H | H | H | Cl | H | F | H | S | 349 |

TABLE II

| No. | R¹ | R² | R³ | R⁴ | R⁵ | R⁶ | R⁷ | R⁸ |
|---|---|---|---|---|---|---|---|---|
| II-1 | F | OCH₃ | H | H | H | H | H | CH₃ |
| II-2 | H | H | H | CF₃ | H | H | H | CH₃ |
| II-3 | F | H | H | H | H | CH₃ | H | CH₃ |
| II-4 | F | H | H | H | H | H | CH₃ | CH₃ |
| II-5 | CH₂CH₃ | H | H | H | H | H | H | CH₃ |
| II-6 | F | H | H | H | H | CH₃ | H | CH₃ |
| II-7 | F | H | H | H | H | H | CH₃ | CH₃ |
| II-8 | CH₃ | H | H | H | H | CH₃ | H | CH₃ |
| II-9 | CH₃ | H | H | H | H | H | CH₃ | CH₃ |
| II-10 | CH₃ | H | H | H | H | CH₃ | H | CH₃ |
| II-11 | F | H | H | H | H | (CH₂)₃CH₃ | H | CH₃ |
| II-12 | F | H | H | H | H | (CH₂)₂CH₃ | H | CH₃ |
| II-13 | CH₃ | H | H | H | H | (CH₂)₂CH₃ | H | CH₃ |
| II-14 | CH₃ | H | H | H | H | CH₂CH₃ | H | CH₃ |
| II-15 | F | H | H | H | H | CH₂CH₃ | H | CH₃ |
| II-16 | F | H | H | H | H | CH₂CH₃ | H | CH₃ |
| II-17 | CH₃ | H | H | H | H | CH₂CH₃ | H | CH₃ |
| II-18 | CH₃ | H | H | H | CH₃ | H | H | CH₃ |
| II-19 | Br | H | H | H | H | H | H | CH₃ |
| II-20 | Cl | Cl | H | H | Cl | H | H | CH₃ |
| II-21 | F | H | H | H | H | (CH₂)₃CH₃ | H | CH₃ |
| II-22 | F | H | H | H | H | (CH₂)₃CH₃ | H | CH₃ |
| II-23 | F | H | H | H | Cl | H | H | CH₃ |
| II-24 | F | H | H | H | Cl | H | H | CH₃ |
| II-25 | H | H | H | H | H | CH₂CH₃ | H | CH₃ |
| II-26 | OH | H | H | H | H | H | H | CH₃ |
| II-27 | CF₃ | H | F | H | H | H | H | CH₃ |
| II-28 | Cl | Cl | OCH₃ | H | H | H | H | CH₃ |
| II-29 | Cl | Cl | OCH₃ | H | H | H | H | CH₃ |
| II-30 | F | H | Cl | H | H | H | H | CH₃ |
| II-31 | F | H | Cl | H | H | H | H | CH₃ |
| II-32 | OCH₃ | H | OCH₃ | H | H | H | H | CH₃ |
| II-33 | OCH₃ | H | H | OCH₃ | H | H | H | CH₃ |
| II-34 | Et | H | H | H | H | H | H | CH₃ |
| II-35 | OCH₃ | H | H | H | H | H | H | CH₃ |
| II-36 | OCH₃ | H | H | H | H | H | H | CH₃ |
| II-37 | NO₂ | H | H | H | Cl | H | H | CH₃ |
| II-38 | NO₂ | H | H | H | Cl | H | H | CH₃ |
| II-39 | H | CF₃ | H | CF₃ | H | H | H | CH₃ |
| II-40 | H | CH₃ | H | CH₃ | H | H | H | CH₃ |
| II-41 | F | F | H | H | H | H | H | CH₃ |
| II-42 | H | H | H | H | H | H | H | CH₂C(CH)₂ |
| II-43 | H | H | H | H | H | H | H | CH₂CH(CH₃)₂ |
| II-44 | H | H | H | H | H | H | H | CH₂CH(CH₃)₂ |
| II-45 | H | H | H | H | H | H | H | CH₂CH(CH₃)₂ |
| II-46 | F | H | H | F | Cl | H | H | CH₃ |
| II-47 | H | CF₃ | H | F | H | H | H | CH₃ |
| II-48 | SCF₃ | H | H | H | H | H | H | CH₃ |
| II-49 | H | Br | H | H | H | H | H | CH₃ |
| II-50 | H | F | H | F | H | H | H | CH₃ |
| II-51 | F | H | H | Cl | H | H | H | CH₃ |
| II-52 | F | H | H | CF₃ | H | H | H | CH₃ |
| II-53 | Br | H | H | F | H | H | H | CH₃ |
| II-54 | H | OCHF₂ | H | H | H | H | H | CH₃ |
| II-55 | F | Cl | H | CF₃ | H | H | H | CH₃ |
| II-56 | F | CH₃ | H | H | F | H | H | CH₃ |
| II-57 | F | F | H | F | H | H | H | CH₃ |
| II-58 | Cl | H | H | CF₃ | H | H | H | CH₃ |
| II-59 | H | SCF₃ | H | H | H | H | H | CH₃ |
| II-60 | F | H | H | F | H | H | H | CH₃ |
| II-61 | NO₂ | H | H | CH₃ | H | H | H | CH₃ |
| II-62 | F | Cl | H | H | H | H | H | CH₃ |
| II-63 | Cl | H | H | H | Cl | H | H | CH₃ |
| II-64 | H | OCH₃ | H | H | H | H | H | CH₃ |
| II-65 | H | OCF₃ | H | H | H | H | H | CH₃ |
| II-66 | Cl | CF₃ | H | H | H | H | H | CH₃ |
| II-67 | NO₂ | Cl | H | H | H | H | H | CH₃ |
| II-68 | NO₂ | H | H | H | H | H | H | CH₃ |
| II-69 | H | OCH₃ | H | OCH₃ | H | H | H | CH₃ |
| II-70 | Cl | CH(CH₃)₂ | H | H | H | H | H | CH₃ |
| II-71 | CH₃ | H | H | NO₂ | H | H | H | CH₃ |
| II-72 | F | H | H | H | F | H | H | CH₃ |
| II-73 | Cl | OCH₃ | H | OCH₃ | Cl | H | H | CH₃ |
| II-74 | Cl | OCH₃ | H | OCH₃ | H | H | H | CH₃ |
| II-75 | CN | H | H | H | H | H | H | CH₃ |
| II-76 | OCHF₂ | H | H | H | H | H | H | CH₃ |
| II-77 | CH₃ | CF₃ | H | H | H | H | H | CH₃ |
| II-78 | F | CH₃ | H | H | H | H | H | CH₃ |
| II-79 | CH₃ | H | H | CH₃ | H | H | H | CH₃ |
| II-80 | H | CH₃ | H | H | H | H | H | CH₃ |
| II-81 | F | CF₃ | H | H | H | H | H | CH₃ |
| II-82 | CH(CH₃)₂ | H | H | H | H | H | H | CH₃ |
| II-83 | CF₃ | H | H | H | H | H | H | CH₃ |
| II-84 | CH₃ | CH₃ | H | CH₃ | CH₃ | H | H | CH₃ |
| II-85 | CH₃ | H | H | H | CH₃ | H | H | CH₃ |
| II-86 | CH₃ | H | H | F | H | H | H | CH₃ |
| II-87 | CH₃ | Cl | H | H | H | H | H | CH₃ |
| II-88 | CH₃ | H | H | CH₃ | H | H | H | CH₃ |
| II-89 | F | CH₃ | H | H | H | H | H | CH₃ |
| II-90 | H | H | H | H | H | H | H | CH₃ |
| II-91 | H | H | H | H | H | H | H | CH₃ |
| II-92 | H | H | H | F | H | H | H | OH |
| II-93 | H | H | H | F | H | H | H | OCH₃ |
| II-94 | H | H | H | H | H | H | H | OH |
| II-95 | H | H | H | F | H | H | H | OCH₃ |
| II-96 | F | H | H | F | H | H | H | OH |
| II-97 | H | H | H | F | H | H | H | OCH₃ |
| II-98 | H | H | H | F | H | H | H | OH |
| II-99 | F | H | H | F | H | H | H | OH |
| II-100 | F | H | H | F | H | H | H | CH₃ |
| II-101 | H | F | H | H | H | H | H | CH₃ |
| II-102 | H | H | H | H | H | H | H | CH₃ |
| II-103 | H | H | H | H | H | H | H | CH₃ |
| II-104 | CH₃ | H | H | H | H | H | H | CH₃ |
| II-105 | F | H | H | H | H | H | H | CH₃ |
| II-106 | H | H | H | H | H | H | H | CH₃ |
| II-107 | CH₃ | H | H | F | H | H | H | CH₃ |
| II-108 | F | H | H | H | H | H | H | CH₃ |
| II-109 | F | H | H | F | H | H | H | CH₃ |
| II-110 | H | H | H | H | H | H | H | CH₃ |
| II-111 | CH₃ | H | H | H | H | H | H | CH₃ |
| II-112 | CH₃ | H | H | H | H | H | H | CH₃ |
| II-113 | CH₃ | H | H | H | H | CH₃ | H | CH₃ |

| | | | | | | LC-MS | m.p. |
|---|---|---|---|---|---|---|---|
| No. | R⁹ | R¹¹ | R¹² | R¹³ | M + H+ | cond. | [° C.] |
| II-1 | H | CF₃ | H | F | | | 208-209 |
| II-2 | H | CF₃ | H | F | | | 219-220 |
| II-3 | H | CF₃ | H | H | | | 192-193 |
| II-4 | H | CF₃ | H | H | | | 231-132 |
| II-5 | H | CF₃ | H | F | | | 198-199 |
| II-6 | H | CF₃ | H | F | | | 203-204 |
| II-7 | H | CF₃ | H | F | | | 213-215 |
| II-8 | H | CF₃ | H | H | | | 214-215 |
| II-9 | H | CF₃ | H | H | | | 260 |
| II-10 | H | CF₃ | H | F | | | 200-201 |
| II-11 | H | CF₃ | H | H | | | 204 |
| II-12 | H | CF₃ | H | F | | | 206-210 |
| II-13 | H | CF₃ | H | F | | | 235-237 |
| II-14 | H | CF₃ | H | F | | | 220-222 |
| II-15 | H | CF₃ | H | F | | | 201-202 |
| II-16 | H | CF₃ | H | H | | | 195-196 |
| II-17 | H | CF₃ | H | H | | | 228-230 |
| II-18 | H | CF₃ | H | H | | | 224 |
| II-19 | H | CF₃ | H | H | 430.2 | a | |
| II-20 | H | CF₃ | H | H | 454.1 | a | |
| II-21 | H | CF₃ | H | F | | | 198-200 |
| II-22 | H | CF₃ | H | F | | | 215-218 |
| II-23 | H | CF₃ | H | H | | | 205-207 |
| II-24 | H | CF₃ | H | F | | | 215-216 |
| II-25 | H | CF₃ | H | H | | | 205-206 |
| II-26 | H | CF₃ | H | F | | | 215-216 |
| II-27 | H | CF₃ | H | F | | | 210-211 |
| II-28 | H | CF₃ | H | F | | | 253-254 |
| II-29 | H | CF₃ | H | H | | | 236-237 |
| II-30 | H | CF₃ | H | F | | | 209-210 |
| II-31 | H | CF₃ | H | H | | | 220-221 |
| II-32 | H | CF₃ | H | H | | | 229-230 |
| II-33 | H | CF₃ | H | F | | | 226-227 |
| II-34 | H | CF₃ | H | F | | | 188-190 |
| II-35 | H | CF₃ | H | H | | | 216-217 |
| II-36 | H | CF₃ | H | F | | | 196-197 |
| II-37 | H | CF₃ | H | F | | | 203-204 |
| II-38 | H | CF₃ | H | H | | | 212-214 |
| II-39 | H | CF₃ | H | H | 487.1 | a | |
| II-40 | H | CF₃ | H | H | 379.1 | a | |
| II-41 | H | CF₃ | H | H | 387.1 | a | |
| II-42 | H | CF₃ | H | F | 393.1 | a | |
| II-43 | H | CF₃ | H | F | 395.0 | a | |
| II-44 | H | CF₃ | H | H | 375.1 | a | |
| II-45 | H | CF₃ | H | H | 377.1 | a | |
| II-46 | H | CF₃ | H | H | 421.0 | a | |
| II-47 | H | CF₃ | H | H | 437.1 | a | |
| II-48 | H | CF₃ | H | H | 451.1 | a | |
| II-49 | H | CF₃ | H | H | 429.0 | a | |
| II-50 | H | CF₃ | H | H | 387.1 | a | |
| II-51 | H | CF₃ | H | H | 403.1 | a | |
| II-52 | H | CF₃ | H | H | 437.1 | a | |
| II-53 | H | CF₃ | H | H | 449.0 | a | |
| II-54 | H | CF₃ | H | H | 417.1 | a | |
| II-55 | H | CF₃ | H | H | 471.0 | a | |
| II-56 | H | CF₃ | H | H | 401.1 | a | |
| II-57 | H | CF₃ | H | H | 405.1 | a | |
| II-58 | H | CF₃ | H | H | 453.0 | a | |
| II-59 | H | CF₃ | H | H | 451.0 | a | |
| II-60 | H | CF₃ | H | H | 387.1 | a | |
| II-61 | H | CF₃ | H | H | 410.1 | a | |
| II-62 | H | CF₃ | H | H | 403.1 | a | |
| II-63 | H | CF₃ | H | H | 419.0 | a | |
| II-64 | H | CF₃ | H | H | 381.1 | a | |
| II-65 | H | CF₃ | H | H | 435.1 | a | |
| II-66 | H | CF₃ | H | H | 453.1 | a | |
| II-67 | H | CF₃ | H | H | 430.0 | a | |
| II-68 | H | CF₃ | H | H | 396.1 | a | |
| II-69 | H | CF₃ | H | H | 411.1 | a | |
| II-70 | H | CF₃ | H | H | 427.1 | a | |
| II-71 | H | CF₃ | H | H | 410.1 | a | |
| II-72 | H | CF₃ | H | H | | | 200-201 |
| II-73 | H | CF₃ | H | H | | | 229-230 |
| II-74 | H | CF₃ | H | H | | | 220-221 |
| II-75 | H | CF₃ | H | H | | | 232-233 |
| II-76 | H | CF₃ | H | H | | | 187-188 |
| II-77 | H | CF₃ | H | F | 451.4 | i | |
| II-78 | H | CF₃ | H | F | 401.4 | i | |
| II-79 | H | CF₃ | H | F | 397.4 | i | |
| II-80 | H | CF₃ | H | F | 383.4 | i | |
| II-81 | H | CF₃ | H | F | 455.4 | i | |
| II-82 | H | CF₃ | H | F | 411.4 | i | |
| II-83 | H | CF₃ | H | F | 455.4 | i | |
| II-84 | H | CF₃ | H | F | 425.4 | i | |
| II-85 | H | CF₃ | H | F | 397.4 | i | |
| II-86 | H | CF₃ | H | F | 401.4 | i | |
| II-87 | H | CF₃ | H | H | | | 223-224 |
| II-88 | H | CF₃ | H | H | 379.4 | i | |
| II-89 | H | CF₃ | H | H | 437.4 | i | |
| II-90 | H | CF₃ | H | H | 365.1 | a | |
| II-91 | H | CF₃ | H | F | 369.1 | a | |
| II-92 | H | CF₃ | H | H | 320.1 | a | |
| II-93 | H | CF₃ | H | H | 320.1 | a | |
| II-94 | CH₃ | CF₃ | H | F | 338.1 | a | |
| II-95 | H | CF₃ | H | F | 338.1 | a | |
| II-96 | H | CF₃ | H | F | 352.0 | a | |
| II-97 | H | CF₃ | H | H | 320.0 | a | |
| II-98 | H | CF₃ | H | F | 338.0 | a | |
| II-99 | H | CF₃ | H | F | 358.1 | a | |
| II-100 | H | CF₃ | H | F | 389.0 | a | |
| II-101 | H | F | H | H | 305.1 | a | |
| II-102 | H | F | CF₃ | H | 369.1 | a | |
| II-103 | H | F | F | H | 319.1 | a | |
| II-104 | H | Cl | Cl | H | 352.1 | a | |
| II-105 | H | Cl | Cl | H | 356.1 | a | |
| II-106 | H | Cl | Cl | H | 352.1 | a | |
| II-107 | H | Cl | CF₃ | H | 398.81 | a | |
| II-108 | H | Cl | H | Cl | 370.0 | a | |
| II-109 | H | Cl | Cl | F | 353.0 | a | |
| II-110 | H | Cl | H | Cl | 352.1 | a | |
| II-111 | H | SO₂CH₃ | H | H | 375.1 | a | |
| II-112 | H | SO₂CHF₂ | H | H | 379.0 | a | |
| II-113 | H | Cl | CF₃ | H | 413.84 | a | |

Use Examples for Herbicidal Action

The herbicidal activity of the phenylalanine derivatives of the formula I was demonstrated by greenhouse experiments:

The cultivation containers used were plastic pots containing loamy sand with approximately 3.0% of humus as the substrate. The seeds of the test plants were sown separately for each species.

For the pre-emergence treatment, directly after sowing, the active compounds, which had been suspended or emulsified in water, were applied by means of finely distributing nozzles. The containers were irrigated gently to promote germination and growth and subsequently covered with transparent plastic hoods until the plants had rooted. This cover caused uniform germination of the test plants, unless this was adversely affected by the active compounds.

For the post-emergence treatment, the test plants were first grown to a height of from 3 to 15 cm, depending on the plant habit, and only then treated with the active compounds which had been suspended or emulsified in water. The test plants were for this purpose either sown directly and grown in the same containers, or they were first grown separately as seedlings and transplanted into the test containers a few days prior to treatment. The application rate for the post-emergence treatment was 0.095, 0.5 or 1.91 kg of a.s. (active substance).

Depending on the species, the plants were kept at 10-25° C. or 20-35° C. The test period extended over from 2 to 4 weeks. During this time, the plants were tended, and their response to the individual treatments was evaluated.

Evaluation was carried out using a scale from 0 to 100. 100 means no emergence of the plants, or complete destruction of at least the aerial parts and 0 means no damage, or normal course of growth.

The plants used in the greenhouse experiments were of the following species:

| Scientific name | Common name |
|---|---|
| Abutilon theophrasti | velvetleaf |
| Setaria italica | foxtail millet |
| Sinapis alba | white mustard |
| Chenopodium album | common lambsquarters |
| Setaria faberia | giant foxtail |
| Galium aperine | catchweed |
| Polygonum persicaria | ladysthumb |

Compound I-19 provides very good control of Abutilon theophrasti and Setaria italica when applied by the post-emergence method at application rates of 0.5.kg of a.s./ha.

Compound I-24 provides very good control of Abutilon theophrasti and Sinapis alba when applied by the post-emergence method at application rates of 0.5 kg of a.s./ha.

Compound I-25 provides very good control of Abutilon theophrasti, Setaria italica and Sinapis alba when applied by the post-emergence method at application rates of 0.5 kg of a.s./ha.

Compound I-32 provides very good control of Setaria italica and Sinapis alba when applied by the post emergence method at application rates of 0.095 kg of a.s./ha.

Compound I-49 provides very good control of Abutilon theophrasti, Setaria italica and Sinapis alba when applied by the post-emergence method at application rates of 1.91 kg of a.s./ha.

Compound I-49 provides very good control of Abutilon theophrasti, Setaria italica and Sinapis alba when applied by the post-emergence method at application rates of 3.0 kg of a.s./ha.

Compound I-51 provides very good control of Abutilon theophrasti and Chenopodium album when applied by the post-emergence method at application rates of 1.0 kg of a.s./ha.

Compound I-53 provides very good control of Abutilon theophrasti, Setaria italica and Sinapis alba when applied by the post-emergence method at application rates of 0.5 kg of a.s./ha.

Compound II-91 provides very good control of Abutilon theophrasti and Sinapis alba when applied by the post-emergence method at application rates of 2.0 kg of a.s./ha.

Compound II-87 provides very good control of Setaria faberia and Chenopodium album when applied by the post-emergence method at application rates of 1.0 kg of a.s./ha.

Compound II-94 provides very good control of Abutilon theophrasti, Setaria italica and Sinapis alba when applied by the post-emergence method at application rates of 3.0 kg of a.s./ha.

Compound II-111 provides very good control of Abutilon theophrasti, Setaria italica and Sinapis alba when applied by the post-emergence method at application rates of 1.0 kg of a.s./ha.

Compound II-112 provides very good control of Abutilon theophrasti, Setaria italica and Sinapis alba when applied by the post-emergence method at application rates of 1.0 kg of a.s./ha.

Compound II-15 provides very good control of Abutilon theophrasti, Setaria italica and Sinapis alba when applied by the post-emergence method at application rates of 0.5 kg of a.s./ha.

Compound II-10 provides very good control of Chenopodium album, Galium aperine and Polygonum persicaria when applied by the post-emergence method at application rates of 1.0 kg of a.s./ha.

Compound II-7 provides very good control of Abutilon theophrasti and Chenopodium album when applied by the post-emergence method at application rates of 1.0 kg of a.s./ha.

Use Examples for Growth-Regulating Action

The growth-regulating action of the phenylalanine derivatives of the formula I was demonstrated by greenhouse experiments:

The cultivation containers used were plastic pots containing loamy sand with approximately 3.0% of humus as the substrate. The seeds of the test plants were sown separately for each species.

For the pre-emergence treatment, directly after sowing, the active compounds, which had been suspended or emulsified in water, were applied by means of finely distributing nozzles. The containers were irrigated gently to promote germination and growth and subsequently covered with transparent plastic hoods until the plants had rooted. This cover causes uniform germination of the test plants, unless this was adversely affected by the active compounds.

For the post-emergence treatment, the test plants were first grown to a height of from 3 to 15 cm, depending on the plant habit, and then treated with the active compounds which had been suspended or emulsified in water. The test plants were for this purpose either sown directly and grown in the same containers, or they were first grown separately as seedlings and transplanted into the test containers a few days prior to treatment. The application rate for the post-emergence treatment was 0.5 kg of a.s./ha.

Depending on the species, the plants were kept at 10-25° C. or 20-35° C. The test period extended over from 2 to 4 weeks. During this time, the plants were tended, and their response to the individual treatments was evaluated.

At the end of the experiment, the observed growth-regulating action was recorded by measuring the height of growth. The measured values obtained in this manner were compared to the height of growth of untreated plants.

Compound II-92, when applied post-emergence at a rate of 500 g/ha, had a significant impact on the longitudinal growth of Zea mays L. 14 days after application (see Tab. III)

TABLE III

| Compound | Height in cm | Plant |
|---|---|---|
| II-92 | 31-33 | Zea mays L. |
| Untreated | 40-42 | Zea mays L. |

1-16. (canceled)

17. A phenylalanine derivative of the formula I 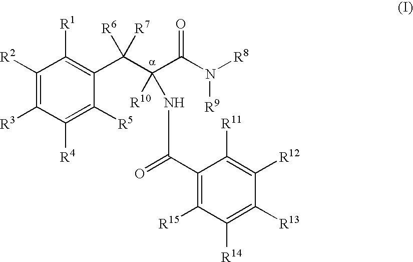
in which
R¹, R², R⁴, R⁵, R¹³ and R¹⁵ independently of one another are hydrogen, halogen, hydroxyl, mercapto, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C6-alkenylsulfonyl, C₃-C₆-alkynylsulfonyl, C₁-C₆-haloalkyl, C₂-C₆-haloalkenyl, C₂-C₆-haloalkynyl, C₁-C₆-haloalkoxy, C₃-C₆-haloalkenyloxy, C₃-C₆-haloalkynyloxy, C₁-C₆-haloalkylthio, C₃-C₆-haloalkenylthio, C₃ -C₆-haloalkynylthio, C₁-C₆-haloalkylsulfinyl, C₃-C₆-haloalkenylsulfinyl, C₃ -C₆-haloalkynylsulfinyl, C₁-C₆-haloalkylsulfonyl, C₃-C₆-haloalkenylsulfonyl, C₃-C₆-haloalkynylsulfonyl, formyl, C₁-C₆-alkylcarbonyloxy, C₁-C₆-alkoxy-C₁-C₄-alkyl, C₃-C₆-alkenyloxy-C₁-C₄-alkyl, C₃-C₄-alkynyloxy-C₁-C₄-alkyl, C₁-C₆-alkylthio-C₁-C₄-alkyl, C₃-C₆-alkenylthio-C₁-C₄-alkyl, C₃-C₄-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkoxycarbonyl-C₁-C₄-alkyl, C₁-C₆-alkoxy-C₁-C₄-alkoxy, C₃-C₆-alkenyloxy-C₁-C₄-alkoxy, C₃-C₄-alkynyloxy-C₁-C₄-alkoxy, C₁-C₆-alkylthio-C₁-C₄-alkoxy, C₃-C₆-alkenylthio-C₁-C₄-alkoxy, C₃-C₆-alkynylthio-C₁-C₄ -alkoxy, C₁-C₆-alkylcarbonyl-C₁-C₄-alkoxy, C₁-C₆-alkylcarbonyloxy-C₁-C₄-alkoxy, C₁-C₆-alkoxycarbonyl-C₁-C₄-alkoxy or CO—R¹⁶;
R³ is hydrogen, halogen, mercapto, C₁-C₆-alkyl, C₂-C₆-alkenyl, C₂-C₆-alkynyl, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₂-C₆-haloalkenyl, C₂-C₆-haloalkinyl, C₁-C₆-haloalkylthio, C₃-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, C₁-C₆-alkoxy-C₁-C₄-alkyl, C₃-C₆-alkenyloxy-C₁-C₄-alkyl, C₃-C₄-alkynyloxy-C₁-C₄-alkyl, C₁-C₆-alkylthio-C₁-C₄-alkyl, C₃-C₆-alkenylthio-C₁-C₄-alkyl, C₃-C₆-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkyloxycarbonyl-C₁-C₄-alkyl or CO—R¹⁶;
R⁶ is hydrogen, C₁-C₆-alkyl, C₂-C₆-alkenyl or C₂-C₆-alkynyl;
R⁷ is hydrogen, halogen, C₁-C₆-alkyl, C₂-C₆-alkenyl, C₂-C₆-alkynyl, C₁-C₆-haloalkyl, C₂-C₆-haloalkenyl or C₂-C₆-haloalkynyl;
R⁸ is methyl, ethyl, C₁-C₆-alkoxy or hydroxyl;
R⁹ is hydrogen or C₁-C₆-alkyl;
R¹⁰ is hydrogen, C₁-C₆-alkyl, C₁-C₆-alkoxycarbonyl or C₁-C₆-haloalkoxylcarbonyl;
R¹¹ is halogen, mercapto, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₂-C₆-haloalkenyl, C₂-C₆-haloalkynyl, C₁-C₆-haloalkoxy, C₃-C₆-haloalkenyloxy, C₃-C₆-haloalkynyloxy, C₁-C₆-haloalkylthio, C₃-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, formyl, C₁-C₆-alkylcarbonyloxy, C₁-C₆-alkoxy-C₁-C₄-alkyl, C₂-C₆-alkenyloxy-C₁-C₄-alkyl, C₃-C₄-alkynyloxy-C₁-C₄-alkyl, C₁-C₆-alkylthio-C₁-C₄-alkyl, C₂-C₆-alkenylthio-C₁-C₄-alkyl, C₃-C₄-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkyloxycarbonyl-C₁-C₄-alkyl, C₁-C₆-alkoxy-C₁-C₄-alkoxy, C₃-C₆-alkenyloxy-C₁-C₄-alkoxy, C₃-C₄-alkynyloxy-C₁-C₄-alkoxy, C₁-C₆-alkylthio-C₁-C₄-alkoxy, C₃-C₆-alkenylthio-C₁-C₄-alkoxy, C₃-C₆-alkynylthio-C₁-C₄-alkoxy, C₁-C₆-alkylcarbonyl-C₁-C₄-alkoxy, C₁-C₆-alkylcarbonyloxy-C₁-C₄-alkoxy, C₁-C₆-alkyloxycarbonyl-C₁-C₄-alkoxy or CO—R¹⁶;
R¹² and R¹⁴ independently of one another are hydrogen, halogen, hydroxyl, mercapto, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₃-C₆-haloalkenyl, C₂-C₆-haloalkynyl, C₁-C₆-haloalkoxy, C₃-C₆-haloalkenyloxy, C₃-C₆-haloalkynyloxy, C₁-C₆-haloalkylthio, C₂-C₆-haloalkenylthio, C₃-C₆-haloalkynylthio, C₁-C₆-haloalkylsulfinyl, C₃-C₆-haloalkenylsulfinyl, C₃-C₆-haloalkynylsulfinyl, C₁-C₆-haloalkylsulfonyl, C₃-C₆-haloalkenylsulfonyl, C₃-C₆-haloalkynylsulfonyl, formyl, C₁-C₆-alkylcarbonyloxy, C₁-C₆-alkoxy-C₁-C₄-alkyl, C₃-C₆-alkenyloxy-C₁-C₄-alkyl, C₃-C₄-alkynyloxy-C₁-C₄-alkyl, C₁-C₆-alkylthio-C₁-C₄-alkyl, C₃-C₆-alkenylthio-C₁-C₄-alkyl, C₃-C₄-alkynylthio-C₁-C₄-alkyl, C₁-C₆-alkylcarbonyl-C₁-C₄-alkyl, C₁-C₆-alkylcarbonyloxy-C₁-C₄-alkyl, C₁-C₆-alkyloxycarbonyl -C₁-C₄-alkyl, C₁-C₆-alkoxy-C₁-C₄-alkoxy, C₃-C₆-alkenyloxy-C₁-C₄-alkoxy, C₃-C₄-alkynyloxy-C₁-C₄-alkoxy, C₁-C₆-alkylthio-C₁-C₄-alkoxy, C₃-C₆-alkenylthio-C₁-C₄-alkoxy, C₃-C₆-alkynylthio-C₁-C₄-alkoxy, C₁-C₆-alkylcarbonyl-C₁-C₄-alkoxy, C₁-C₆-alkylcarbonyloxy-C₁-C₄-alkoxy, C₁-C₆-alkyloxycarbonyl-C₁-C₄-alkoxy or CO—R¹⁶; and
R¹⁶ is hydrogen, hydroxyl, C₁-C₆-alkyl, C₂-C₆-alkenyl, C₂-C₆-alkynyl, C₁-C₆-haloalkyl, C₂-C₆-haloalkenyl, C₂-C₆-haloalkynyl, C₁-C₆-alkoxy, C₃-C₆-alkenyloxy, C₃-C₆-alkynyloxy, C₁-C₆-haloalkoxy, C₁-C₆-alkylamino or di(C₁-C₆-alkyl)amino; or
R⁷ together with R¹⁰ forms a C₃-C₄-alkylene or -alkenylene chain, where the C₃-C₄-alkylene or -alkenylene chain may carry 1-3 substituents from the group consisting of halogen, nitro or cyano and/or one carbon atom of the C₃-C₄-alkylene chain may be replaced by a heteroatom selected from the group consisting of oxygen, sulfur and nitrogen and/or by a carbonyl group;
or an argiculturally useful salt thereof.

18. A phenylalanine derivative or salt thereof as claimed in claim 17, in which
R¹ is hydrogen, halogen, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₁-C₆-haloalkoxy, C₃-C₆-haloalkenyloxy, C₁-C₆-haloalkylthio, C₃-C₆-haloalkenylthio, C₁-C₆-haloalkylsulfinyl, C₃-C₆-haloalkenylsulfinyl, C₁-C₆-haloalkylsulfonyl or C₃-C₆-haloalkenylsulfonyl;
R² is hydrogen, halogen, nitro, cyano, C₁-C₆-alkyl, C₂-C₆-alkynyl, C₁-C₆-alkoxy, C₃-C₆-alkenyloxy, C₃-C₆-alkynyloxy, C₁-C₆-haloalkyl, C₁-C₆-haloalkoxy, C₃-C₆-haloalkenyloxy or C₃-C₆-haloalkynyloxy;
R³ is hydrogen, halogen, C₁-C₆-alkyl or C₁-C₆-haloalkyl;
R⁴ is hydrogen, halogen, nitro, cyano, C₁-C₆-alkyl, C₁-C₆-alkoxy, C₃-C₆-alkenyloxy, C₃-C₆-alkynyloxy, C₁-C₆-haloalkyl or C₁-C₆-haloalkoxy;
R⁵ is hydrogen, halogen, nitro, cyano, C₁-C₆-alkyl, C₂-C₆-alkenyl, C₂-C₆-alkynyl, C₁-C₆-alkoxy, C₃-C₆-alkenyloxy, C₃-C₆-alkynyloxy, C₁-C₆-haloalkyl, C₁-C₆-haloalkoxy or C₃-C₆-haloalkenyloxy; and
R₆ is hydrogen or C₁-C₆-alkyl;
R⁷ is hydrogen, halogen, C₁-C₆-alkyl, C₂-C₆-alkenyl, C₂-C₆-alkynyl or C₁-C₆-haloalkyl;
R⁸ is methyl, ethyl, hydroxyl or methoxy;
R⁹ is hydrogen or methyl;
R¹⁰ is hydrogen, C₁-C₆-alkyl, C₁-C₆-alkoxycarbonyl or C₁-C₄-haloalkoxycarbonyl;
R¹¹ is halogen, nitro, cyano, C₁-C₆-alkyl, C₁-C₆-alkoxy, C₁-C₆-alkylthio, C₃-C₆-alkenylthio, C₃₋C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₁-C₆-haloalkoxy, C₁-C₆-haloalkylthio, C₃-C₆-haloalkenylthio, C₁-C₆-haloalkylsulfinyl, C₃-C₆-haloalkenylsulfinyl, C₁-C₆-haloalkylsulfonyl, C₃-C₆-haloalkenylsulfonyl or CO—R¹⁶;
R¹³ is hydrogen, halogen, nitro, cyano, C₁-C₆-alkyl, C₁-C₆-alkoxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₁-C₆-haloalkoxy, C₁-C₆-haloalkylthio, C₃-C₆-haloalkenylthio, C₁-C₆-haloalkylsulfinyl, C₃-C₆-haloalkenylsulfinyl, C₁-C₆-haloalkylsulfonyl, C₃-C₆-haloalkenylsulfonyl or CO—R¹⁶;
R¹² and R¹⁴ independently of one another are hydrogen, halogen, cyano, C₁-C₆-alkyl, C₁-C₆-alkoxy, C₁-C₆-alkylthio, C₃-C₆-alkenylthio, C₃-C₆-alkynylthio, C₁-C₆-alkylsulfinyl, C₃-C₆-alkenylsulfinyl, C₃-C₆-alkynylsulfinyl, C₁-C₆-alkylsulfonyl, C₃-C₆-alkenylsulfonyl, C₃-C₆-alkynylsulfonyl, C₁-C₆-haloalkyl, C₁-C₆-haloalkoxy, C₁-C₆-haloalkylthio, C₃-C₆-haloalkenylthio, C₁-C₆-haloalkylsulfinyl, C₃-C₆-haloalkenylsulfinyl, C₁-C₆-haloalkylsulfonyl, C₃-C₆ -haloalkenylsulfonyl or CO—R¹⁶;
R¹⁵ is hydrogen, halogen, C₁-C₆-alkyl or C₁-C₆-haloalkyl;
R¹⁶ is hydrogen, hydroxyl, C₁-C₆-alkyl, C₁-C₆-haloalkyl, C₁-C₆-alkoxy, C₁-C₆-haloalkoxy, C₁-C₆-alkylamino or di(C₁-C₆-alkyl)amino.

19. A phenylalanine derivative or salt thereof as claimed in claim 17 in which
R¹ is hydrogen, halogen, cyano, C₁-C₆-alkyl, C₁-C₆-alkylthio, C₁-C₆-alkylsulfinyl or C₁-C₆-alkylsulfonyl;
R² is hydrogen, halogen, cyano, C₁-C₆-haloalkyl or C₁-C₆-alkyl;
R³ is hydrogen, C₁-C₆-alkyl or halogen;
R⁴ is hydrogen, halogen, C₁-C₆-alkyl or C₁-C₆-haloalkyl;
R⁵ is hydrogen, halogen, C₁-C₆-alkyl or C₁-C₆-haloalkyl;
R⁶ is hydrogen or C₁-C₆-alkyl;
R⁷ is hydrogen, C₁-C₆-alkyl, C₂-C₆-alkenyl or C₂-C₆-alkynyl;
R⁸ is methyl, hydroxyl or methoxy;
R⁹ is hydrogen or methyl;
R¹⁰ is hydrogen; and
R¹¹ is halogen, cyano, C₁-C₆-alkyl, C₁-C₆-alkylthio, C₁-C₆-alkylsulfinyl, C₁-C₆-alkylsulfonyl, C₁-C₆-haloalkyl, C₁-C₆-haloalkoxy, C₁-C₆-haloalkylthio, C₁-C₆-alkylsulfonyl or C₁-C₆-alkylsulfinyl;
R¹², R¹³ and R¹⁴ independently of one another are hydrogen, halogen, cyano, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy or C₁-C₆-haloalkylthio; and
R¹⁵ is hydrogen.

20. A phenylalanine derivative or salt thereof as claimed in claim 17 in which
R¹, R², R³, R⁵ in each case independently of one another are hydrogen, fluorine, chlorine, methyl or ethyl;
R⁴, R⁶, R¹⁰, R¹⁴and R¹⁵ are hydrogen;
R⁷ is hydrogen, methyl or ethyl;
R⁸ is methoxy methyl or hydroxyl;
R⁹ is hydrogen;
is methyl if R⁸ is hydroxyl;
R¹¹ is fluorine, chlorine, halomethyl such as fluoromethyl, difluoromethyl, trifluoromethyl, halomethoxy, such as fluoromethoxy, difluoromethoxy, trifluoromethoxy, halothioalkyl, such as fluorothiomethyl, difluorothiomethyl, trifluorothiomethyl, methylsulfinyl or methylsulfonyl;
R¹² is hydrogen, cyano, methyl, fluorine, chlorine, halomethyl, such as fluoromethyl, difluoromethyl, trifluoromethyl, halomethoxy, such as fluoromethoxy, difluoromethoxy, trifluoromethoxy, halothioalkyl, such as fluorothiomethyl, difluorothiomethyl, trifluorothiomethyl;
R¹³ is hydrogen, fluorine, chlorine.

21. A process for preparing a phenylalanine derivative of claim 17 comprising
(A) linking a phenylalanine derivative of the formula II 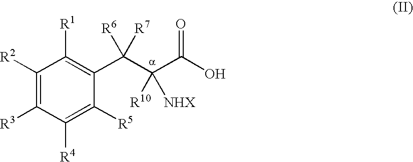
which is protected at the amino function by a protective group X to a support resin;
(B) removing the protective group X by addition of a base,
(C) acylating the resulting compounds at the nitrogen and
(D) cleaving the compounds acylated at the nitrogen from the solid support by addition of an acid, followed by addition of a condensing agent with an amine IX
R⁸—NH—R⁹ (IX)
to produce a phenyalanine derivative of claim 17.

22. A process for preparing a phenylalanine derivative of claim 17 in which R⁹ is hydrogen, comprising
(A) reacting a polymer resin X
Pol-CHO (X)
with an amine XI
H²NR⁸ (XI)
in the presence of a reducing agent to obtain an aminated resin;
(B) reacting the aminated resin XII
Pol-CH₂—NHR⁸ (XII)
obtained in step A with a phenylalanine derivative of the formula II; 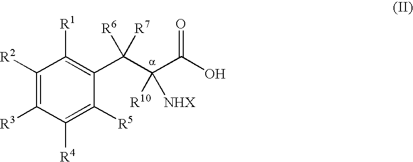
(C) removing the protective group X by addition of a base;
(D) and acylating the resulting compounds XIII 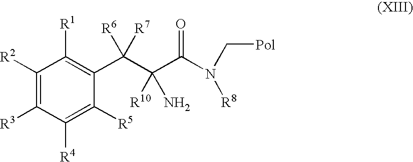
to give the compound, XIV 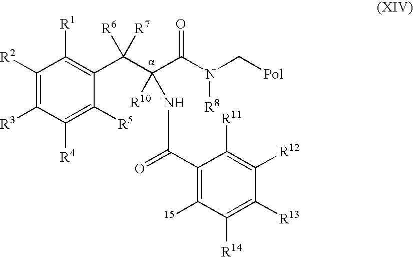
which is subsequently, by addition of an acid, cleaved from the solid support, thereby preducing a compound of claim 17.

23. A process for preparing phenylalanine derivatives of as claimed in claim 17 comprising
(A) reacting a phenylalanine derivative of the formula II 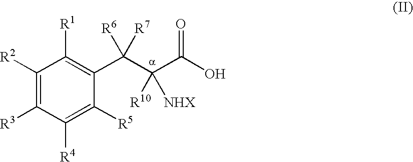
which is protected at the amino function by a protective group X, with an amine IX
HNR⁸R⁹ (IX)
in an inert aprotic dipolar organic solvent to give the compounds XV 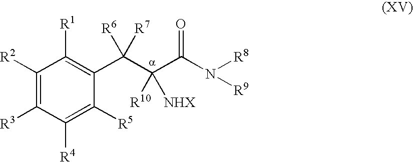
(B) removing the protective group X, and
(C) acylating the compounds obtained in step B to give a compound of formula I.

24. A process for preparing phenylalanine derivative of claim 17 in which R⁹ is hydrogen, comprising
(A) reacting an aminomalonic acid ester derivative XVII 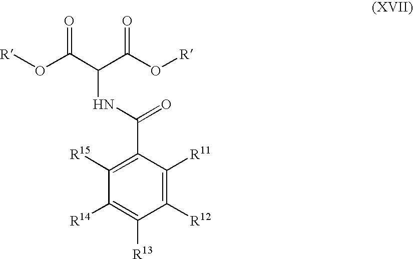
in which R′ is a low-molecular-weight organic radical with a benzyl derivative XVIII 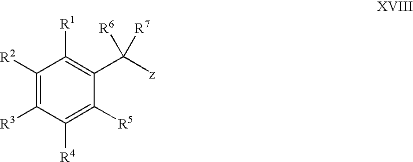
to give a diester XIX 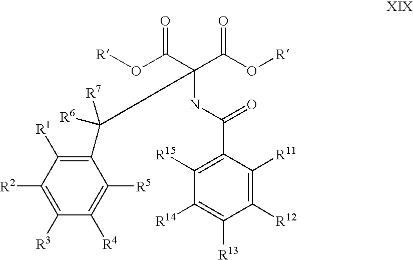
(B) decarboxylating and hydrolyzing the diester XIX, followed by reaction with an amine IX
HNR⁸R⁹ (IX)
in an inert aprotic dipolar organic solvent using a condensing agent, to provide a compound of formula I.

25. A process for preparing a phenylalanine derivative of claim 17 comprising
(A) reacting the benzyl derivative XVIII 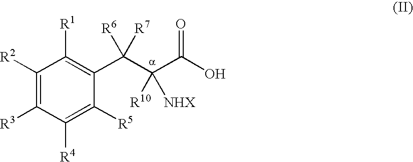
with an alkylating agent XXI 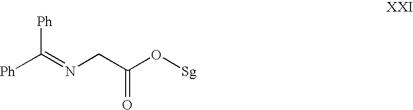
to give the compound XXII 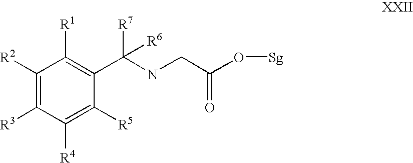
(B) acylating the resulting compound XXII at the nitrogen and
(C) reacting the nitrogen-acylated compounds by addition of a condensing agent with an amine IX
R⁸—NH—R⁹ (IX)
to produce a phenylalanine derivative of claim 17.

26. An argicultural composition comprising a phenylalanine derivative of claim 17 or an agriculturally useful salt thereof and at least one customary auxiliary.

27. An argicultural composition suitable for controlling undesirable vegetation which composition comprises a phenylalanine derivative of claim 17 or an agriculturally useful salt thereof and a solid liquid carrier.

28. A method for controlling undesirable vegetation comprising contacting at least one of the vegetation or the vetetation's habitat or seed with an effective amount of a phenylalanine derivative of claim 17 or an argiculturally useful salt thereof.

29. A composition for regulating plant growth comprising a growth-regulating effective amount of at least one phenylalanine derivative of claim 17 or an agriculturally useful salt thereof and at least one inert solid or liquid carrier.

30. The composition of claim 29, further comprising at least one surfactant.

31. A process for preparing compositions for regulating plant growth, said process comprising mixing a growth-regulating effective amount of at least one phenylalanine derivative of claim 17 or an aguiculturally useful salt thereof with at least one liquid or solid carrier.

32. The process of claim 31, further comprising mixing at least one surfactant into the composition.

33. A method for regulating plant growth, comprising contacting a plant with a growth-regulating effective amount of at least one phenylalanine derivative of claim 17 or an agriculturally useful salt thereof.
